(19) United States
(12) Patent Application Publication
(10) Pub. No.: US 2025/0173764 A1
(43) Pub. Date: May 29, 2025

(54) METHOD AND SYSTEM FOR GENERATING JOURNEYS FOR ENGAGING USERS IN REAL-TIME

(71) Applicant: WizRocket Inc., San Francisco, CA (US)

(72) Inventors: Jacob JOSEPH, Mumbai (IN); Ankush JAIN, Mumbai (IN)

(73) Assignee: WizRocket Inc., San Francisco, CA (US)

(21) Appl. No.: 19/018,158

(22) Filed: Jan. 13, 2025

Related U.S. Application Data
(63) Continuation-in-part of application No. 17/644,588, filed on Dec. 16, 2021, now abandoned.

(51) Int. Cl. G06Q 30/0251

(52) U.S. Cl. CPC G06Q 30/0271; G06Q 30/0254; G06Q 30/0264

(57) ABSTRACT

The present disclosure provides a method and system for generating a plurality of journeys for engaging a plurality of users in real-time. The system receives a first set of data associated with the plurality of users. In addition, the system fetches a second set of data associated with a plurality of past events on a plurality of platforms through one or more communication devices. Further, the system obtains a third set of data associated with a plurality of live events. Furthermore, the system analyzes the first set of data, the second set of data and the third set of data using one or more machine learning algorithms. Moreover, the system generates the plurality of journeys for engaging the plurality of users through a plurality of channels. Also, the system creates one or more goals for each of the plurality of journeys of the plurality of platforms.

### TECHNICAL FIELD

The present invention relates to the field of marketing and, in particular, relates to a method and system for generating journeys for engaging users in real-time.

### INTRODUCTION

Over the past few years, online platforms have become a popular way for individuals and consumers to interact online. The online platforms have been used to provide range of services to the individuals on the Internet. The range of services includes marketplaces, search engines, social media, consumer business, financial services, industrial products, home services, legal services, creative services, e-learning services, and the like. In addition, the online platforms facilitate interactions between at least two or more distinct individuals (whether firms or consumers) through the range of services via the Internet. We have seen an increasing demand in the usage of the online platforms. The increasing demand of the online platforms leads to a competitive environment within online platform providers. The online platform providers have to make segments for the individuals accessing the online platforms for running marketing campaigns in this competitive environment. The online platform providers are seeking effective ways to automate workflows to engage with the individuals accessing the online platforms. In addition, the online platform providers seek to have productive engagements with the individuals accessing the online platforms. However, the present systems and methods for generating workflow automations to engage with the individuals accessing the online platforms are inefficient.

### SUMMARY

In a first example, a computer-implemented method is provided. The computer-implemented method to generate a plurality of journeys to engage in a personalized way with a plurality of users in real-time. The computer-implemented method includes a first step to receive a first set of data associated with the plurality of users. The plurality of users is associated with one or more communication devices. In addition, the computer-implemented method includes a second step to fetch a second set of data associated with a plurality of past events of the plurality of users on a plurality of platforms through the one or more communication devices. Further, the computer-implemented method includes a third step to obtain a third set of data associated with a plurality of live events of the plurality of users on the plurality of platforms through the one or more communication devices. Furthermore, the computer-implemented method includes a fourth step for computing an optimal time (H*ᵤ, H*_{global}) of sending marketing engagement (C) by capturing an hour of the day where the user were most active or when the majority of users were most active. Furthermore, the computer-implemented method includes a fifth step to analyze the first set of data, the second set of data, the computed optimal time and the third set of data using one or more machine learning algorithms. The analysis is performed based on training of a machine learning model. The analysis is performed to identify one or more patterns. Moreover, the computer-implemented method includes a sixth step to generate the plurality of journeys to engage the plurality of users through a plurality of channels based on the analysis of the first set of data, the second set of data and the third set of data. Also, the computer-implemented method includes a seventh step to create one or more goals for each of the plurality of journeys of the plurality of platforms. The one or more goals are ambitious aim of the plurality of platforms for the plurality of journeys. Each of the one or more goals is tracked in real-time.

In an embodiment of the present disclosure, the analysis is performed for predicting one or more patterns as a probability of user intent defined by at least one of:
whether the user will perform a predetermined goal; and
a likelihood of success of the sent engagement of the user at each hour;

In an embodiment of the present disclosure, the journeys are generated by the steps of:
a) personalization of the marketing engagement to be sent to the user based on the patterns of user intent; and
b) selecting an optimal content to be delivered via the personalized marketing engagement at the predicted optimal time, said selection performed via a multi-bandit algorithm based on the user intent and a campaign context;

In an embodiment of the present disclosure, the first set of data corresponds to personal information of the plurality of users. In addition, the first set of data includes name data, age data, e-mail identity data, contact number data, gender data, geographic location data, angiographic data, and demographic data. Further, the first set of data includes payment cards data, banking partners data, salary data, loan data, lifetime data on each of the plurality of platforms, and relationship status data. The marketing engagement (C) comprises notification, email, in-app message, wireless communication messages, and the intended user action comprises clicking on a link, viewing a product, purchasing an item.

In an embodiment of the present disclosure, the computer-implemented method identifies an entry criterion for automated admittance of each of the plurality of users accessing the plurality of platforms in corresponding journey from the plurality of journeys in real-time.

In an embodiment of the present disclosure, the computer-implemented method identifies the one or more patterns based on the training of the machine learning model on the plurality of past events, the plurality of live events, and a plurality of features in real-time. The machine learning model is trained using a combined loss function associated with prediction of the probabilities of the user intent, wherein the third set of data comprises clicking on a link, viewing a product, purchasing an item.

In an embodiment of the present disclosure, a plurality of intent based micro-segments associated with each of the one or more segments are based on the predicted patterns of the user intent. The plurality of intent based micro-segments is created in real-time, and are classified into High, Medium, and Low intent categories using the XGBoost machine learning model.

In an embodiment of the present disclosure, the computer-implemented method creates the machine learning model to perform the analysis of the first set of data, the second set of data, and the third set of data. In addition, the machine learning model is trained to identify the one or more patterns for the first set of data, the second set of data, and the third set of data.

In an embodiment of the present disclosure, the computer-implemented method computes at the journey management system with the processor, the optimal time of the engagement with the plurality of users in the plurality of journeys using user-specific historical data subject to availability or multiple user data.

In an embodiment of the present disclosure, the computer-implemented method enables segmentation of the plurality of users in one or more segments using the one or more machine learning algorithms in real-time.

In an embodiment of the present disclosure, the computer-implemented method creates a plurality of intent based micro-segments associated with each of the one or more segments to initiate the generation of the plurality of journeys to achieve each of the one or more goals. In addition, the plurality of intent based micro-segments is created in real-time. The plurality of intent based micro-segments is created in real-time, and are classified into High, Medium, and Low intent categories using the XGBoost machine learning model.

In an embodiment of the present disclosure, the computer-implemented method detects an optimal time of the engagement with the plurality of users in the plurality of journeys using the one or more machine learning algorithms in real-time.

In an embodiment of the present disclosure, the computer-implemented method identifies an optimal channel from the plurality of channels for the plurality of journeys for the engagement with the plurality of users in real-time. In addition, the plurality of channels includes mobile channels, email channels, desktop channels, social channels, remarketing channels, and server channels.

In an embodiment of the present disclosure, the computer-implemented method recommends an optimal content for the engagement with the plurality of users throughout the plurality of journeys using the one or more machine learning algorithms in real-time.

In an embodiment of the present disclosure, a multi-arm bandit algorithm is updated for an updated selection of the optimal content based on a reward signal derived from user action in response to previously delivered optimal content through the personalized engagement.

In a second example, a computer system is provided. The computer system includes one or more processors, a signal generator circuitry embedded inside a computing device for generating a signal, and a memory. The memory is coupled to the one or more processors. The memory stores instructions. The instructions are executed by the one or more processors. The execution of the instructions causes the one or more processors to perform a method to generate the plurality of journeys to engage the plurality of users in real-time. The method includes a first step to receive the first set of data associated with the plurality of users. The plurality of users is associated with the one or more communication devices. In addition, the method includes a second step to fetch the second set of data associated with the plurality of past events of the plurality of users on the plurality of platforms through the one or more communication devices. Further, the method includes a third step to obtain the third set of data associated with the plurality of live events of the plurality of users on the plurality of platforms through the one or more communication devices. Furthermore, the method includes a fourth step to analyze the first set of data, the second set of data, and the third set of data using the one or more machine learning algorithms. The analysis is performed based on training of the machine learning model. The analysis is performed to identify the one or more patterns. Moreover, the method includes a fifth step to generate the plurality of journeys to engage the plurality of users through the plurality of channels based on the analysis of the first set of data, the second set of data and the third set of data. Also, the method includes a sixth step to create the one or more goals for each of the plurality of journeys of the plurality of platforms. The one or more goals are the ambitious aim of the plurality of platforms for the plurality of journeys. Each of the one or more goals is tracked in real-time.

In an embodiment of the present disclosure, the first set of data corresponds to the personal information of the plurality of users. In addition, the first set of data includes name data, age data, e-mail identity data, contact number data, gender data, geographic location data, angiographic data, and demographic data. Further, the first set of data includes payment cards data, banking partners data, salary data, loan data, lifetime data on each of the plurality of platforms, and relationship status data.

In an embodiment of the present disclosure, the journey management system identifies the entry criterion for automated admittance of each of the plurality of users accessing the plurality of platforms in corresponding journey from the plurality of journeys in real-time.

In an embodiment of the present disclosure, the journey management system identifies the one or more patterns based on the training of the machine learning model on the plurality of past events, the plurality of live events, and the plurality of features in real-time.

In an embodiment of the present disclosure, the journey management system creates the machine learning model to perform the analysis of the first set of data, the second set of data, and the third set of data. In addition, the machine learning model is trained to identify the one or more patterns for the first set of data, the second set of data, and the third set of data.

In an embodiment of the present disclosure, the journey management system enables the segmentation of the plurality of users in the one or more segments using the one or more machine learning algorithms in real-time.

In an embodiment of the present disclosure, the journey management system creates the plurality of intent based micro-segments associated with each of the one or more segments to initiate the generation of the plurality of journeys to achieve each of the one or more goals. In addition, the plurality of intent based micro-segments is created in real-time.

In an embodiment of the present disclosure, the journey management system detects the optimal time of the engagement with the plurality of users in the plurality of journeys using the one or more machine learning algorithms in real-time.

In an embodiment of the present disclosure, the journey management system identifies the optimal channel from the plurality of channels for the plurality of journeys for the engagement with the plurality of users in real-time. In addition, the plurality of channels includes mobile channels, email channels, desktop channels, social channels, remarketing channels, and server channels.

In an embodiment of the present disclosure, the journey management system recommends the optimal content for the engagement with the plurality of users throughout the plurality of journeys using the one or more machine learning algorithms in real-time.

In a third example, a non-transitory computer-readable storage medium is provided. The non-transitory computer-readable storage medium encodes computer executable instructions that, when executed by at least one processor, performs a method to generate the plurality of journeys to engage the plurality of users in real-time. The method includes a first step to receive the first set of data associated with the plurality of users. The plurality of users is associated with the one or more communication devices. In addition, the method includes a second step to fetch the second set of data associated with the plurality of past events of the plurality of users on the plurality of platforms through the one or more communication devices. Further, the method includes a third step to obtain the third set of data associated with the plurality of live events of the plurality of users on the plurality of platforms through the one or more communication devices. Furthermore, the method includes a fourth step to analyze the first set of data, the second set of data, and the third set of data using the one or more machine learning algorithms. The analysis is performed based on training of the machine learning model. The analysis is performed to identify the one or more patterns. Moreover, the method includes a fifth step to generate the plurality of journeys to engage the plurality of users through the plurality of channels based on the analysis of the first set of data, the second set of data and the third set of data. Also, the method includes a sixth step to create the one or more goals for each of the plurality of journeys of the plurality of platforms. The one or more goals are the ambitious aim of the plurality of platforms for the plurality of journeys. Each of the one or more goals is tracked in real-time.

### BRIEF DESCRIPTION OF THE DRAWINGS

Having thus described the invention in general terms, reference will now be made to the accompanying drawings, which are not necessarily drawn to scale, and wherein:

FIG. 1 illustrates a block diagram of a plurality of platforms, in accordance with various embodiments of the present disclosure;

FIG. 2 illustrates a general overview of an interactive system enabling interaction of a plurality of users on the plurality of platforms in real-time, in accordance with various embodiments of the present disclosure;

FIG. 3 illustrates an interactive computing environment for generating a plurality of journeys for engaging the plurality of users in real-time, in accordance with various embodiments of the present disclosure;

FIG. 4 illustrates an exemplary user onboarding journey for engaging the plurality of users in real-time, in accordance with various embodiments of the present disclosure;

FIG. 5 illustrates a first exemplary journey on detection of an inaction for engaging the plurality of users, in accordance with various embodiments of the present disclosure;

FIG. 6 illustrates an exemplary drive conversion journey for engaging the plurality of users, in accordance with various embodiments of the present disclosure;

FIG. 7 illustrates an exemplary long running re-engagement journey for engaging the plurality of users, in accordance with various embodiments of the present disclosure;

FIG. 8 illustrates an exemplary statistic monitor for the plurality of journeys, in accordance with various embodiments of the present disclosure;

FIG. 9 illustrates a first exemplary onboarding and offboarding criteria for the plurality of journeys, in accordance with various embodiments of the present disclosure;

FIG. 10 illustrates a second exemplary journey on detection of an action for engaging the plurality of users, in accordance with various embodiments of the present disclosure;

FIG. 11 illustrates a second exemplary onboarding and offboarding criteria with re-entry of the plurality of users for the plurality of journeys, in accordance with various embodiments of the present disclosure;

FIG. 12 illustrates a first exemplary journey with a plurality of segment nodes and a plurality of engagement nodes, in accordance with various embodiments of the present disclosure;

FIG. 13 illustrates a second exemplary journey with the plurality of segment nodes and the plurality of engagement nodes, in accordance with various embodiments of the present disclosure;

FIG. 14 illustrates a third exemplary journey with the plurality of segment nodes and the plurality of engagement nodes, in accordance with various embodiments of the present disclosure;

FIG. 15 illustrates a fourth exemplary journey with the plurality of segment nodes and the plurality of engagement nodes, in accordance with various embodiments of the present disclosure;

FIG. 16 illustrates a flow chart for generating the plurality of journeys for engaging the plurality of users in real-time, in accordance with various embodiments of the present disclosure; and

FIG. 17 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figures are intended and provided to illustrate embodiments of the disclosure described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

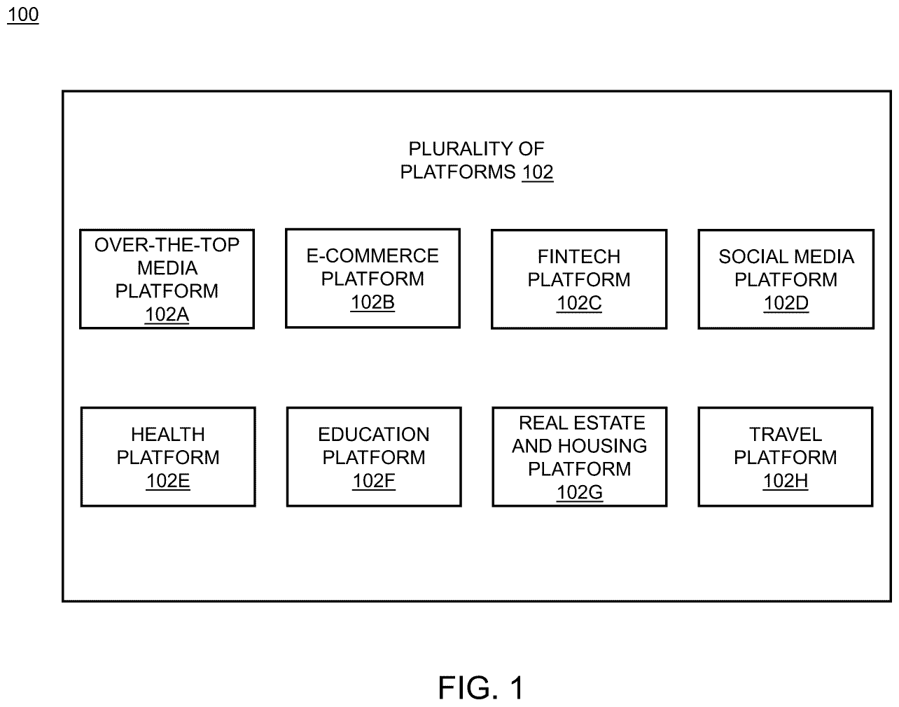

FIG. 1 illustrates a block diagram 100 of a plurality of platforms 102, in accordance with various embodiments of the present disclosure. In general, each of online platforms is a computing platform that enables various individuals to obtain, upload and access valuable resources or services. In addition, the plurality of platforms 102 includes a plurality of contents. In an embodiment of the present disclosure, the plurality of contents include but may not be limited to a plurality of OTT media contents, a plurality of products, a plurality of financial services, and one or more social media contents. In another embodiment of the present disclosure, the plurality of contents include but may not be limited to a plurality of health services, a plurality of educational services, a plurality of real estate services, and a plurality of travel services. However, the plurality of contents is not limited to the above-mentioned contents.

In an embodiment of the present disclosure, the plurality of platforms 102 corresponds to android operating system compatible application. In another embodiment of the present disclosure, the plurality of platforms 102 corresponds to windows operating system compatible applications. In yet another embodiment of the present disclosure, the plurality of platforms 102 corresponds to iPhone operating system compatible applications. In yet another embodiment of the present disclosure, the plurality of platforms 102 corresponds to mac operating system compatible applications. In yet another embodiment of the present disclosure, the plurality of platforms 102 corresponds to webpages. However, the plurality of platforms 102 is not limited to the above-mentioned online platforms.

In addition, the plurality of platforms 102 includes an over-the top media platform 102A, an e-commerce platform 102B, a fintech platform 102C, a social media platform 102D, and a health platform 102E. Further, the plurality of platforms 102 includes an educational platform 102F, a real estate and housing platform 102G, and a travel platform 102H. However, the plurality of platforms 102 is not limited to the above-mentioned online platforms.

In an embodiment of the present disclosure, the plurality of platforms 102 includes the over-the-top media platform 102A. In general, OTT media platform provides a streaming media service to the various individuals over internet. In addition, the over-the-top media platform 102A has the plurality of OTT media contents. The plurality of OTT media contents include but may not be limited to drama series, documentaries, anime, comedy series, science based series, kid series, movies, and stand-up comedy shows. The plurality of OTT media contents is searched using a plurality of genre codes on the over-the-top media platform 102A. The plurality of genre codes includes but may not be limited to action and adventure, action comedies, action sci-fi and fantasy, action thrillers, anime action, region based action content, crime action, and classic action. In an example, an individual 11 opens an over-the-top media platform O1 on a web browser W1 to watch live baseball match on a communication device D1 (let's say a smartphone) using internet connection.

In an embodiment of the present disclosure, the plurality of platforms 102 includes the e-commerce platform 102B. In general, e-commerce platform provides an online service of buying or selling of various products over the Internet. In addition, the e-commerce platform 102B has the plurality of products. The plurality of products include but may not be limited to laptops, tablets, mobiles, clocks, decorative accessories, books, home appliances, shoes, bags, jewelry, clothes, stationery, golf kit, and baseball bat. The plurality of products is searched using a plurality of sections on the e-commerce platform 102B. The plurality of sections include but may not be limited to books and audible, movies and games, electronics, toys, clothes, sports, health and beauty, business, industry, science, and handmade. In an example, an Individual 11 launches an e-commerce application E1 on a communication device D1 (let's say a desktop) to surf various smartwatch brands.

In an embodiment of the present disclosure, the plurality of platforms 102 includes the fintech platform 102C. In general, fintech platform provides an online financial service to the various individuals over the Internet. In addition, the fintech platform 102C includes the plurality of financial services. The plurality of financial services include but may not be limited to car buying loans, house buying loans, credit cards, net banking, commercial banking, opening saving accounts, home equity, and stock exchange investment. However, the plurality of financial services is not limited to the above-mentioned financial services. In an example, an individual 11 searches for best car loan plan on a fintech platform F1 using a communication device D1 (let's say a laptop).

In an embodiment of the present disclosure, the plurality of platforms 102 includes the social media platform 102D. In general, social media platform facilitates creating and sharing of contents for various individuals over the internet. In addition, the social media platform 102D has the one or more social media contents. The one or more social media contents include but may not be limited to online games, business blogs, retail products, live video streams, text messages, multimedia contents, educational content, current affairs, and real-time activity updates. However, the one or more social media contents are not limited to the above-mentioned contents. In an example, an individual 11 promotes skincare product P1 on a social media platform S1 using a business page B1 on a communication device D1 (let's say a desktop).

In an embodiment of the present disclosure, the plurality of platforms 102 includes the heath platform 102E. In general, health platform enables the various individuals to access personalized digital healthcare, diet and medicines to enhance the efficiency of healthcare delivery. In addition, the health platform 102E provides the plurality of health services. The plurality of health services include but may not be limited to diet plans, medicines, physician clinics, nearest hospital, nearest fitness clubs, exercises, yoga classes, aerobics, healthy food orders, and medical tests. However, the plurality of health services is not limited to the above-mentioned services. In an example, a patient P1 searches for eosinophilic asthma medicine M1 on a health platform H1 through a communication device D1 (let's say a tablet).

In an embodiment of the present disclosure, the plurality of platforms 102 includes the education platform 102F. In general, education platform enables students and parents to access personalized digital educational information, tools and resources to enhance the efficiency of educational development. In addition, the education platform 102F provides the plurality of educational services. The plurality of educational services include but may not be limited to live teacher-student interaction, online subject wise informative media contents, entrance examination preparatory matters, and technical support for educational projects. However, the plurality of educational services is not limited to the above-mentioned services. In an example, a student S1 finds difficult to solve a differential equation problem P1. The student S1 searches for online lecture for differential equations on an education platform E1 through a communication device D1 (let's say a smartphone).

In an embodiment of the present disclosure, the plurality of platforms 102 includes the real estate and housing platform 102G. In general, real estate and housing platform enables the various individuals to access personalized digital real estate and housing information and minimizes efforts of the corresponding individual. In addition, the real estate and housing platform 102G provides the plurality of real estate services. The plurality of real estate services include but may not be limited to houses on rent, properties on sale, house cleaning, garbage disposal, home repair, maintenance, and interior designing. However, the plurality of real estate services is not limited to the above-mentioned services. In an example, an individual 11 surfs for an apartment A1 in Dallas on a real estate platform through a communication device D1 (let's say a laptop).

In an embodiment of the present disclosure, the plurality of platforms 102 includes the travel platform 102H. In general, travel platform enables the various individuals to access personalized digital travel and hospitality information. In addition, the travel platform 102H provides the plurality of travel services. The plurality of travel services include but may not be limited to flight booking, train booking, taxi hiring, vacation deals, hotel booking, travel destination information, couch-surfing travel, and hot restaurant deals. However, the plurality of travel services is not limited to the above-mentioned services. In an example, an individual 11 wants to book a hotel room R1 in Austin. The individual 11 surfs on a travel platform T1 through a communication device D1 (let's say a workstation).

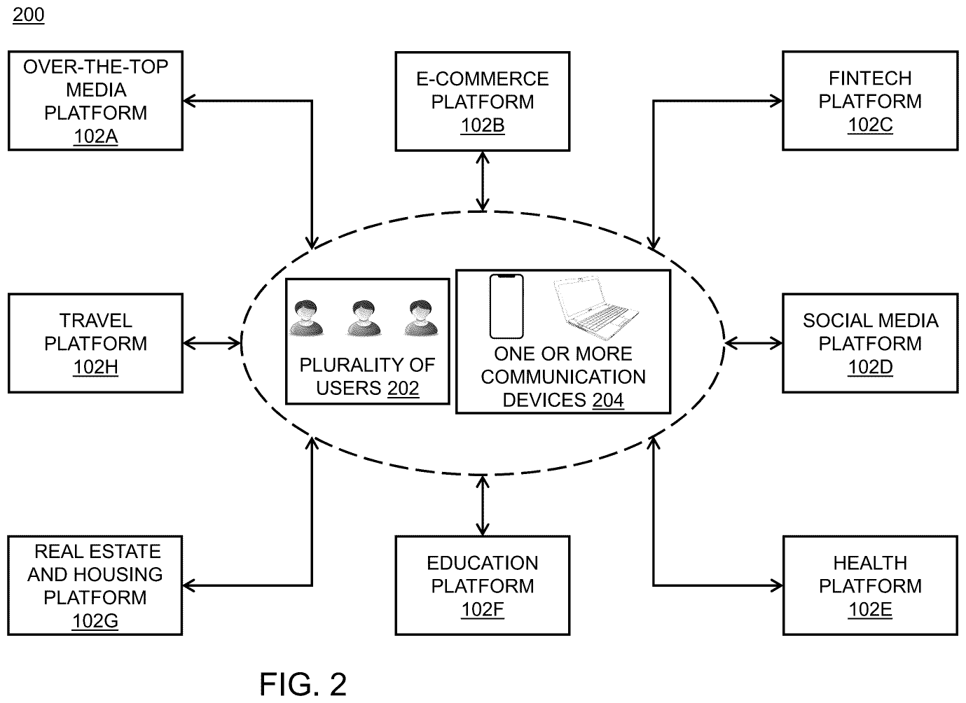

FIG. 2 illustrates a general overview of an interactive system 200 enabling interaction of a plurality of users 202 on the plurality of platforms 102 in real-time, in accordance with various embodiments of the present disclosure. The interactive system 200 is any environment facilitating interaction of the plurality of users 202 with the plurality of platforms 102. In addition, the interactive system 200 includes the plurality of users 202, one or more communication devices 204, and the plurality of platforms 102.

The interactive system 200 includes the plurality of users 202. In addition, the plurality of users 202 may be any person or individual accessing the one or more communication devices 204. In an embodiment of the present disclosure, the plurality of users 202 is an owner of the one or more communication devices 204. In another embodiment of the present disclosure, the plurality of users 202 is not the owner of the one or more communication devices 204. In an embodiment of the present disclosure, the plurality of users 202 accesses the one or more communication devices 204 at home. In another embodiment of the present disclosure, the plurality of users 202 accesses the one or more communication devices 204 at a cafe. In yet another embodiment of the present disclosure, the plurality of users 202 accesses the one or more communication devices 204 in an office. In an example, a user U1 accesses a smartphone S1 while sitting in a lawn. In another example, a user U2 accesses a laptop L1 while travelling in car. In yet another example, a user U3 accesses a desktop computer D1 while working in the office.

The interactive system 200 includes the one or more communication devices 204. The plurality of users 202 is connected with the interactive system 200 through the one or more communication devices 204. In an embodiment of the present disclosure, the one or more communication devices 204 facilitate access to the plurality of platforms 102. In an embodiment of the present disclosure, each of the one or more communication devices 204 is a portable communication device. The portable communication device includes but may not be limited to a laptop, a smartphone, a tablet, and a smart watch.

In an example, the smartphone may be an iOS-based smartphone, an android-based smartphone, a windows-based smartphone and the like. In another embodiment of the present disclosure, each of the one or more communication devices 204 is a fixed communication device. The fixed communication device includes but may not be limited to a desktop, a workstation, a smart TV and a mainframe computer. In an embodiment of the present disclosure, the one or more communication devices 204 are currently in the switched-on state. The one or more communication devices 204 are any type of devices having an active internet. In addition, each of the plurality of users 202 accesses corresponding communication device of the one or more communication devices 204 in real-time.

In an embodiment of the present disclosure, the one or more communication devices 204 perform computing operations based on a suitable operating system installed inside the one or more communication devices 204. In general, the operating system is system software that manages computer hardware and software resources and provide common services for computer programs. In addition, the operating system acts as an interface for software installed inside the one or more communication devices 204 to interact with hardware components of the one or more communication devices 204. In an embodiment of the present disclosure, each of the one or more communication devices 204 performs computing operations based on any suitable operating system designed for the portable communication device. In an example, the operating system installed inside the one or more communication devices 204 is a mobile operating system. Further, the mobile operating system include but may not be limited to windows operating system, android operating system, iOS operating system, symbian operating system, bada operating system from Samsung Electronics and BlackBerry operating system, and sailfish. However, the operating system is not limited to above mentioned operating systems. In an embodiment of the present disclosure, the one or more communication devices 204 operate on any version of particular operating system corresponding to above mentioned operating systems.

In another embodiment of the present disclosure, the one or more communication devices 204 perform computing operations based on any suitable operating system designed for fixed communication device. In an example, the operating system installed inside the one or more communication devices 204 is windows. In another example, the operating system installed inside the one or more communication devices 204 is Mac. In yet another example, the operating system installed inside the one or more communication devices 204 is Linux based operating system. In yet another example, the operating system installed inside the one or more communication devices 204 is Chrome OS. In yet another example, the operating system installed inside the one or more communication devices 204 may be one of UNIX, Kali Linux, and the like. However, the operating system is not limited to above mentioned operating systems.

In an embodiment of the present disclosure, the one or more communication devices 204 operate on any version of windows operating system. In another embodiment of the present disclosure, the one or more communication devices 204 operate on any version of Mac operating system. In yet another embodiment of the present disclosure, the one or more communication devices 204 operate on any version of Linux operating system. In yet another embodiment of the present disclosure, the one or more communication devices 204 operate on any version of Chrome OS. In yet another embodiment of the present disclosure, the one or more communication devices 204 operate on any version of particular operating system corresponding to above mentioned operating systems.

In an embodiment of the present disclosure, the plurality of platforms 102 is installed on the one or more communication devices 204. The plurality of platforms 102 allows the plurality of users 202 to access the plurality of contents. In another embodiment of the present disclosure, the plurality of platforms 102 is run on a plurality of web browsers installed on the one or more communication devices 204. In an example, the plurality of web browsers include but may not be limited to Opera, Mozilla Firefox, Google Chrome, Internet Explorer, Microsoft Edge, Safari and UC Browser. Further, the plurality of web browsers installed on the one or more communication devices 204 runs on any version of the respective web browser of the above mentioned web browsers. In an example, a user U1 opens an e-commerce application E1 to buy cutlery items. In another example, a user U2 accesses a fintech wepage F2 on Google Chrome for a car loan.

The interactive system 200 includes the over-the top media platform 102A. The plurality of users 202 connects with the over-the top media platform 102A on the one or more communication devices 204 to access the plurality of OTT media contents. In an embodiment of the present disclosure, the over-the top media platform 102A is the application installed on the one or more communication devices 204. In another embodiment of the present disclosure, the over-the top media platform 102A is accessed on the one or more communication devices 204 through the plurality of web browsers. In an example, a user U1 watches a sci-fi movie M1 on an OTT platform O1 installed in a form of application on a communication device D1 (let's say a smartphone). In another example, a user U2 watches a stand-up comedy show S2 on an OTT platform O2 on a communication device D2 (let's say a desktop computer) through a web browser W2 (let's say Google Chrome). In yet another example, a user U3 adds an anime A3 to a watch-list W3 on an OTT platform O3 installed on a communication device D3 (let's say a tablet).

The interactive system 200 includes the e-commerce platform 102B. The plurality of users 202 connects with the e-commerce platform 102B on the one or more communication devices 204 to access the plurality of products. In an embodiment of the present disclosure, the e-commerce platform 102B is the application installed on the one or more communication devices 204. In another embodiment of the present disclosure, the e-commerce platform 102B is accessed on the one or more communication devices 204 through the plurality of web browsers. In an example, a user U1 surfs various smartwatches S1 on an e-commerce platform E1 installed in a form of application on a communication device D1 (let's say a smartphone). In another example, a user U2 buys a grooming kit G2 on an e-commerce platform E2 on a communication device D2 (let's say a desktop computer) through a web browser W2 (let's say UC Browser). In yet another example, a user U3 adds a musical instrument M3 (Let's say a guitar) to a cart on an e-commerce platform E3 installed on a communication device D3 (let's say a tablet).

The interactive system 200 includes the fintech platform 102C. The plurality of users 202 connects with the fintech platform 102C on the one or more communication devices 204 to access the plurality of financial services. In an embodiment of the present disclosure, the fintech platform 102C is the application installed on the one or more communication devices 204. In another embodiment of the present disclosure, the fintech platform 102C is accessed on the one or more communication devices 204 through the plurality of web browsers. In an example, a user U1 surfs various account opening options O1 on fintech platform F1 installed in a form of application on a communication device D1 (let's say a smartphone). In another example, a user U2 requests for car loan L2 on a fintech platform F2 on a communication device D2 (let's say a desktop computer) through a web browser W2 (let's say Google Chrome). In yet another example, a user U3 buys a credit card C3 on a fintech platform F3 on a communication device D3 (let's say a tablet) through a web browser W3 (let's say Microsoft Edge).

The interactive system 200 includes the social media platform 102D. The plurality of users 202 connects with the social media platform 102D on the one or more communication devices 204 to access the one or more social media contents. In an embodiment of the present disclosure, the social media platform 102D is the application installed on the one or more communication devices 204. In another embodiment of the present disclosure, the social media platform 102D is accessed on the one or more communication devices 204 through the plurality of web browsers. In an example, a user U1 surfs various multimedia content C1 (let's say a teaser of a music video) on a social media platform S1 installed in a form of application on a communication device D1 (let's say a smartphone). In another example, a user U2 promotes a handcraft product P2 (let's say a woodcraft vase) on a social media platform S2 on a communication device D2 (let's say a desktop computer) through a web browser W2 (let's say Mozilla Firefox). In yet another example, a user U3 streams live video V3 on a social media platform S3 through a web browser W3 (let's say Opera Browser). In yet another example, a manufacturer of goods, a service provider, and a retailer may join the social media platform S4. The social media platform S4 allows users U4 to be connected to the manufacturer of goods, the service provider, and the retailer.

The interactive system 200 includes the health platform 102E. The plurality of users 202 connects with the health platform 102E on the one or more communication devices 204 to access the plurality of health services. In an embodiment of the present disclosure, the health platform 102E is the application installed on the one or more communication devices 204. In another embodiment of the present disclosure, the health platform 102E is accessed on the one or more communication devices 204 through the plurality of web browsers. In an example, a user U1 surfs various healthcare contents (let's say a tuberculosis medicine) on a health platform H1 installed in a form of application on a communication device D1 (let's say a smartphone). In another example, a user U2 creates a dietary plan on a health platform H2 on a communication device D2 (let's say a desktop computer) through a web browser W2 (let's say Mozilla Firefox). In yet another example, a user U3 buys medicine M3 (let's say diabetes medicines) on a health platform H3 installed on a communication device D3 (let's say a tablet).

The interactive system 200 includes the education platform 102F. The plurality of users 202 connects with the education platform 102F on the one or more communication devices 204 to access the plurality of educational services. In an embodiment of the present disclosure, the education platform 102F is the application installed on the one or more communication devices 204. In another embodiment of the present disclosure, the education platform 102F is accessed on the one or more communication devices 204 through the plurality of web browsers. In an example, a user U1 surfs various mathematical training videos (let's say a differential equation lecture) on an education platform E1 on a communication device D1 (let's say a smartphone) through a web browser W1 (let's say UC Browser). In another example, a user U2 submits online science project (let's say a hydraulic power brakes) on an education platform E2 installed in a form of application on a communication device D2 (let's say a desktop computer). In yet another example, a user U3 prepares for common entrance exam on an education platform E3 installed on a communication device D3 (let's say a tablet).

The interactive system 200 includes the real estate and housing platform 102G. The plurality of users 202 connects with the real estate and housing platform 102G on the one or more communication devices 204 to access the plurality of real estate services. In an embodiment of the present disclosure, the real estate and housing platform 102G is the application installed on the one or more communication devices 204. In another embodiment of the present disclosure, the real estate and housing platform 102G is accessed on the one or more communication devices 204 through the plurality of web browsers. In an example, a user U1 surfs various apartments (let's say a studio apartment) on sale on a real estate platform R1 installed in a form of application on a communication device D1 (let's say a smartphone). In another example, a user U2 requests property seller contact details on a real estate platform R2 on a communication device D2 (let's say a desktop computer) through a web browser W2 (let's say Google Chrome). In yet another example, a user U3 uploads images of a property (let's say a penthouse) for sale on a real estate platform R3 on a communication device D3 (let's say a tablet). In yet another example, a user U4 negotiates online for rent of a bungalow on a real estate platform R4 installed on a communication device D4 (let's say a laptop).

The interactive system 200 includes the travel platform 102H. The plurality of users 202 connects with the travel platform 102H on the one or more communication devices 204 to access the plurality of travel services. In an embodiment of the present disclosure, the travel platform 102H is the application installed on the one or more communication devices 204. In another embodiment of the present disclosure, the travel platform 102H is accessed on the one or more communication devices 204 through the plurality of web browsers. In an example, a user U1 surfs various flight options to travel from California to Chicago on a travel platform T1 installed in a form of application on a communication device D1 (let's say a smartphone). In another example, a user U2 requests price quotations for twenty hotel rooms in Cleveland on a travel platform T2 on a communication device D2 (let's say a desktop computer) through a web browser W2 (let's say Safari Browser). In yet another example, a user U3 uploads images of food (let's say a Chinese Food) on a travel platform T3 installed on a communication device D3 (let's say a tablet). In yet another example, a user U4 books holiday package (let's say 5 days and 6 nights) for Switzerland on a travel platform T4 on a communication device D4 (let's say a laptop) through a web browser W4 (let's say Opera Browser).

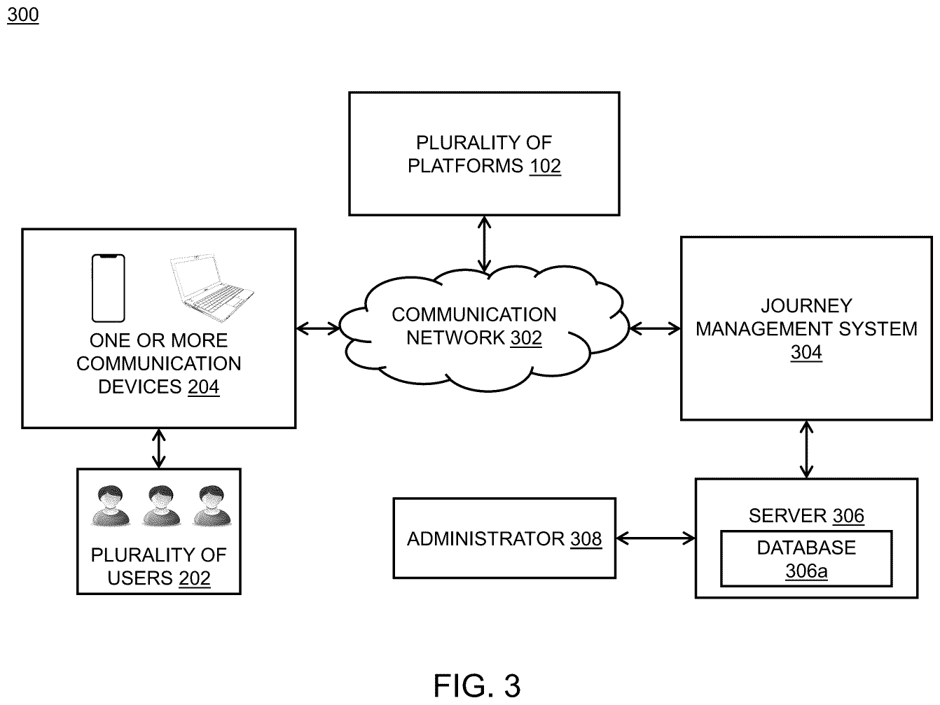

FIG. 3 illustrates an interactive computing environment 300 for generating a plurality of journeys for personalized engagement with the plurality of users 202 in real-time, in accordance with various embodiments of the present disclosure. The interactive computing environment 300 includes the plurality of users 202, the one or more communication devices 204, a communication network 302, and the plurality of platforms 102. In addition, the interactive computing environment 300 includes a journey management system 304, a server 306, a database 306a, and an administrator 308. The above stated elements of the interactive computing environment 300 operate coherently and synchronously to generate the plurality of journeys to engage the plurality of users 202 in real-time.

The interactive computing environment 300 includes the plurality of users 202.

The plurality of users 202 corresponds to any number of person or individual associated with the journey management system 304. The journey management system 304 accesses behavior of each of the plurality of users 202 on the plurality of platforms 102 through the one or more communication devices 204 using the communication network 302. In an example, a user U1 watches action movie on an online platform P1 through a communication device D1 (let's say a smartphone). In another example, a user U2 clicks on notification N2 (let's say renew of subscription with 20% discount) while surfing on an online platform P2 through a communication device D2 (let's say a desktop computer). In yet another example, a user U3 initiates video on demand transaction on an online platform P3 through a communication device D3 (let's say a laptop).

The interactive computing environment 300 includes the plurality of users 202. In addition, the plurality of users 202 accesses the plurality of platforms 102 through the one or more communication devices 204. Further, the one or more communication devices 204 are associated with the plurality of users 202. Furthermore, the journey management system 304 receives a first set of data associated with the plurality of users 202. The first set of data corresponds to personal information of the plurality of users 202. The first type of data comprises a marketing engagement (C) sent to the users, and an intended user action (G) to be executed against the sent marketing engagement. Moreover, the first set of data include but may not be limited to name data, age data, e-mail identity data, contact number data, gender data, geographic location data, and angiographic data. Also, the first set of data include but may not be limited to demographic data, payment cards data, banking partners data, salary data, loan data, lifetime data on each of the plurality of platforms 102 and relationship status data. In an embodiment of the present disclosure, the first set of data is received from database of the plurality of platforms 102, one or more communication device database, and third-party database. In another embodiment of the present disclosure, the first set of data is received from the plurality of users 202. In an example, a user U1 may provide his or her name, profile picture, city of residence, contact information, birth date, gender, marital status, employment, educational background, interests, and other demographic information.

In an embodiment, the marketing engagement (C) comprises notification, email, in-app message, wireless communication messages such as whats app, SMS, and wherein the intended user action comprises clicking on a link, viewing a product, purchasing an item.

In an embodiment of the present disclosure, the first set of data corresponds to the personal information of the plurality of users 202. In addition, the journey management system 304 protects the personal information of each of the plurality of users 202 in accordance with a data protection regulation. In general, data protection regulation is directive on protection and privacy of personal information for each individuals residing in any country. In addition, data protection regulation protects personal information of each individuals such that no information is made publicly available. Further, data protection regulation provides right to each individuals to know how personal information is being processed. Furthermore, data protection regulation allows each individual to regulate processing of personal information.

In an example, a user U2 provides name data on an OTT platform P1 while subscribing through a communication device D1 (let's say a smartphone). In another example, a user U3 installs various mobile applications on a communication device D2 (let's say a desktop computer) through an application store using internet connection. In yet another example, a student S1 chooses fifth standard while accessing geography lecture on an educational platform P2 through a communication device D3 (let's say a tablet). In yet another example, a user U4 provides an email-identity for receiving a real-time updates of regular health check-ups on a health platform P3 through a communication device D4 (let's say a laptop) using internet. In yet another example, a user U5 provides contact number on a fintech platform P4 to receive real-time text updates regarding saving account through a communication device D5 (let's say a smartphone). In yet another example, a user U6 provides salary information on a fintech platform P6 to apply for car loan through a communication device D6 (let's say a tablet). In yet another example, a user U7 provides geographical location on a real estate and housing platform P7 to search for properties in Miami using a communication device D7 (let's say a Workstation).

In an embodiment of the present disclosure, the first set of data is received from the over-the-top media platform 102A. In another embodiment of the present disclosure, the first set of data is received from the e-commerce platform 102B. In yet another embodiment of the present disclosure, the first set of data is received from the fintech platform 102C. In yet another embodiment of the present disclosure, the first set of data is received from the social media platform 102D. In yet another embodiment of the present disclosure, the first set of data is received from the health platform 102E. In yet another embodiment of the present disclosure, the first set of data is received from the education platform 102F. In yet another embodiment of the present disclosure, the first set of data is received from the real-estate and housing platform 102G. In yet another embodiment of the present disclosure, the first set of data is received from the travel platform 102H.

The interactive computing environment 300 includes the plurality of users 202 who is any person present at any location and accessing the plurality of contents. In addition, the plurality of contents is associated with the plurality of platforms 102. The plurality of users 202 is any legal person or natural person who access the plurality of contents and need an IP based network for accessing the plurality of contents. In addition, the plurality of users 202 is an individual or person who access the plurality of contents on the plurality of platforms 102 through the one or more communication devices 204. The plurality of users 202 is associated with the one or more communication devices 204.

In an embodiment of the present disclosure, the plurality of users 202 accesses the plurality of OTT media contents on the over-the-top media platform 102A. In another embodiment of the present disclosure, the plurality of users 202 accesses the plurality of products on the e-commerce platform 102B. In yet another embodiment of the present disclosure, the plurality of users 202 accesses the plurality of financial services on the fintech platform 102C. In yet another embodiment of the present disclosure, the plurality of users 202 accesses the one or more social media contents on the social media platform 102D. In yet another embodiment of the present disclosure, the plurality of users 202 accesses the plurality of health services on the health platform 102E. In yet another embodiment of the present disclosure, the plurality of users 202 accesses the plurality of educational services on the education platform 102F. In yet another embodiment of the present disclosure, the plurality of users 202 accesses the plurality of real estate services on the real-estate and housing platform 102G. In yet another embodiment of the present disclosure, the plurality of users 202 accesses the plurality of travel services on the travel platform 102H.

The interactive computing environment 300 includes the one or more communication devices 204 which enable the plurality of users 202 to access the plurality of platforms 102. The one or more communication devices 204 are internet-enabled device for allowing the plurality of users 202 to access the plurality of platforms 102. In an embodiment of the present disclosure, the plurality of users 202 is the owner of the one or more communication devices 204. In another embodiment of the present disclosure, the plurality of users 202 is not the owner of the one or more communication devices 204.

In an embodiment of the present disclosure, the plurality of users 202 installs an application of the over-the-top media platform 102A on the one or more communication devices 204. In another embodiment of the present disclosure, the plurality of users 202 installs an application of the e-commerce platform 102B on the one or more communication devices 204. In yet another embodiment of the present disclosure, the plurality of users 202 installs an application of the fintech platform 102C on the one or more communication devices 204. In yet another embodiment of the present disclosure, the plurality of users 202 installs an application of the social media platform 102D on the one or more communication devices 204. In yet another embodiment of the present disclosure, the plurality of users 202 installs an application of the health platform 102E on the one or more communication devices 204. In yet another embodiment of the present disclosure, the plurality of users 202 installs an application of the education platform 102F on the one or more communication devices 204. In yet another embodiment of the present disclosure, the plurality of users 202 installs an application of the real-estate and housing platform 102G on the one or more communication devices 204. In yet another embodiment of the present disclosure, the plurality of users 202 installs an application of the travel platform 102H on the one or more communication devices 204.

In an embodiment of the present disclosure, the plurality of users 202 accesses the over-the-top media platform 102A on the one or more communication devices 204 through the plurality of web browsers. In another embodiment of the present disclosure, the plurality of users 202 accesses the e-commerce platform 102B on the one or more communication devices 204 through the plurality of web browsers. In yet another embodiment of the present disclosure, the plurality of users 202 accesses the fintech platform 102C on the one or more communication devices 204 through the plurality of web browsers. In yet another embodiment of the present disclosure, the plurality of users 202 accesses the social media platform 102D on the one or more communication devices 204 through the plurality of web browsers. In yet another embodiment of the present disclosure, the plurality of users 202 accesses the health platform 102E on the one or more communication devices 204 through the plurality of web browsers. In yet another embodiment of the present disclosure, the plurality of users 202 accesses the education platform 102F on the one or more communication devices 204 through the plurality of web browsers. In yet another embodiment of the present disclosure, the plurality of users 202 accesses the real-estate and housing platform 102G on the one or more communication devices 204 through the plurality of web browsers. In yet another embodiment of the present disclosure, the plurality of users 202 accesses the travel platform 102H on the one or more communication devices 204 through the plurality of web browsers.

The interactive computing environment 300 includes the one or more communication devices 204. The one or more communication devices 204 provide an interface for the plurality of users 202 to interact with the interactive computing environment 300. The plurality of users 202 can interact with the interactive computing environment 300 through more than one device of the one or more communication devices 204. In an example, a user U1 connects with the interactive computing environment 300 through a communication device D1 (let's say a smartphone) to watch video on demand at home. In another example, a user U2 connects with the computing environment 300 through a communication device D2 (let's say a desktop computer) at home. The user U3 connects with the computing environment 300 with a communication device D3 (let's say a tablet) while travelling.

Each of the one or more communication devices 204 comprises of a memory. In general, the memory includes computer-storage media in the form of volatile and/or nonvolatile memory. The memory may be removable, non-removable, or a combination thereof. Exemplary hardware devices include solid-state memory, hard drives, optical-disc drives, etc. The memory is coupled with one or more processors. In general, the one or more processor read data from various entities such as memory or I/O components. The one or more processor execute the one or more instructions which are stored in the memory. The one or more processors provide execution method for one or more instructions provided by the journey management system 304.

The one or more communication devices 204 are a media device. The one or more communication devices 204 enable the plurality of users 202 to access the plurality of contents on the plurality of platforms 102. The one or more communication devices 204 support various multimedia contents. The plurality of users 202 accesses the plurality of contents in real-time through the one or more communication devices 204. In an embodiment of the present disclosure, the plurality of contents is a video stream. In another embodiment of the present disclosure, the plurality of contents corresponds to video on demand being accessed on the one or more communication devices 204. In yet another embodiment of the present disclosure, the plurality of contents is an audio clip. In yet another embodiment of the present disclosure, the plurality of contents corresponds to an e-commerce product. In yet another embodiment of the present disclosure, the plurality of contents is an illustration. In yet another embodiment of the present disclosure, the plurality of contents is an e-book. In yet another embodiment of the present disclosure, the plurality of contents is a podcast.

The interactive computing environment 300 includes the plurality of platforms 102. The plurality of users 202 performs various activities on the plurality of platforms 102 through the one or more communication devices 204. In addition, the plurality of users 202 accesses the plurality of contents on the plurality of platforms 102 in real-time. In an example, a user U1 watches comedy show C1 on online platform P1 through a communication device D1 (let's say a smartphone). In another example, a user U2 explores smart watches on the online platform P2 through the communication device D2 (let's say a desktop computer) in real-time. In yet another example, a user U3 reads fiction novel N1 on online platform P3 through a communication device D3 (let's say a laptop) in real-time. In yet another example, a user U4 clicks on notification N2 while watching adventure movie M1 on online platform P4 through a communication device D4 (let's say a tablet) in real-time. Further, the plurality of platforms 102 includes the over-the top media platform 102A, the e-commerce platform 102B, the fintech platform 102C, the social media platform 102D, and the health platform 102E. Furthermore, the plurality of platforms 102 includes the educational platform 102F, the real estate and housing platform 102G, and the travel platform 102H. However, the plurality of platforms 102 is not limited to the above-mentioned online platforms.

The interactive computing environment 300 includes the communication network 302. The one or more communication devices 204 are connected to the communication network 302. The communication network 302 provides a medium for the plurality of users 202 accessing the plurality of contents on the plurality of platforms 102 to connect with the journey management system 304. In an embodiment of the present disclosure, the communication network 302 is an internet connection. In another embodiment of the present disclosure, the communication network 302 is a wireless mobile network. In yet another embodiment of the present disclosure, the communication network 302 is a wired network with a finite bandwidth. In yet another embodiment of the present disclosure, the communication network 302 is a combination of the wireless and the wired network for the optimum throughput of data transmission. In yet another embodiment of the present disclosure, the communication network 302 is an optical fiber high bandwidth network that enables a high data rate with negligible connection drops. The communication network 302 includes a set of channels. Each channel of the set of channels supports a finite bandwidth. Moreover, the finite bandwidth of each channel of the set of channels is based on capacity of the communication network 302. The communication network 302 connects the one or more communication devices 204 to the journey management system 304 using a plurality of methods. The plurality of methods used to provide network connectivity to the one or more communication devices 204 includes 2G, 3G, 4G, 5G, Wifi and the like.

The interactive computing environment 300 includes the journey management system 304 which is associated with the plurality of platforms 102 and the plurality of users 202. In addition, the journey management system 304 enables segmentation of the plurality of users 202 in real-time based on various activities of the plurality of users 202. The journey management system 304 enables the granular level segmentation of the plurality of users 202 based on analysis done on the various activities of the plurality of users 202 on the plurality of platforms 102. The journey management system 304 creates one or more segments based on analysis done on various activities of the plurality of users 202. The journey management system 304 automatically generates the plurality of journeys to engage plurality of users 202 of the one or more segments in real-time.

The journey management system 304 receives the first set of data associated with the plurality of users 202 in real-time. The plurality of users 202 is associated with the one or more communication devices 204. In addition, the first set of data corresponds to the personal information of the plurality of users 202. The first set of data include but may not be limited to name data, age data, e-mail identity data, contact number data, gender data, geographic location data, and angiographic data. In addition, the first set of data include but may not be limited to demographic data, payment cards data, banking partners data, salary data, loan data, the lifetime data on each of the plurality of platforms 102 and relationship status data. In an example, users U1 provide the personal information on an online platform P1 while signing up for accessing various services and contents through communication devices C1 (let's say smartphones). In another example, users U2 provide the personal information on an online platform P2 before accessing various contents and services through communication devices C2 (let's say desktop computers). In yet another example, users U3 provide demographic data D3 on an online platform P3 while signing up for accessing various services and contents through communication devices C3 (let's say tablets). In yet another example, users U4 provide geographic data D4 on an online platform P4 while signing up for accessing various services and contents through communication devices C4 (let's say laptops). In yet another example, users U5 provide angiographic data on an online health platform P5 while accessing various services and contents.

In an embodiment of the present disclosure, the journey management system 304 accesses the first set of data from the over-the-top media platform 102A through the communication network 302. In another embodiment of the present disclosure, the journey management system 304 accesses the first set of data from the e-commerce platform 102B through the communication network 302. In yet another embodiment of the present disclosure, the journey management system 304 accesses the first set of data from the fintech platform 102C through the communication network 302. In yet another embodiment of the present disclosure, the journey management system 304 accesses the first set of data from the social media platform 102D through the communication network 302. In yet another embodiment of the present disclosure, the journey management system 304 accesses the first set of data from the health platform 102E through the communication network 302. In yet another embodiment of the present disclosure, the journey management system 304 accesses the first set of data from the education platform 102F through the communication network 302. In yet another embodiment of the present disclosure, the journey management system 304 accesses the first set of data from the real-estate and housing platform 102G through the communication network 302. In yet another embodiment of the present disclosure, the journey management system 304 accesses the first set of data from the travel platform 102H through the communication network 302. In addition, the first set of data may be received from the database of the plurality of platform 102, the one or more communication device database, and the third-party database.

In an embodiment for other type of data such as sent engagement C and intended user action G, a time window for performing the intended user action G after the sent user engagement C (e.g., within 24 hours, 7 days, etc.) can be configured based on the to be launched campaign requirements. Each engagement C is associated with the following metadata:
Engagement Type: Notification, email, in-app message, etc.
Timestamp: The exact time the engagement was sent.
Intended user action or Goal Event G: The intended user action (e.g., clicking on a link, viewing a product, purchasing an item).

The journey management system 304 fetches a second set of data associated with a plurality of past events of the plurality of users 202 on the plurality of platforms 102 through the one or more communication devices 204. In addition, the second set of data corresponds the plurality of past events of the plurality of users 202. In an example, the plurality of past events include but may not be limited to past uniform resource locater visits, past number of visits, past number of pages accessed, past webpage visited, and past accessed content. In another example, the plurality of past events include but may not be limited to past application installed, past number of times application installed, past application launched, past number of times application launched, and past application uninstalled. In yet another example, the plurality of past events include but may not be limited to past started content, past paused content, past resumed content, past searched content, past notification clicks, and past notification views. In yet another example, the plurality of past events include but may not be limited to past products surfed, past products added to cart, past reviews for products, past favorite product category, and past inactivity for products. In yet another example, the plurality of past events include but may not be limited to past accounts opened, past credit card requests, past credit cards issued, past loan requests, and past net-banking requests. In yet another example, the plurality of past events include but may not be limited to past multimedia content surfed, past multimedia content watched, past texts exchanged, past business blogs, and past live media streamed. In yet another example, the plurality of past events include but may not be limited to past audio-video callings, past medicines searched, past medicines bought, and past medical test kit bought. In yet another example, the plurality of past events include but may not be limited to past medical tests scheduled, past bill payments, past doctor consultation scheduled, and past hospital visit planned. In yet another example, the plurality of past events include but may not be limited to past dietary plan requested, past personal trainer hired, past fitness center searched, and past educational video searched. In yet another example, the plurality of past events include but may not be limited to past educational video watched, past projects submitted, past mock tests subscribed, and past educational counselling requested. In yet another example, the plurality of past events include but may not be limited to past problem solving session requested, past international masters interests, and past properties searched. In yet another example, the plurality of past events include but may not be limited to past properties watched, past properties bought, past rented properties searched, and past maintenance services requested. In yet another example, the plurality of past events include but may not be limited to past hotel searched, past hotels added to watch-list, past hotel bookings, past holiday plans searched, and past holiday plans booked. In yet another example, the plurality of past events include but may not be limited to past stock exchange investments, past money donated, past inactivity for product category, and past account created. In yet another example, the plurality of past events include but may not be limited to past products bought, past repeated products, past subscriptions, past subscription renewals, and past subscription skipped. In yet another example, the plurality of past events include but may not be limited to past initiated transactions, past failed transactions, past content added to cart, and past completed transactions. In yet another example, the plurality of past events include but may not be limited to past most visited category, past content details watched, past video on demand accessed, past video on demand initiated, and past video on demand searched. Further, the second set of data may be fetched from the database of the plurality of platforms 102, the one or more communication device database, and the third-party database.

In an embodiment of the present disclosure, the journey management system 304 accesses the second set of data from the over-the-top media platform 102A through the communication network 302. In another embodiment of the present disclosure, the journey management system 304 accesses the second set of data from the e-commerce platform 102B through the communication network 302. In yet another embodiment of the present disclosure, the journey management system 304 accesses the second set of data from the fintech platform 102C through the communication network 302. In yet another embodiment of the present disclosure, the journey management system 304 accesses the second set of data from the social media platform 102D through the communication network 302. In yet another embodiment of the present disclosure, the journey management system 304 accesses the second set of data from the health platform 102E through the communication network 302. In yet another embodiment of the present disclosure, the journey management system 304 accesses the second set of data from the education platform 102F through the communication network 302. In yet another embodiment of the present disclosure, the journey management system 304 accesses the second set of data from the real-estate and housing platform 102G through the communication network 302. In yet another embodiment of the present disclosure, the journey management system 304 accesses the second set of data from the travel platform 102H through the communication network 302.

In an embodiment of the present disclosure, the journey management system 304 fetches the plurality of past events performed on the over-the-top media platform 102A through the communication network 302. In addition, the plurality of past events performed on the over-the-top media platform 102A includes past content watched, past content paused, and past content added to watch later, and the like. Further, the plurality of past events performed on the over-the-top media platform 102A includes past subscriptions, past subscription renewals, past subscription transaction failures, past content details viewed and the like. Furthermore, the plurality of past events performed on the over-the-top media platform 102A includes past contents added to favorites, past content skipped, past subscription skipped, past most visited category, and the like.

In an example, a user U1 watched content C1 (let's say anime) on an OTT platform P1 in the past through a communication device D1 (let's say smartphones) using internet.

In another example, a user U2 paused content C2 (let's say comedy movie) on an OTT platform P2 in the past through a communication device D2 (let's say desktop computers) using internet. In yet another example, a user U3 added content C3 to a watch later list W1 on an OTT platform P3 in the past through a communication device D3 (let's say tablets) using internet. In yet another example, a user U4 subscribed for accessing an OTT platform P4 in the past through a communication device D4 (let's say laptops) using internet. In yet another example, a user U5 renewed subscription ten times for accessing an OTT platform P5 in the past through a communication device D5 using internet. In yet another example, a user U6 failed subscription transactions on an OTT platform P6 for accessing various contents in the past through a communication device D6 using internet. In yet another example, a user U7 watched description of content C7 (let's say stand-up comedy show) on an OTT platform P7 in the past through a communication device D7 using internet. In yet another example, a user U8 clicked notification N8 on an OTT platform P8 while accessing content C8 in the past through a communication device D8 using internet.

In an embodiment of the present disclosure, the journey management system 304 fetches the plurality of past events performed on the e-commerce platform 102B through the communication network 302. In addition, the plurality of past events performed on the e-commerce platform 102B includes past products surfed, past products added to cart, past account created, past products bought, past repeated products and the like. Further, the plurality of past events performed on the e-commerce platform 102B includes past transactions initiated, past transactions completed, past transactions failed, past notification clicks and the like. Furthermore, the plurality of past events performed on the e-commerce platform 102B includes past reviews for products, past favorite product category, past inactivity for products, past inactivity for product category, and the like.

In an example, a user U1 surfed a product T1 (let's say formal shirts) on an e-commerce platform P1 in the past through a communication device D1 (let's say smartphones) using internet. In another example, a user U2 added a product T2 (let's say a tablet) to a cart on an e-commerce platform P2 in the past through a communication device D2 (let's say desktop computers) using internet. In yet another example, a user U3 created online account A3 to buy a product T3 (let's say a refrigerator) on an e-commerce platform P3 in the past through a communication device D3 (let's say tablets) using internet. In yet another example, a user U4 bought a product T4 (let's say a smart television) while accessing an e-commerce platform P4 in the past through a communication device D4 (let's say laptops) using internet. In yet another example, a user U5 repeatedly bought a product T5 (let's say a sports shoes) on an e-commerce platform P5 in the past through a communication device D5 using internet. In yet another example, a user U6 initiated payment transaction 16 for a product T6 (let's say a non-fiction book) on an e-commerce platform P6 in the past through a communication device D6 using internet. In yet another example, a user U7 completed payment transaction C7 for a product T7 (let's say a grooming set) on an e-commerce platform P7 in the past through a communication device D7 using internet. In yet another example, a user U8 left payment transaction L8 for a product T8 (let's say a washing machine) on an e-commerce platform P8 in the past through a communication device D8 using internet. In yet another example, a user U9 reviewed a product T9 (let's say a Xbox) on an e-commerce platform P9 in the past through a communication device D9 using internet.

In an embodiment of the present disclosure, the journey management system 304 fetches the plurality of past events performed on the fintech platform 102C through the communication network 302. In addition, the plurality of past events performed on the fintech platform 102C includes past accounts opened, past credit card requests, past credit cards issued, past loan requests, past net-banking requests and the like. Further, the plurality of past events performed on the fintech platform 102C includes past bill payments, past stock exchange investments, past money donated, past notifications clicked and the like. Furthermore, the plurality of past events performed on the fintech platform 102C includes past transaction initiated, past transaction failed, past transaction left, past transaction completed and the like.

In an example, a user U1 opened an account A1 (let's say a saving account) on a fintech platform P1 in the past through a communication device D1 (let's say smartphones) using internet. In another example, a user U2 requested for a credit card C2 on a fintech platform P2 in the past through a communication device D2 (let's say desktop computers) using internet. In yet another example, a user U3 requested for loan L3 (let's say a home loan) on a fintech platform P3 in the past through a communication device D3 (let's say tablets) using internet. In yet another example, a user U4 requested to start net-banking service on a fintech platform P4 in the past through a communication device D4 (let's say laptops) using internet. In yet another example, a user U5 paid a bill B5 (let's say a broadband bill) through a fintech platform P5 in the past through a communication device D5 using internet. In yet another example, a user U6 invested money in stock exchange S6 on a fintech platform P6 in the past through a communication device D6 using internet. In yet another example, a user U7 donated money for social, disaster, environment and economical campaigns S7 (let's say a donation for Tsunami victims) on a fintech platform P7 in the past through a communication device D7 using internet. In yet another example, a user U8 clicked a notification N8 on a fintech platform P8 in the past through a communication device D8 using internet. In yet another example, a user U9 initiated transaction T9 (let's say $100) for credit card payments on a fintech platform P9 in the past through a communication device D9 using internet. In yet another example, a user U10 completed transaction T10 (let's say $150) for a grocery store G10 on a fintech platform P10 in the past through a communication device D10 using internet. In an embodiment of the present disclosure, the journey management system 304 fetches the plurality of past events performed on the social media platform 102D through the communication network 302. In addition, the plurality of past events performed on the social media platform 102D includes past multimedia content surfed, past multimedia content watched, past account created, past texts exchanged, past business blogs and the like. Further, the plurality of past events performed on the social media platform 102D includes past paid promotions, past services activated, past live media streamed, past audio-video callings, and the like.

In an example, a user U1 surfed a multimedia content M1 (let's say an animation cartoon) on a social media platform P1 in the past through a communication device D1 (let's say smartphones) using internet. In another example, a user U2 watched a multimedia content M2 (let's say an action movie teaser) on a social media platform P2 in the past through a communication device D2 (let's say desktop computers) using internet. In yet another example, a user U3 created an online account on a social media platform P3 in the past through a communication device D3 (let's say tablets) using internet. In yet another example, a user U4 exchanged a text message T4 (let's say a promotional text message) on a social media platform P4 in the past through a communication device D4 (let's say laptops) using internet. In yet another example, a user U5 wrote a business blog B5 (let's say a grooming product business blog) through a social media platform P5 in the past through a communication device D5 using internet. In yet another example, a user U6 requested for a paid promotion (let's say a paid promotion for clothing page) on a social media platform P6 in the past through a communication device D6 using internet. In yet another example, a user U7 streamed a live video L7 (let's say a live stream of a baseball match) on a social media platform P7 in the past through a communication device D7 using internet. In yet another example, a user U8 clicked a notification N8 on a social media platform P8 in the past through a communication device D8 using internet.

In an embodiment of the present disclosure, the journey management system 304 fetches the plurality of past events performed on the health platform 102E through the communication network 302. In addition, the plurality of past events performed on the health platform 102E includes past medicines searched, past medicines bought, past medical test kit bought, past medical tests scheduled, and the like. Further, the plurality of past events performed on the health platform 102E includes past transaction initiated, past transaction completed, past doctor consultation scheduled, past hospital visit planned, and the like. Furthermore, the plurality of past events performed on the health platform 102E includes past dietary plan requested, past personal trainer hired, past fitness center searched and the like.

In an example, a user U1 searched a medicine M1 (let's say a diabetes medicine) on a health platform P1 in the past through a communication device D1 (let's say smartphones) using internet. In another example, a user U2 bought a medicine M2 (let's say a blood pressure medicine) on a health platform P2 in the past through a communication device D2 (let's say desktop computers) using internet. In yet another example, a user U3 bought a medical kit M3 (let's say a sugar level test kit) on a health platform P3 in the past through a communication device D3 (let's say tablets) using internet. In yet another example, a user U4 scheduled a medical test T4 (let's say a pregnancy test) on a health platform P4 in the past through a communication device D4 (let's say laptops) using internet. In yet another example, a user U5 initiated a transaction T5 (let's say $10) for buying a medicine M5 on a health platform P5 in the past through a communication device D5 using internet. In yet another example, a user U6 completed a transaction T6 (let's say a $50) for medical kit M6 on a health platform P6 in the past through a communication device D6 using internet. In yet another example, a user U7 scheduled a consultation with a doctor D7 (let's say a cardiologist) on a health platform P7 in the past through a communication device D7 using internet. In yet another example, a user U8 requested a dietary plan M8 (let's a weight loss diet plan) on a health platform P8 in the past through a communication device D8 using internet. In yet another example, a user U9 hired a personal trainer T9 (let's an aerobics instructor) on a health platform P9 in the past through a communication device D9 using internet.

In an embodiment of the present disclosure, the journey management system 304 fetches the plurality of past events performed on the education platform 102F through the communication network 302. In addition, the plurality of past events performed on the education platform 102F includes past educational video searched, past educational video watched, past projects submitted, past account created, and the like. Further, the plurality of past events performed on the education platform 102F includes past transaction initiated, past transaction failures, past transaction completed, past notification clicked, and the like. Furthermore, the plurality of past events performed on the education platform 102F includes past mock tests subscribed, past educational counselling requested, past problem solving session requested, past international masters interests and the like.

In an example, a user U1 searched an educational video E1 (let's say an educational video on trigonometry) on an education platform P1 in the past through a communication device D1 (let's say smartphones) using internet. In another example, a user U2 watched an educational video E2 (let's say an educational video on Anatomy) on an education platform P2 in the past through a communication device D2 (let's say desktop computers) using internet. In yet another example, a user U3 submitted an educational project E3 (let's say an educational solar project) on an education platform P3 in the past through a communication device D3 (let's say tablets) using internet. In yet another example, a user U4 created an account A4 on an education platform P4 in the past through a communication device D4 (let's say laptops) using internet. In yet another example, a user U5 initiated a transaction T5 (let's say $10) for buying a zoology book Z5 on an education platform P5 in the past through a communication device D5 using internet. In yet another example, a user U6 completed a transaction T6 (let's say a $50) for a business communication skills lectures B6 on an education platform P6 in the past through a communication device D6 using internet. In yet another example, a user U7 clicked a notification N7 on an education platform P7 in the past through a communication device D7 using internet. In yet another example, a user U8 subscribed for a mock test M8 (let's a mock test for geography subject) on an education platform P8 in the past through a communication device D8 using internet. In yet another example, a user U9 requested a problem solving session S9 (let's a problem solving session with an Integration expert) on an education platform P9 in the past through a communication device D9 using internet.

In an embodiment of the present disclosure, the journey management system 304 fetches the plurality of past events performed on the real estate and housing platform 102G through the communication network 302. In addition, the plurality of past events performed on the real estate and housing platform 102G includes past properties searched, past properties watched, past properties bought, past rented properties searched, and the like. In addition, the plurality of past events performed on the real estate and housing platform 102G includes past account created, past maintenance services requested, past transaction initiated, past transaction completed and the like. In an example, a user U1 searched a property E1 (let's say an apartment in California) on a real estate and housing platform P1 in the past through a communication device D1 (let's say smartphones) using internet. In another example, a user U2 watched a property E2 (let's say a home in Alaska) on a real estate and housing platform P2 in the past through a communication device D2 (let's say desktop computers) using internet. In yet another example, a user U3 bought a property E3 (let's say a commercial property in New York) on a real estate and housing platform P3 in the past through a communication device D3 (let's say tablets) using internet. In yet another example, a user U4 created an account A4 on a real estate and housing platform P4 in the past through a communication device D4 (let's say laptops) using internet. In yet another example, a user U5 initiated a transaction T5 (let's say $15000) on a real estate and housing platform P5 in the past through a communication device D5 using internet. In yet another example, a user U6 completed a transaction T6 (let's say a $5000) on a real estate and housing platform P6 in the past through a communication device D6 using internet. In yet another example, a user U7 clicked a notification N7 (let's say a notification suggesting apartments in Chicago) on a real estate and housing platform P7 in the past through a communication device D7 using internet. In yet another example, a user U8 requested a maintenance service M8 (let's maintenance of electronic elements) on a real estate and housing platform P8 in the past through a communication device D8 using internet.

In an embodiment of the present disclosure, the journey management system 304 fetches the plurality of past events performed on the travel platform 102H through the communication network 302. In addition, the plurality of past events performed on the travel platform 102H includes past hotel searched, past hotels added to watch-list, past hotel bookings, past account created, past holiday plans searched, and the like. Further, the plurality of past events performed on the travel platform 102H includes past holiday plans booked, past transaction initiated, past transaction completed, past restaurant pre-booked, and the like.

In an example, a user U1 searched a hotel H1 (let's say a hotel in San Francisco) on a travel P1 in the past through a communication device D1 (let's say smartphones) using internet. In another example, a user U2 added a hotel H2 (let's say a hotel in Seattle) to a watch-list W2 on a travel platform P2 in the past through a communication device D2 (let's say desktop computers) using internet. In yet another example, a user U3 booked a hotel H3 (let's say a hotel in San Jose) on a travel platform P3 in the past through a communication device D3 using internet. In yet another example, a user U4 created an account A4 on a travel platform P4 in the past through a communication device D4 using internet. In yet another example, a user U5 searched a holiday plan H5 (let's say a holiday plan to Maldives for 5 days 4 nights) on a travel platform P5 in the past through a communication device D5 (let's say tablets) using internet. In yet another example, a user U6 booked a holiday plan H6 (let's say a holiday plan to Cairo for 4 days 5 nights) on a travel platform P6 in the past through a communication device D6 using internet. In yet another example, a user U7 initiated a transaction T7 (let's say $150) on a travel platform P7 in the past through a communication device D7 using internet. In yet another example, a user U8 completed a transaction T8 (let's say a $500) on a travel platform P8 in the past through a communication device D8 (let's say laptops) using internet. In yet another example, a user U9 clicked a notification N9 (let's say a notification suggesting Holiday plans for Switzerland) on a travel platform P9 in the past through a communication device D9 using internet. In yet another example, a user U10 pre-booked a restaurant R10 (let's an Indian restaurant in Dallas) on a travel platform P10 in the past through a communication device D10 using internet.

The journey management system 304 obtains a third set of data associated with a plurality of live events of the plurality of users 202 on the plurality of platforms 102 through the one or more communication devices 204. The third set of data corresponds the plurality of live events of the plurality of users 202 and especially an actual user action (E). User behavior following the engagement is tracked using events E, which represents any interaction or event type (e.g., click, add-to-cart, purchase). In an example, the plurality of live events include but may not be limited to real-time uniform resource locater visits, real-time number of webpage visits, and real-time number of webpages accessed. In another example, the plurality of live events includes but may not be limited to real-time application installed, real-time application launch, and real-time application uninstalled. In yet another example, the plurality of live events include but may not be limited to real-time webpage visit, real-time accessed content, real-time started content, real-time paused content, and real-time resumed content. In yet another example, the plurality of live events include but may not be limited to real-time searched content, real-time notification clicks, real-time notification views, real-time products surfed, and real-time products added to cart. In yet another example, the plurality of live events include but may not be limited to real-time reviews for products, real-time favorite product category, real-time inactivity for products, and real-time accounts opened. In yet another example, the plurality of live events include but may not be limited to real-time credit card requests, real-time credit cards issued, real-time loan requests, and real-time net-banking requests. In yet another example, the plurality of live events include but may not be limited to real-time multimedia content surfed, real-time multimedia content watched, real-time texts exchanged, and real-time business blogs. In yet another example, the plurality of live events include but may not be limited to real-time live media streamed, real-time audio-video callings, real-time medicines searched, and real-time medicines bought. In yet another example, the plurality of live events include but may not be limited to real-time medical test kit bought, real-time medical tests scheduled, real-time bill payments, and real-time doctor consultation scheduled. In yet another example, the plurality of live events include but may not be limited to real-time hospital visit planned, real-time dietary plan requested, real-time personal trainer hired, and real-time fitness center searched. In yet another example, the plurality of live events include but may not be limited to real-time educational video searched, real-time educational video watched, and real-time projects submitted. In yet another example, the plurality of live events include but may not be limited to real-time mock tests subscribed, real-time educational counselling requested, and real-time problem solving session requested. In yet another example, the plurality of live events include but may not be limited to real-time international masters interests, real-time properties searched, real-time properties watched, and real-time properties bought. In yet another example, the plurality of live events include but may not be limited to real-time rented properties searched, real-time maintenance services requested, and real-time hotel searched. In yet another example, the plurality of live events include but may not be limited to real-time hotels added to watch-list, real-time hotel bookings, real-time holiday plans searched, and real-time holiday plans booked. In yet another example, the plurality of live events include but may not be limited to real-time stock exchange investments, real-time money donated, real-time inactivity for product category, and real-time account created. In yet another example, the plurality of live events include but may not be limited to real-time products bought, real-time repeated products, real-time subscriptions, and real-time subscription renewals. In yet another example, the plurality of live events include but may not be limited to real-time subscription skipped, real-time initiated transactions, real-time failed transactions, and real-time content added to cart. In yet another example, the plurality of live events include but may not be limited to real-time completed transactions, real-time most visited category, real-time content details watched, and real-time video on demand accessed. In yet another example, the plurality of live events include but may not be limited to real-time video on demand initiated, and real-time video on demand searched. The third set of data extracted from plurality of events largely may be categorized as clicking on a link, viewing a product, purchasing an item.

In an embodiment of the present disclosure, the journey management system 304 accesses the third set of data from the over-the-top media platform 102A through the communication network 302. In another embodiment of the present disclosure, the journey management system 304 accesses the third set of data from the e-commerce platform 102B through the communication network 302. In yet another embodiment of the present disclosure, the journey management system 304 accesses the third set of data from the fintech platform 102C through the communication network 302. In yet another embodiment of the present disclosure, the journey management system 304 accesses the third set of data from the social media platform 102D through the communication network 302. In yet another embodiment of the present disclosure, the journey management system 304 accesses the third set of data from the health platform 102E through the communication network 302. In yet another embodiment of the present disclosure, the journey management system 304 accesses the third set of data from the education platform 102F through the communication network 302. In yet another embodiment of the present disclosure, the journey management system 304 accesses the third set of data from the real-estate and housing platform 102G through the communication network 302. In yet another embodiment of the present disclosure, the journey management system 304 accesses the third set of data from the travel platform 102H through the communication network 302.

In an embodiment of the present disclosure, the journey management system 304 obtains the plurality of live events performed on the over-the-top media platform 102A through the communication network 302. In addition, the plurality of live events performed on the over-the-top media platform 102A includes content watched in real-time, content paused in real-time, and content added to watch later in real-time. Further, the plurality of live events performed on the over-the-top media platform 102A includes subscriptions in real-time, subscription renewals in real-time, subscription transaction failures in real-time, content details viewed in real-time and the like. Furthermore, the plurality of live events performed on the over-the-top media platform 102A includes contents added to favorites in real-time, content skipped in real-time, subscription skipped in real-time, most visited category in real-time, and the like.

In an example, a user U1 watches content C1 (let's say comic anime) on an OTT platform P1 in real-time through a communication device D1 (let's say smartphones) using internet. In another example, a user U2 pauses content C2 (let's say horror movie) on an OTT platform P2 in the real-time through a communication device D2 using internet. In yet another example, a user U3 adds content C3 (let's say a documentary) to a watch later list W1 on an OTT platform P3 in the real-time through a communication device D3 (let's say desktop computers) using internet. In yet another example, a user U4 subscribes for accessing an OTT platform P4 in the real-time through a communication device D4 using internet. In yet another example, a user U5 renews subscription for accessing an OTT platform P5 in the real-time through a communication device D5 (let's say tablets) using internet. In yet another example, a user U6 fails subscription transactions on an OTT platform P6 for accessing various contents in the real-time through a communication device D6 using internet. In yet another example, a user U7 watches description of content C7 (let's say stand-up comedy show) on an OTT platform P7 in the real-time through a communication device D7 (let's say laptops) using internet. In yet another example, a user U8 clicks notification N8 on an OTT platform P8 while accessing content C8 in the real-time through a communication device D8 using internet. In an embodiment of the present disclosure, the journey management system 304 obtains the plurality of live events performed on the e-commerce platform 102B through the communication network 302. In addition, the plurality of live events performed on the e-commerce platform 102B includes products surfed in real-time, products added to cart in real-time, account created in real-time, products bought in real-time, repeated products in real-time and the like. Further, the plurality of live events performed on the e-commerce platform 102B includes transactions initiated in real-time, transactions completed in real-time, transactions failed in real-time, notification clicks in real-time and the like. Furthermore, the plurality of live events performed on the e-commerce platform 102B includes reviews for products in real-time, product category visits in real-time, inactivity for products in real-time, inactivity for product category in real-time, and the like.

In an example, a user U1 surfs a product T1 (let's say sport shoes) on an e-commerce platform P1 in real-time through a communication device D1 (let's say smartphones) using internet. In another example, a user U2 adds a product T2 (let's say a smartphone) to a cart on an e-commerce platform P2 in the real-time through a communication device D2 using internet. In yet another example, a user U3 creates online account A3 to buy a product T3 (let's say a washing machine) on an e-commerce platform P3 in the past through a communication device D3 (let's say desktop computers) using internet. In yet another example, a user U4 buys a product T4 (let's say a smartwatch) while accessing an e-commerce platform P4 in the real-time through a communication device D4 using internet. In yet another example, a user U5 repeatedly buys a product T5 (let's say a formal trouser) on an e-commerce platform P5 in the real-time through a communication device D5 (let's say tablets) using internet. In yet another example, a user U6 initiates payment transaction 16 for a product T6 (let's say a non-fiction book) on an e-commerce platform P6 in the real-time through a communication device D6 using internet. In yet another example, a user U7 completes payment transaction C7 for a product T7 (let's say a Bluetooth speaker) on an e-commerce platform P7 in the real-time through a communication device D7 (let's say laptops) using internet. In yet another example, a user U8 leaves payment transaction L8 for a product T8 (let's say a mattress) on an e-commerce platform P8 in the real-time through a communication device D8 using internet. In yet another example, a user U9 reviews a product T9 (let's say a play station) on an e-commerce platform P9 in the real-time through a communication device D9 using internet.

In an embodiment of the present disclosure, the journey management system 304 obtains the plurality of live events performed on the fintech platform 102C through the communication network 302. In addition, the plurality of live events performed on the fintech platform 102C includes accounts opened in real-time, credit card requests in real-time, credit cards issued in real-time, loan requests in real-time, net-banking requests in real-time and the like. Further, the plurality of live events performed on the fintech platform 102C includes bill payments in real-time, stock exchange investments in real-time, money donated in real-time, notifications clicked in real-time, and the like. Furthermore, the plurality of live events performed on the fintech platform 102C includes transaction initiated in real-time, transaction failed in real-time, transaction left in real-time, transaction completed in real-time, and the like.

In an example, a user U1 opens an account A1 (let's say a saving account) on a fintech platform P1 in the real-time through a communication device D1 (let's say smartphones) using internet. In another example, a user U2 requests for a credit card C2 on a fintech platform P2 in the real-time through a communication device D2 using internet. In yet another example, a user U3 requests for loan L3 (let's say a home loan) on a fintech platform P3 in the real-time through a communication device D3 (let's desktop computers) using internet. In yet another example, a user U4 requests to start net-banking service on a fintech platform P4 in the real-time through a communication device D4 using internet. In yet another example, a user U5 pays a bill B5 (let's say a broadband bill) through a fintech platform P5 in the real-time through a communication device D5 (let's say tablets) using internet. In yet another example, a user U6 invests money in stock exchange S6 on a fintech platform P6 in the real-time through a communication device D6 using internet. In yet another example, a user U7 donates money for social, disaster, environment and economical campaigns S7 (let's say a donation for Tsunami victims) on a fintech platform P7 in the real-time through a communication device D7 (let's say laptops) using internet. In yet another example, a user U8 clicks a notification N8 on a fintech platform P8 in the real-time through a communication device D8 using internet. In yet another example, a user U9 initiates transaction T9 (let's say $50) for credit card payments on a fintech platform P9 in the real-time through a communication device D9 using internet. In yet another example, a user U10 completes transaction T10 (let's say $100) for a grocery store G10 on a fintech platform P10 in the real-time through a communication device D10 using internet.

In an embodiment of the present disclosure, the journey management system 304 obtains the plurality of live events performed on the social media platform 102D through the communication network 302. In addition, the plurality of live events performed on the social media platform 102D includes multimedia content surfed in real-time, multimedia content watched in real-time, and account created in real-time. Further, the plurality of live events performed on the social media platform 102D includes texts exchanged in real-time, business blogs accessed in real-time, paid promotions in real-time, and the like. Furthermore, the plurality of live events performed on the social media platform 102D includes services activated in real-time, live media streamed in real-time, audio-video callings in real-time, and the like.

In an example, a user U1 surfs a multimedia content M1 (let's say an animation cartoon) on a social media platform P1 in the real-time through a communication device D1 (let's say smartphones) using internet. In another example, a user U2 watches a multimedia content M2 (let's say an action movie teaser) on a social media platform P2 in the real-time through a communication device D2 using internet. In yet another example, a user U3 creates an online account on a social media platform P3 in the real-time through a communication device D3 (let's say laptops) using internet. In yet another example, a user U4 exchanges a text message T4 (let's say a promotional text message) on a social media platform P4 in the real-time through a communication device D4 using internet. In yet another example, a user U5 writes a business blog B5 (let's say a grooming product business blog) through a social media platform P5 in the real-time through a communication device D5 (let's say desktop computers) using internet. In yet another example, a user U6 requests for a paid promotion (let's say a paid promotion for clothing page) on a social media platform P6 in the real-time through a communication device D6 using internet. In yet another example, a user U7 streams a live video L7 (let's say a live stream of a baseball match) on a social media platform P7 in the real-time through a communication device D7 (let's say tablets) using internet. In yet another example, a user U8 clicks a notification N8 on a social media platform P8 in the real-time through a communication device D8 using internet.

In an embodiment of the present disclosure, the journey management system 304 obtains the plurality of live events performed on the health platform 102E through the communication network 302. In addition, the plurality of live events performed on the health platform 102E includes medicines searched in real-time, medicines bought in real-time, medical test kit bought in real-time, and the like. Further, the plurality of live events performed on the health platform 102E includes medical tests scheduled in real-time, transaction initiated in real-time, transaction completed in real-time, and the like. Furthermore, the plurality of live events performed on the health platform 102E includes doctor consultation scheduled in real-time, hospital visit planned in real-time, and the like. Moreover, the plurality of live events performed on the health platform 102E includes dietary plan requested in real-time, personal trainer hired in real-time, fitness center searched in real-time and the like.

In an example, a user U1 searches a medicine M1 (let's say a diabetes medicine) on a health platform P1 in the real-time through a communication device D1 (let's say desktop computers) using internet. In another example, a user U2 buys a medicine M2 (let's say a blood pressure medicine) on a health platform P2 in the real-time through a communication device D2 using internet. In yet another example, a user U3 buys a medical kit M3 (let's say a sugar level test kit) on a health platform P3 in the real-time through a communication device D3 (let's say smartphones) using internet. In yet another example, a user U4 schedules a medical test T4 (let's say a pregnancy test) on a health platform P4 in the real-time through a communication device D4 using internet. In yet another example, a user U5 initiates a transaction T5 (let's say $10) for buying a medicine M5 on a health platform P5 in the real-time through a communication device D5 (let's say tablets) using internet. In yet another example, a user U6 completes a transaction T6 (let's say a $50) for medical kit M6 on a health platform P6 in the real-time through a communication device D6 using internet. In yet another example, a user U7 schedules a consultation with a doctor D7 (let's say a cardiologist) on a health platform P7 in the real-time through a communication device D7 using internet. In yet another example, a user U8 requests a dietary plan M8 (let's a weight loss diet plan) on a health platform P8 in the real-time through a communication device D8 (let's say laptops) using internet. In yet another example, a user U9 hires a personal trainer T9 (let's an aerobics instructor) on a health platform P9 in the real-time through a communication device D9 using internet.

In an embodiment of the present disclosure, the journey management system 304 obtains the plurality of live events performed on the education platform 102F through the communication network 302. In addition, the plurality of live events performed on the education platform 102F includes educational video searched in real-time, educational video watched in real-time, projects submitted in real-time, and the like. Further, the plurality of live events performed on the education platform 102F includes account created in real-time, and the like. Furthermore, the plurality of live events performed on the education platform 102F includes transaction initiated in real-time, transaction failures in real-time, transaction completed in real-time, and the like. Moreover, the plurality of live events performed on the education platform 102F includes notification clicked in real-time, mock tests subscribed in real-time, educational counselling requested in real-time, and the like. Also, the plurality of live events performed on the education platform 102F includes problem solving session requested in real-time, international masters searched in real-time, and the like.

In an example, users U1 search an educational video E1 (let's say an educational video on trigonometry) on an education platform P1 in the real-time through a communication device D1 (let's say laptops) using internet. In another example, users U2 watch an educational video E2 (let's say an educational video on Anatomy) on an education platform P2 in the real-time through a communication device D2 (let's say tablets) using internet. In yet another example, users U3 submit an educational project E3 (let's say an educational solar project) on an education platform P3 in the real-time through a communication device D3 using internet. In yet another example, users U4 create an account A4 on an education platform P4 in the real-time through a communication device D4 using internet. In yet another example, users U5 initiate a transaction T5 (let's say $10) for buying a zoology book Z5 on an education platform P5 in the real-time through a communication device D5 (let's say desktop computers) using internet. In yet another example, users U6 complete a transaction T6 (let's say a $50) for a business communication skills lectures B6 on an education platform P6 in the real-time through a communication device D6 using internet. In yet another example, users U7 click a notification N7 on an education platform P7 in the real-time through a communication device D7 using internet. In yet another example, users U8 subscribe for a mock test M8 (let's a mock test for geography subject) on an education platform P8 in the real-time through a communication device D8 (let's say smartphones) using internet. In yet another example, users U9 request a problem solving session S9 (let's a problem solving session with an Integration expert) on an education platform P9 in the real-time through a communication device D9 using internet.

In an embodiment of the present disclosure, the journey management system 304 obtains the plurality of live events performed on the real estate and housing platform 102G through the communication network 302. In addition, the plurality of live events performed on the real estate and housing platform 102G includes properties searched in real-time, properties watched in real-time, properties bought in real-time, and the like. Further, the plurality of live events performed on the real estate and housing platform 102G includes rented properties in real-time, maintenance services requested in real-time, and the like. Furthermore, the plurality of live events performed on the real estate and housing platform 102G includes transaction initiated in real-time, account created in real-time, transaction completed in real-time, and the like.

In an example, users U1 search a property E1 (let's say an apartment in California) on a real estate and housing platform P1 in the real-time through a communication device D1 (let's say tablets) using internet. In another example, users U2 watch a property E2 (let's say a home in Alaska) on a real estate and housing platform P2 in the real-time through a communication device D2 using internet. In yet another example, users U3 buy a property E3 (let's say a commercial property in New York) on a real estate and housing platform P3 in the real-time through a communication device D3 (let's say desktop computers) using internet. In yet another example, users U4 create an account A4 on a real estate and housing platform P4 in the real-time through a communication device D4 using internet. In yet another example, users U5 initiate a transaction T5 (let's say $15000) on a real estate and housing platform P5 in the real-time through a communication device D5 using internet. In yet another example, users U6 complete a transaction T6 (let's say a $5000) on a real estate and housing platform P6 in the real-time through a communication device D6 (let's say laptops) using internet. In yet another example, users U7 click a notification N7 (let's say a notification suggesting apartments in Chicago) on a real estate and housing platform P7 in the real-time through a communication device D7 using internet. In yet another example, users U8 request a maintenance service M8 (let's maintenance of electronic elements) on a real estate and housing platform P8 in the real-time through a communication device D8 (let's say smartphones) using internet.

In an embodiment of the present disclosure, the journey management system 304 obtains the plurality of live events performed on the travel platform 102H through the communication network 302. In addition, the plurality of live events performed on the travel platform 102H includes hotel searched in real-time, hotels added to watch-list in real-time, hotel bookings in real-time, and the like. Further, the plurality of live events performed on the travel platform 102H includes account created in real-time, holiday plans searched in real-time, holiday plans booked in real-time, and the like. Furthermore, the plurality of live events performed on the travel platform 102H includes transaction initiated in real-time, transaction completed in real-time, restaurant pre-booked in real-time, and the like.

In an example, users U1 search a hotel H1 (let's say a hotel in San Francisco) on a travel P1 in the real-time through a communication device D1 (let's say smartphones) using internet. In another example, users U2 add a hotel H2 (let's say a hotel in Seattle) to a watch-list W2 on a travel platform P2 in the real-time through a communication device D2 (let's say tablets) using internet. In yet another example, users U3 book a hotel H3 (let's say a hotel in San Jose) on a travel platform P3 in the real-time through a communication device D3 using internet. In yet another example, users U4 create an account A4 on a travel platform P4 in the real-time through a communication device D4 using internet. In yet another example, users U5 search a holiday plan H5 (let's say a holiday plan to Maldives for 5 days 4 nights) on a travel platform P5 in the real-time through a communication device D5 using internet. In yet another example, users U6 book a holiday plan H6 (let's say a holiday plan to Cairo for 4 days 5 nights) on a travel platform P6 in the real-time through a communication device D6 (let's say desktop computers) using internet. In yet another example, users U7 initiate a transaction T7 (let's say $150) on a travel platform P7 in the real-time through a communication device D7 using internet. In yet another example, users U8 complete a transaction T8 (let's say a $500) on a travel platform P8 in the real-time through a communication device D8 (let's say laptops) using internet. In yet another example, users U9 click a notification N9 (let's say a notification suggesting Holiday plans for Switzerland) on a travel platform P9 in the real-time through a communication device D9 using internet. In yet another example, users U10 pre-book a restaurant R10 (let's an Indian restaurant in Dallas) on a travel platform P10 in the real-time through a communication device D10 using internet.

The journey management system 304 further computes an optimal time (H*ᵤ H*_{global}) of sending marketing engagement (C) by capturing an hour of the day where the user were most active hour or when the majority of users were most active. The optimal time of the engagement with the plurality of users in the plurality of journeys is computed using user-specific historical data subject to availability or multiple user data. In an embodiment, the Optimal Send Time Calculation may be categorized as follows
a) For Users with Historical Goal Event Data
For users who have performed the goal event G in the past, the system determines the hour of the day H*ᵤ where the user u was most active in G:

$${H}_{u}^{*} = arg {max}_{h ∈ [ 0 , 23 ]} {T}_{G , h} ( u )$$

### Where:

T_{G,h}(u) represents the total occurrences of G by user u during hour h in the past.
b) For Users without Historical Goal Event Data
If the user has not performed G in the past, the system considers the hour H*_{global} when the majority of users were most active in G:

$${H}_{global}^{*} = arg {max}_{h ∈ [ 0 , 23 ]} {\sum }_{u ∈ U} {T}_{G , h} ( u )$$

Where U is the set of all users in the system.
c) Fallback Mechanism
If neither user-specific nor global data for G exists (e.g., in cases of new goal events), the system falls back to the hour when users were most active in all interactions:

$${H}_{fallback}^{*} = arg {max}_{h ∈ [ 0 , 23 ]} {\sum }_{e ∈ E} {\sum }_{u ∈ U} {T}_{e , h} ( u )$$

Where E is the set of all event types.

The journey management system 304 analyzes the first set of data, the second set of data and the third set of data using an XGBoost machine learning model in real-time. In an embodiment of the present disclosure, the one or more machine learning algorithms include a decision tree algorithm and a random forest algorithm. In another embodiment of the present disclosure, the one or more machine learning algorithms include but may not be limited to prediction algorithms, deep learning algorithms, natural language processing algorithm and the like. However, the one or more machine learning algorithms are not limited to the above-mentioned algorithms. The analysis of the first set of data, the second set of data, the optimal time, and the third set of data based on the one or more machine learning algorithms is done in real-time. In addition, the journey management system 304 creates a machine learning model to perform analysis of the first set of data, the second set of data, the optimal time, and the third set of data. The machine learning model is trained to identify one or more patterns from the first set of data, the second set of data, and the third set of data for the one or more segments and a plurality of intent based micro-segments. Specifically, the analysis is defined as predicting one or more patterns as a probability of user intent. The XGBoost model is trained not only to predict (a target variable Ŷᵤ) whether the user will perform a goal in accordance with the user intent but also to evaluate the likelihood (Hu) of engagement success at specific times. The combined model predicts the probability of the user intent defined by at-least one of:
Probability (Ŷᵤ) whether the user will perform a predetermined goal. The same denotes a probability of performing a goal in accordance with the user intent after engagement, and
A likelihood (Au) of success of the sent engagement of the user at each hour. The same denotes a probability distribution over hours h, indicating the likelihood of engagement success at each hour.
   Based on the probabilities, the plurality of intent based micro-segments are created in real-time, and are classified into High, Medium, and Low intent categories using the XGBoost machine learning model.
   For analysis, the machine learning model is trained based on a feature vector comprising features for User Interaction and Engagement.
   To predict Ŷᵤ, a feature vector Xu is created for each user u. This feature vector captures the following dimensions:
   1. Engagement Features (captured as first type of data)
C_{type}: Type of engagement sent (e.g., notification, email).
Cₜᵢₘₑ: Timestamp of the engagement.
G_{type}: Type of goal event associated with the engagement.
   2. Behavioral Features (captured as third type of data)
Generic Event Intensity
   For each event e∈E:
      Daily intensity: I_{daily}(u, e, d).
      Rolling intensity: Iₙ(u, e).
      Hourly intensity: I_{hourly}(u, e, h).
Goal-Specific Features
   Intensity of actions specifically related to G:

I_{goal}(u,G)=Occurrences of G/Total Actions by u

### 3. Profile Features

Device Type: D(u).
Operating System: OS(u).
User's historical preferences, such as interaction frequency with products or categories Fp(u).
   4. User-Specific Optimal Hour or first type of computed optimal time: H*ᵤ
   5. Global Optimal Hour or second type computed optimal time: H*_{global}
   6. Time Difference: The time difference between the current time and the calculated optimal hour H*ᵤ:

$$Δ H = \vert {H}_{current} - {H}_{u}^{*} \vert$$

Accordingly, a complete feature vector Xu is structured based on but not limited to aforesaid six features. Further, the machine Learning Model XGBoost model is trained not only to predict whether the user will perform (target variable Ŷᵤ) a goal or intended user action G in accordance with the user intent, but also to evaluate the likelihood (Ĥᵤ) of engagement success at specific times. The combined model predicts:
1. Ýᵤ: Probability of performing G after engagement.
2. Ĥᵤ: Probability distribution over hours h, indicating the likelihood of engagement success at each hour.
   The machine Learning Model XGBoost is trained using a combined loss function associated with prediction of the probabilities of the user intent. The loss function may be provided as follows:
1. Binary classification loss Lᵢₙₜₑₙₜ for Ýᵤ:

$${L}_{intent} = {\sum }_{i = 1}^{N} Loss ( {Y}_{i} , {\hat{Y}}_{i} )$$

2. Multiclass classification loss Lₜᵢₘₑ for H*ᵤ:

$${L}_{time} = - {\sum }_{i = 1}^{N} {\sum }_{h = 0}^{23} {P}_{actual} ( h ) log ( {P}_{predicted} ( h ) )$$

Where P_{actual}(h) is the actual probability (1 for the optimal hour, 0 otherwise) and P_{predicted}(h) is the predicted probability for each hour.
The combined loss function may be referred as:

$$L = α {L}_{intent} + ( 1 - α ) {L}_{time}$$

Where α controls the weight given to intent prediction versus optimal time prediction.

In other embodiment, the journey management system 304 vide the machine Learning Model XGBoost is designed to predict the probability (Y) of intended user action G to perform a goal event, where said type of intended user action G to perform goal event is the intended outcome of the sent marketing engagement C (e.g., clicking on a link, purchasing a product, completing a registration) and optimal time Hᵤ and H_{global} to send engagements, based on the user's historical activity in the goal event

For each engagement C sent to a user U, the target variable Y is defined as:

$$Y = \{ \begin{matrix}1 & if user u performs the goal event G after engagement C \\ 0 & otherwise\end{matrix}$$

The time window for performing the intended user action G after sending the engagement C (e.g., within 24 hours, 7 days, etc.) may be configured based on the campaign requirements

Based on aforesaid, the journey management system 304 provides a personalized Engagement Delivery.
For a user u, the engagement C is sent at the predicted optimal time H*ᵤ or H*_{global} if user-specific data is unavailable.
The content of C is personalized based on the user's predicted intent Ýᵤ.

The journey management system 304 further provides a batch campaign optimization, since for large-scale campaigns, users can be grouped by their optimal send times H*ᵤ to maximize engagement efficiency.

The journey management system 304 further provides a dynamic Engagement Timing if real-time user behavior indicates changes in activity patterns, the system dynamically adjusts the predicted optimal time for future engagements.

The journey management system 304 identifies the one or more patterns of the user intent based on the aforesaid training of the machine learning model on the plurality of past events, the plurality of live events, and a plurality of features in real-time. The one or more patterns include uniform resource locater visit pattern, webpage visit pattern, number of webpage accessed pattern, accessed content pattern, started content pattern, paused content pattern, and the like.

In addition, the one or more patterns include application installation pattern, application launch pattern, application uninstallation pattern, and the like. Further, the one or more patterns include resumed content pattern, searched content pattern, notification click pattern, notification views pattern, products surfed pattern, products added to cart pattern, and the like. Furthermore, the one or more patterns include reviews for products pattern, favorite product category pattern, inactivity for products pattern, accounts opened pattern, credit card requests pattern, and the like. Moreover, the one or more patterns include credit cards issued pattern, loan request patterns, net-banking requests pattern, multimedia content surfed pattern, multimedia content watched pattern, and the like. Also, the one or more patterns include texts exchanged pattern, business blogs pattern, live media streamed pattern, audio-video calling pattern, medicines searched pattern, medicines bought pattern, and the like. Also, the one or more patterns include medical test kit bought pattern, medical tests scheduled pattern, bill payments pattern, doctor consultation scheduled pattern, hospital visit pattern, and the like. Also, the one or more patterns include dietary plan request pattern, personal trainer hired pattern, fitness center search pattern, educational video search pattern, educational video watched pattern, and the like. Also, the one or more patterns include projects submission pattern, mock tests subscription pattern, educational counselling request pattern, problem solving session request pattern, and the like. Also, the one or more patterns include international masters interests pattern, properties search pattern, properties watched pattern, properties bought pattern, rented properties search pattern, and the like. Also, the one or more patterns include maintenance services request pattern, hotel search pattern, hotels added to watch-list pattern, hotel bookings pattern, holiday plans search pattern, and the like. Also, the one or more patterns include holiday plans booked pattern, stock exchange investments pattern, money donated pattern, inactivity for product category pattern, account creation pattern, and the like. Also, the one or more patterns include products bought pattern, repeated products pattern, subscriptions pattern, subscription renewals pattern, subscription skipped pattern, initiated transactions pattern, and the like. Also, the one or more patterns include failed transactions pattern, content added to cart pattern, completed transactions pattern, most visited category pattern, content details watched pattern, and the like. Also, the one or more patterns include video on demand accessed pattern, video on demand initiated pattern, video on demand searched pattern, and the like.

The plurality of features includes recency, frequency, time during weekdays, time during weekends, time based features, days based features, age based features, events based features, inactivity based features, and the like. Furthermore, the plurality of features includes user properties features, demographic features, geographic features, technographic features, number of visits in specific days, number of app launches in the specific days, and the like. However, the plurality of features is not limited to the above-mentioned features.

The machine learning model is trained to analyze the first set of data, the second set of data, and the third set of data. In addition, the machine learning model is trained to identify the match of the one or more patterns of each of the plurality of users 202. In an embodiment of the present disclosure, the machine learning model is trained using supervised machine learning model. In another embodiment of the present disclosure, the machine learning model is trained using un-supervised machine learning model. Moreover, the machine learning model predicts behavior of each of the plurality of users 202 based on the one or more patterns, the second set of data and the third set of data. Also, the behavior of the plurality of users is predicted in real-time.

The journey management system 304 enables the segmentation of the plurality of users 202 in the one or more segments in one or more categories using the one or more machine learning algorithms. Such plurality of intent based micro-segments are created in real-time, and are classified into High, Medium, and Low intent categories using the aforesaid XGBoost machine learning model. In an embodiment of the present disclosure, the one or more categories include the past behavior category and the live behavior category. However, the one or more online categories are not limited to the above-mentioned categories. In addition, the past behavior category corresponds a category where behavior and interests of the plurality of users 202 are considered to create the one or more segments. The past behavior category includes a plurality of first sub-categories. The plurality of first sub-categories includes a past action sub-category, a past inaction sub-category, a past action with properties sub-category, and the like. Further, the past action sub-category includes the plurality of past events, and one or more parameters. The one or more parameters include day, time, language, location, events, inactivity, and online platform. Furthermore, the past inaction sub-category includes a plurality of past inactions, and the plurality of parameters. The plurality of past inactions corresponds to the plurality of past actions not performed by the plurality of users 202. Moreover, the past action with properties sub-category includes a plurality of properties and the plurality of parameters. The plurality of properties includes user properties, demographic properties, geographic properties, technographic properties, reachability, application fields, and the like. The user properties include activation date, birthday, e-mail identity, customer type, preferred language, preferred genre, postal code, and the like. The demographic properties include age, gender and the like. The geographic properties include continents, countries, states, cities, villages and the like. The technographic properties include the plurality of browsers, the one or more communication devices 204, the operating system, and the like. The reachability includes device token, e-mail identity, contact number, and the like.

In addition, the live behavior category corresponds a category where behavior and interests displayed by the plurality of users 202 in real-time to create the one or more segments. The live behavior category includes a plurality of second sub-categories. The plurality of second sub-categories includes a real-time action sub-category, a real-time inaction sub-category, a real-time page visit sub-category, a real-time page count sub-category, and the like. Further, the real-time action sub-category includes the plurality of live events, and the plurality of parameters. Furthermore, the real-time inaction sub-category includes a plurality of live inactions, and the plurality of parameters. The plurality of live inactions corresponds to the plurality of live events not performed by the plurality of users 202 within a certain time.

In an embodiment of the present disclosure, the one or more segments of the plurality of users 202 are created based on at least one feature of the plurality of features. The one or more segments are created in real-time. In addition, the one or more segments of the plurality of the users 202 are created based on the one or more patterns. Further, the one or more segments are created using each of the one or more patterns of corresponding user of the plurality of users 202. Also, the each of the one or more patterns of corresponding user of the plurality of users 202 are analyzed using the one or more machine learning algorithms.

As referred previously, the probability Ŷᵤ, represents the likelihood that the user performs the goal event or the intended user action G after receiving the sent engagement C. These probabilities Ŷᵤ are further categorized into three levels of intent:
High Intent
Medium Intent
Low Intent

The categorization is performed using thresholds derived from F-scores, i.e.
https://en.wikipedia.org/wiki/F-score,
   which balances precision and recall based on different beta values. The probability Ŷᵤ is categorized as High Intent and defined by a lower beta value (β_{high}<1) that is used to emphasize precision over recall. This ensures that users categorized as “High Intent” have a high likelihood of performing the goal event. The threshold for High Intent is determined as:

$${P}_{high} = arg {max}_{P} {F}_{{β}_{high}} ( P )$$

Where P_{high} is the predicted probability of said High Intent category, and β_{high} prioritizes precision while computing the F score. The probability Ŷᵤ is categorized as Low intent based on the probability P_{low} and defined by a higher beta value (β_{low}>1) to emphasize recall over precision. This ensures that users unlikely to perform the goal event are captured in the “Low Intent” category. The threshold for Low Intent is determined as:

$${P}_{low} = arg {max}_{P} {F}_{{β}_{low}} ( P )$$

The probability Ŷᵤ categorized as Medium intent and defined by a higher beta value. Users with predicted probabilities Ŷᵤ falling between P_{low} and P_{high} are categorized as “Medium Intent.” Overall, the probability Ŷᵤ is categorized as:

$$Intent Lev el = \{ \begin{matrix}High , & if {\hat{Y}}_{u} \geq {P}_{high} \\ Medium , & if {P}_{low} \leq {\hat{Y}}_{u} < {P}_{high} \\ Low , & if {\hat{Y}}_{u} < {P}_{low}\end{matrix}$$

In an embodiment of the present disclosure, the one or more segments of the plurality of users 202 are created based on the recency. In another embodiment of the present disclosure, the one or more segments of the plurality of users 202 are created based on the frequency. In yet another embodiment of the present disclosure, the one or more segments of the plurality of users 202 are created based on the time based features. In another embodiment of the present disclosure, the one or more segments of the plurality of users 202 are created based on the days based features. In yet another embodiment of the present disclosure, the one or more segments of the plurality of users 202 are created based on the age based features. In yet another embodiment of the present disclosure, the one or more segments of the plurality of users 202 are created based on the location based features. In yet another embodiment of the present disclosure, the one or more segments of the plurality of users 202 are created based on the events based features. In yet another embodiment of the present disclosure, the one or more segments of the plurality of users 202 are created based on the inactivity based features. In yet another embodiment of the present disclosure, the one or more segments of the plurality of users 202 are created based on the categories based features. In yet another embodiment of the present disclosure, the one or more segments of the plurality of users 202 are created based on the sub-categories based features.

In an example, segment S1 is created for users U1 performing actions A1 (let's say notification click) on an online platform P1 (let's say social media platform) on communication devices D1 (let's say laptop) using a feature F1 (let's say time feature) in a category C1 (let's say past behavior category). In another example, segment S2 is created for users U2 performing actions A2 (let's say webpage launched) on an online platform P2 (let's say over-the-top platform) on communication devices D2 (let's say smartphone) using a feature F2 (let's say day feature) in a category C2 (let's say page count category). In yet another example, segment S3 is created for users U3 performing actions A3 (let's say wrist watch added to watchlist) on an online platform P3 (let's say e-commerce platform) on communication devices D3 (let's say desktop) using a feature F3 (let's say geographic location feature) in a category C3 (let's say live behavior category). In yet another example, segment S4 is created for users U4 performing actions A4 (let's say paused a genetics lecture and inaction) on an online platform P4 (let's say education platform) on communication devices D4 (let's say tablet) using a feature F4 (let's say inactivity feature) in a category C4 (let's say real-time inaction category). In yet another example, segment S5 is created for users U5 performing actions A5 (let's say transaction initiated) on an online platform P5 (let's say fintech platform) on communication devices D5 (let's say laptop) using a feature F5 (let's say activities feature) in a category C5 (let's say demographic category).

The journey management system 304 creates the plurality of intent based micro-segments associated with each of the one or more segments to initiate the generation of the plurality of journeys to achieve each of one or more goals. The plurality of intent based micro-segments corresponds to intent based target groups. In general, the target groups provides information regarding prospect to meet each of the one or more goals. The plurality of intent based micro-segments includes most likely, moderately likely, least likely and the like.

The journey management system 304 creates a segment trend plot for each of the one or more segments and each of the plurality of intent based micro-segments. In addition, the segment trend plot is in one or more forms. Further, the one or more forms include but not limited to bar graph, histogram, pictogram, pie graph, line graph, and cartesian graph. In an embodiment of the present disclosure, the segment trend plot corresponds to the line graph. In another embodiment of the present disclosure, the segment trend plot corresponds to the bar graph. In yet another embodiment of the present disclosure, the segment trend plot corresponds to the cartesian graph. In yet another embodiment of the present disclosure the segment trend plot corresponds to the pie graph. Furthermore, the segment trend plot is downloaded in one or more formats, wherein the one or more formats include chart, joint photographic experts group, portable network graphics, portable document format, scalable vector graphics, and comma-separated values. In an embodiment of the present disclosure, the segment trend plot is downloaded in the joint photographic experts group format. In another embodiment of the present disclosure, the segment trend plot is downloaded in the portable network graphics format. In yet another embodiment of present disclosure, the segment trend plot is downloaded in the portable document format.

The journey management system 304 automatically generates the plurality of journeys to engage the plurality of users 202 through a plurality of channels based on the analysis of the first set of data, the second set of data and the third set of data. The journeys are generated based on one or more patterns of user intent by the steps of:
a) personalization of the marketing engagement to be sent to the user based on the patterns of user intent; and
b) selecting an optimal content to be delivered via the personalized marketing engagement at the predicted optimal time, said selection performed via a multi-bandit algorithm based on the user intent and a campaign context.

The multi-arm bandit algorithm may be updated for an updated selection of the optimal content based on a reward signal derived from user action in response to previously delivered optimal content through the personalized engagement. The selected content comprises reminders, recommendations, discounts based on the user intent and the context of campaign, and wherein the multi bandit algorithm for selected content is at least one of upper confidence bound and Thomson sampling.

In an embodiment, a framework for Multi-Armed Bandits for Content Selection is provided. For each intent segment (High, Medium, Low), the journey management system 304 employs a Multi-Armed Bandit (MAB) algorithm to dynamically select the best content variant (arm) for each user. The arms represent different content types (e.g., reminders, recommendations, discounts) tailored to a campaign context. A reward signal is based on whether the user performs the goal event:

Example algorithm options for Multi-Armed Bandit (MAB) algorithm may be:
1. Upper Confidence Bound (UCB), which is based on Average reward for arm, Number of times arm has been selected, total number of trials.
2. Thompson Sampling, which is based on prior successes for arm, and prior failures for arm

Example Applications pursued by the journey management system 304 based on the predicted user intent (Yu and Hu) and selection of the content based on multibandit algorithm may be
a) Cart Drop-Off Campaign: High intent segmented users receive a strong recommendation or discount offer, Medium Intent segmented users receive a balanced reminder, and Low Intent segmented users receive trending items or general engagement content.
b) Onboarding Campaign: High intent segmented users receive reminders to complete the process, medium intent segmented users receive educational messages about the benefits of onboarding, and low intent segemented Users receive incentives to spark interest.

In addition, the plurality of generated journeys corresponds to data driven decision making work flow automation to engage the plurality of users 202 through the plurality of channels. Further, the plurality of journeys include but may not be limited to user onboarding journeys, promotional journeys, and long running re-engagement journeys. Furthermore, the user onboarding journeys engage the plurality of users 202 over several days or weeks and on the plurality of channels to introduce the plurality of contents and services. Moreover, the promotional journeys entice the plurality of users 202 to transact at different points of time. Also, the long running re-engagement journeys pull the plurality of users 202 back into the plurality of contents and the services if the plurality of users 202 starts to slip away. Also, each of the plurality of journeys is a combination of a plurality of segment nodes and a plurality of engagement nodes. Also, the journey management system 304 automatically detects the plurality of segment nodes and the plurality of engagement nodes. Also, the journey management system 304 identifies optimal time and placement for each of the plurality of segment nodes and each of the plurality of engagement nodes. Also, the plurality of segment nodes include but may not be limited to action, inaction, past behavior, date, time, journey trigger, an entry criterion, page visit, referrer entry, and page count. The plurality of channels include but may not be limited to mobile channels, email channels, desktop channels, social channels, remarketing channels, server channels, and the like. However, the various channels are not limited to the above-mentioned channels. The mobile channels include mobile push, SMS, and application inbox. In addition, the remarketing channels include audiences and google ads. Further, the social channels include WhatsApp, Facebook, Skype, Google Hangouts, Microsoft Teams, Slack, Business Chat, Telegram, and the like.

In an embodiment of the present disclosure, the journey management system 304 automatically generates the plurality of journeys to engage the plurality of users 202 of the one or more segments of the over-the-top media platform 102A. In another embodiment of the present disclosure, the journey management system 304 automatically generates the plurality of journeys to engage the plurality of users 202 of the e-commerce platform 102B. In yet another embodiment of the present disclosure, the journey management system 304 automatically generates the plurality of journeys to engage the plurality of users 202 of the fintech platform 102C. In yet another embodiment of the present disclosure, the journey management system 304 automatically generates the plurality of journeys to engage the plurality of users 202 of the social media platform 102D. In yet another embodiment of the present disclosure, the journey management system 304 automatically generates the plurality of journeys to engage the plurality of users 202 of the health platform 102E. In yet another embodiment of the present disclosure, the journey management system 304 automatically generates the plurality of journeys to engage the plurality of users 202 of the education platform 102F. In yet another embodiment of the present disclosure, the journey management system 304 automatically generates the plurality of journeys to engage the plurality of users 202 of the real-estate and housing platform 102G. In yet another embodiment of the present disclosure, the journey management system 304 automatically generates the plurality of journeys to engage the plurality of users 202 of the travel platform 102H.

In an embodiment of the present disclosure, the journey management system 304 automatically generates the user onboarding journeys to engage the plurality of users 202 of the one or more segments of the over-the-top media platform 102A. In another embodiment of the present disclosure, the journey management system 304 automatically generates the user onboarding journeys to engage the plurality of users 202 of the e-commerce platform 102B. In yet another embodiment of the present disclosure, the journey management system 304 automatically generates the user onboarding journeys to engage the plurality of users 202 of the fintech platform 102C. In yet another embodiment of the present disclosure, the journey management system 304 automatically generates the user onboarding journeys to engage the plurality of users 202 of the social media platform 102D. In yet another embodiment of the present disclosure, the journey management system 304 automatically generates the user onboarding journeys to engage the plurality of users 202 of the health platform 102E. In yet another embodiment of the present disclosure, the journey management system 304 automatically generates the user onboarding journeys to engage the plurality of users 202 of the education platform 102F. In yet another embodiment of the present disclosure, the journey management system 304 automatically generates the user onboarding journeys to engage the plurality of users 202 of the real-estate and housing platform 102G. In yet another embodiment of the present disclosure, the journey management system 304 automatically generates the user onboarding journeys to engage the plurality of users 202 of the travel platform 102H.

In an embodiment of the present disclosure, the journey management system 304 automatically generates the promotional journeys to engage the plurality of users 202 of the one or more segments of the over-the-top media platform 102A. In another embodiment of the present disclosure, the journey management system 304 automatically generates the promotional journeys to engage the plurality of users 202 of the e-commerce platform 102B. In yet another embodiment of the present disclosure, the journey management system 304 automatically generates the promotional journeys to engage the plurality of users 202 of the fintech platform 102C. In yet another embodiment of the present disclosure, the journey management system 304 automatically generates the promotional journeys to engage the plurality of users 202 of the social media platform 102D. In yet another embodiment of the present disclosure, the journey management system 304 automatically generates the promotional journeys to engage the plurality of users 202 of the health platform 102E. In yet another embodiment of the present disclosure, the journey management system 304 automatically generates the promotional journeys to engage the plurality of users 202 of the education platform 102F. In yet another embodiment of the present disclosure, the journey management system 304 automatically generates the promotional journeys to engage the plurality of users 202 of the real-estate and housing platform 102G. In yet another embodiment of the present disclosure, the journey management system 304 automatically generates the promotional journeys to engage the plurality of users 202 of the travel platform 102H.

In an embodiment of the present disclosure, the journey management system 304 automatically generates the long running re-engagement journeys to engage the plurality of users 202 of the one or more segments of the over-the-top media platform 102A. In another embodiment of the present disclosure, the journey management system 304 automatically generates the long running re-engagement journeys to engage the plurality of users 202 of the e-commerce platform 102B. In yet another embodiment of the present disclosure, the journey management system 304 automatically generates the long running re-engagement journeys to engage the plurality of users 202 of the fintech platform 102C. In yet another embodiment of the present disclosure, the journey management system 304 automatically generates the long running re-engagement journeys to engage the plurality of users 202 of the social media platform 102D. In yet another embodiment of the present disclosure, the journey management system 304 automatically generates the long running re-engagement journeys to engage the plurality of users 202 of the health platform 102E. In yet another embodiment of the present disclosure, the journey management system 304 automatically generates the long running re-engagement journeys to engage the plurality of users 202 of the education platform 102F. In yet another embodiment of the present disclosure, the journey management system 304 automatically generates the long running re-engagement journeys to engage the plurality of users 202 of the real-estate and housing platform 102G. In yet another embodiment of the present disclosure, the journey management system 304 automatically generates the long running re-engagement journeys to engage the plurality of users 202 of the travel platform 102H.

The journey management system 304 creates the one or more goals for each of the plurality of journeys of the plurality of platforms 102 in real-time. In general, goal is to achieve a target for any event for a specific journey in a selected timeframe. The one or more goals are ambitious aim of the plurality of platforms 102 for the plurality of journeys. Each of the one or more goals is tracked in real-time. In addition, the one or more goals include but may not be limited to maximizing uniform resource locater visits, maximizing number of visits, maximizing number of pages accessed, maximizing webpage visits, and maximizing application installations. Further, the one or more goals include but may not be limited to maximizing application launches, minimizing application uninstallations, maximizing accessed content, maximizing started content, and minimizing paused content. Furthermore, the one or more goals include but may not be limited to maximizing searched content, maximizing notification clicks, maximizing notification views, maximizing products surfed, and maximizing products added to cart. Moreover, the one or more goals include but may not be limited to maximizing reviews for products, minimizing inactivity for products, maximizing accounts opening, maximizing credit card requests, and maximizing credit cards issued. Also, the one or more goals include but may not be limited to maximizing loan requests, maximizing net-banking requests, maximizing multimedia content surfed, maximizing multimedia content watched, and maximizing texts exchange. Also, the one or more goals include but may not be limited to maximizing live media streaming, maximizing audio-video callings, maximizing medicines searched, maximizing medicines bought, and maximizing medical test kit bought. Also, the one or more goals include but may not be limited to maximizing dietary plan requests, maximizing personal trainer hiring, maximizing fitness center searches, and maximizing educational video searches. Also, the one or more goals include but may not be limited to maximizing educational video watched, maximizing projects submission, maximizing mock tests subscription, and maximizing properties searches. Also, the one or more goals include but may not be limited to maximizing properties watched, maximizing rented properties searches, maximizing maintenance services requests, and maximizing hotel searches. Also, the one or more goals include but may not be limited to maximizing hotel bookings, maximizing holiday plans searches, maximizing holiday plans bookings, and maximizing stock exchange investments. Also, the one or more goals include but may not be limited to maximizing money donations, maximizing account creations, maximizing subscription renewals, minimizing subscription skipped, and maximizing initiated transactions. Also, the one or more goals include but may not be limited to minimizing failed transactions, maximizing completed transactions, and minimizing transaction cancellations.

In an embodiment of the present disclosure, the journey management system 304 creates the one or more goals for the plurality of journeys of the over-the-top media platform 102A. In another embodiment of the present disclosure, the journey management system 304 creates the one or more goals for the plurality of journeys of the e-commerce platform 102B. In yet another embodiment of the present disclosure, the journey management system 304 creates the one or more goals for the plurality of journeys of the fintech platform 102C. In yet another embodiment of the present disclosure, the journey management system 304 creates the one or more goals for the plurality of journeys of the social media platform 102D. In yet another embodiment of the present disclosure, the journey management system 304 creates the one or more goals for the plurality of journeys of the health platform 102E. In yet another embodiment of the present disclosure, the journey management system 304 creates the one or more goals for the plurality of journeys of the education platform 102F. In yet another embodiment of the present disclosure, the journey management system 304 creates the one or more goals for the plurality of journeys of the real-estate and housing platform 102G. In yet another embodiment of the present disclosure, the journey management system 304 creates the one or more goals for the plurality of journeys of the travel platform 102H.

In an embodiment of the present disclosure, the journey management system 304 creates the one or more goals for the plurality of journeys of the over-the-top media platform 102A. In addition, the one or more goals include maximizing content watched, maximizing content reach, maximizing account created, maximizing subscriptions, minimizing content paused, minimizing inactivity and the like. Further, the one or more goals include maximizing subscription renewal, maximizing application installation, minimizing content stopped, minimizing incomplete transactions, minimizing content excluded from watchlist and the like.

In an example, goal G1 (let's say maximizing anime watched) is created for users U1 of Journey J1 accessing an OTT platform P1 on communication devices D1 (let's say laptop) using a feature F1 (let's say time feature). In another example, goal G2 (let's say minimizing inactivity for horror movies) is assigned for users U2 of journey J2 accessing an OTT platform P2 on communication devices D2 (let's say smartphone) using a feature F2 (let's say recency feature). In yet another example, goal G3 (let's say minimizing webpage closed) is assigned for users U3 of Journey J3 accessing an OTT platform P3 on communication devices D3 (let's say desktop) using a feature F3 (let's say frequency feature). In yet another example, goal G4 (let's say maximizing application launched) is assigned for users U4 of Journey J4 accessing an OTT platform P4 on communication devices D4 (let's say tablet) using a feature F4 (let's say sub-category feature). In yet another example, goal G5 (let's say maximizing subscriptions) is assigned for users U5 of journey J5 accessing an OTT platform P5 on communication devices D5 (let's say laptop) using a feature F5 (let's say activities feature). In yet another example, goal G6 (let's say maximizing transaction completed) is assigned for users U6 of journey J6 accessing an OTT platform P6 on communication devices D6 (let's say smartphone) using a feature F6 (let's say monetary feature).

In an embodiment of the present disclosure, the journey management system 304 creates the one or more goals for the plurality of journeys of the e-commerce platform 102B. In addition, the one or more goals include maximizing products surfed, maximizing products added to cart, maximizing account created, maximizing products bought and the like. Further, the one or more goals include maximizing transaction initiated, minimizing application uninstalled, minimizing inaction time, minimizing product removed from cart, minimizing product unavailability and the like.

In an example, goal G1 (let's say maximizing mattress surfed) is assigned for users U1 of Journey J1 accessing an e-commerce platform P1 on communication devices D1 (let's say laptop) using a feature F1 (let's say activities feature). In another example, goal G2 (let's say minimizing inactivity for grocery items) is assigned for users U2 of journey J2 accessing an e-commerce platform P2 on communication devices D2 (let's say smartphone) using a feature F2 (let's say inactivity feature). In yet another example, goal G3 (let's say minimizing application uninstalled) is assigned for users U3 of Journey J3 accessing an e-commerce platform P3 on communication devices D3 (let's say desktop) using a feature F3 (let's say recency feature). In yet another example, goal G4 (let's say maximizing application launched) is assigned for users U4 of Journey J4 accessing an e-commerce platform P4 on communication devices D4 (let's say tablet) using a feature F4 (let's say technographic feature). In yet another example, goal G5 (let's say maximizing smartphone bought) is assigned for users U5 of journey J5 accessing an e-commerce platform P5 on communication devices D5 (let's say laptop) using a feature F5 (let's say recency feature). In yet another example, goal G6 (let's say minimizing transaction failures) is assigned for users U6 of journey J6 accessing an e-commerce platform P6 on communication devices D6 (let's say smartphone) using a feature F6 (let's say monetary feature).

In an embodiment of the present disclosure, the journey management system 304 creates the one or more goals for the plurality of journeys of the fintech platform 102C. In addition, the one or more goals include maximizing accounts opening, maximizing credit cards issued, maximizing credit card requests, maximizing loan requests, maximizing net-banking requests and the like. Further, the one or more goals include maximizing bill payments, maximizing stock exchange investments, maximizing money donated, maximizing notifications clicked and the like. Furthermore, the one or more goals include maximizing transaction initiated, minimizing transaction failed, minimizing transaction left, minimizing application uninstallation and the like.

In an example, goal G1 (let's say maximizing saving account opening requests) is assigned for users U1 of journey J1 accessing a fintech platform P1 on communication devices D1 (let's say laptop) using a feature F1 (let's say activities feature). In another example, goal G2 (let's say minimizing inactivity for loan requests) is assigned for users U2 of journey J2 accessing a fintech platform P2 on communication devices D2 (let's say smartphone) using a feature F2 (let's say inactivity feature). In yet another example, goal G3 (let's say minimizing application uninstalled) is assigned for users U3 of journey J3 accessing a fintech platform P3 on communication devices D3 (let's say desktop) using a feature F3 (let's say recency feature). In yet another example, goal G4 (let's say maximizing application launched) is assigned for users U4 of journey J4 accessing a fintech platform P4 on communication devices D4 (let's say tablet) using a feature F4 (let's say technographic feature). In yet another example, goal G5 (let's say maximizing online bill payments) is assigned for users U5 of journey J5 accessing a fintech platform P5 on communication devices D5 (let's say laptop) using a feature F5 (let's say frequency feature). In yet another example, goal G6 (let's say minimizing transaction failures) is assigned for users U6 of Journey J6 accessing a fintech platform P6 on communication devices D6 (let's say smartphone) using a feature F6 (let's say monetary feature).

In an embodiment of the present disclosure, the journey management system 304 creates the one or more goals for the plurality of journeys of the social media platform 102D. In addition, the one or more goals include maximizing multimedia content surfed, maximizing multimedia content watched, maximizing account created, maximizing texts exchanged, maximizing time spent, and the like. Further, the one or more goals include maximizing paid promotions, maximizing services activated, minimizing inactivity on platform, maximizing live media streamed, maximizing audio-video callings in real-time, and the like.

In an example, goal G1 (let's say maximizing rock music surfed) is assigned for users U1 of journey J1 accessing a social media platform P1 on communication devices D1 (let's say laptop) using a feature F1 (let's say activities feature). In another example, goal G2 (let's say maximizing romantic movie watched) is assigned for users U2 of journey J2 accessing a social media platform P2 on communication devices D2 (let's say smartphone) using a feature F2 (let's say recency feature). In yet another example, goal G3 (let's say maximizing time spent while using application) is assigned for users U3 of Journey J3 accessing a social media platform P3 on communication devices D3 (let's say desktop) using a feature F3 (let's say time feature). In yet another example, goal G4 (let's say maximizing paid promotions of a fashion page) is assigned for users U4 of journey J4 accessing a social media platform P4 on communication devices D4 (let's say tablet) using a feature F4 (let's say monetary feature). In yet another example, goal G5 (let's say minimizing inactivity after launching application) is assigned for users U5 of journey J5 accessing a social media platform P5 on communication devices D5 (let's say laptop) using a feature F5 (let's say inactivity feature). In yet another example, goal G6 (let's say minimizing transaction failures) is assigned for users U6 of Journey J6 accessing a social media platform P6 on communication devices D6 (let's say smartphone) using a feature F6 (let's say monetary feature).

In an embodiment of the present disclosure, the journey management system 304 creates the one or more goals for the plurality of journeys of the health platform 102E. In addition, the one or more goals include maximizing medicines searched, maximizing medicines bought, maximizing medical test kit bought, maximizing medical tests scheduled, and the like. Further, the one or more goals include maximizing transaction initiated, maximizing transaction completed, maximizing doctor consultation scheduled, maximizing hospital visit planned, and the like. Furthermore, the one or more goals include maximizing dietary plan requested, maximizing personal trainer hired, maximizing fitness center searched and the like. Moreover, the one or more goals include minimizing subscription expired, minimizing transaction failures, minimizing inactivity, and the like.

In an example, goal G1 (let's say maximizing diabetes medicine searched) is assigned for users U1 of journey J1 accessing a health platform P1 on communication devices D1 (let's say laptop) using a feature F1 (let's say activities feature). In another example, goal G2 (let's say maximizing blood pressure medicine bought) is assigned for users U2 of journey J2 accessing a health platform P2 on communication devices D2 (let's say smartphone) using a feature F2 (let's say monetary feature). In yet another example, goal G3 (let's say maximizing transaction initiated for yoga classes) is assigned for users U3 of journey J3 accessing a health platform P3 on communication devices D3 (let's say desktop) using a feature F3 (let's say recency feature). In yet another example, goal G4 (let's say minimizing transaction failed to receive regular health checkup notification) is assigned for users U4 of Journey J4 accessing a health platform P4 on communication devices D4 (let's say tablet) using a feature F4 (let's say monetary feature). In yet another example, goal G5 (let's say minimizing inactivity after opening health webpage) is assigned for users U5 of journey J5 accessing a health platform P5 on communication devices D5 (let's say laptop) using a feature F5 (let's say inactivity feature). In yet another example, goal G6 (let's say maximizing Zumba class schedule notification clicked) is assigned for users U6 of journey J6 accessing a health platform P6 on communication devices D6 (let's say smartphone) using a feature F6 (let's say frequency feature). In yet another example, goal G7 (let's say maximizing overall time spent on surfing best fitness gym in South Carolina) is assigned for users U7 of journey J7 accessing a health platform P7 on communication devices D7 (let's say desktop) using a feature F7 (let's say time feature).

In an embodiment of the present disclosure, the journey management system 304 creates the one or more goals for the plurality of journeys of the education platform 102F. In addition, the one or more goals include maximizing educational video searched, maximizing educational video watched, maximizing projects submitted, maximizing account created, and the like. Further, the one or more goals include maximizing transaction initiated, minimizing transaction failures, maximizing transaction completed, maximizing notification clicked, and the like. Furthermore, the one or more goals include maximizing mock tests subscribed, maximizing educational counselling requested, maximizing time spent, minimizing inactivity on the platform, and the like.

In an example, goal G1 (let's say maximizing botany lecture searched) is assigned for users U1 of Journey J1 accessing an education platform P1 on communication devices D1 (let's say laptop) using a feature F1 (let's say activities feature). In another example, goal G2 (let's say maximizing integration lecture watched) is assigned for users U2 of journey J2 accessing an education platform P2 on communication devices D2 (let's say smartphone) using a feature F2 (let's say frequency feature). In yet another example, goal G3 (let's say maximizing renewal energy project submitted) is assigned for users U3 of journey J3 accessing an education platform P3 on communication devices D3 (let's say desktop) using a feature F3 (let's say recency feature). In yet another example, goal G4 (let's say minimizing transaction failed to receive regular mathematics lecture notification) is assigned for users U4 of journey J4 accessing an education platform P4 on communication devices D4 (let's say tablet) using a feature F4 (let's say monetary feature). In yet another example, goal G5 (let's say minimizing inactivity after opening education application) is assigned for users U5 of journey J5 accessing an education platform P5 on communication devices D5 (let's say laptop) using a feature F5 (let's say inactivity feature). In yet another example, goal G6 (let's say maximizing life science lecture schedule notification clicked) is assigned for users U6 of journey J6 accessing an education platform P6 on communication devices D6 (let's say smartphone) using a feature F6 (let's say frequency feature). In yet another example, goal G7 (let's say maximizing overall time spent on surfing international business management colleges) is assigned for users U7 of journey J7 accessing an education platform P7 on communication devices D7 (let's say desktop) using a feature F7 (let's say time feature).

In an embodiment of the present disclosure, the journey management system 304 creates the one or more goals for the plurality of journeys of the real estate and housing platform 102G. In addition, the one or more goals include maximizing properties searched, maximizing properties watched, maximizing properties bought, maximizing rented properties searched, and the like. Further, the one or more goals include maximizing account created, maximizing maintenance services requested, maximizing transaction initiated, maximizing transaction completed, and the like. Furthermore, the one or more goals include minimizing maintenance service cancelled, minimizing inactivity, minimizing transaction failures, minimizing application uninstalled, and the like.

In an example, goal G1 (let's say maximizing property search in California) is assigned for users U1 of journey J1 accessing a real estate and housing platform P1 on communication devices D1 (let's say laptop) using a feature F1 (let's say activities feature). In another example, goal G2 (let's say maximizing property bought in Washington) is assigned for users U2 of journey J2 accessing a real estate and housing platform P2 on communication devices D2 (let's say smartphone) using a feature F2 (let's say frequency feature). In yet another example, goal G3 (let's say maximizing air conditioner maintenance service requests) is assigned for users U3 of journey J3 accessing a real estate and housing platform P3 on communication devices D3 (let's say desktop) using a feature F3 (let's say recency feature). In yet another example, goal G4 (let's say minimizing transaction failed for rented apartment in Chicago) is assigned for users U4 of journey J4 accessing a real estate and housing platform P4 on communication devices D4 (let's say tablet) using a feature F4 (let's say monetary feature). In yet another example, goal G5 (let's say minimizing inactivity after opening real estate application) is assigned for users U5 of journey J5 accessing a real estate and housing platform P5 on communication devices D5 (let's say laptop) using a feature F5 (let's say inactivity feature). In yet another example, goal G6 (let's say maximizing best home loan notification clicked) is assigned for users U6 of Journey J6 accessing a real estate and housing platform P6 on communication devices D6 (let's say smartphone) using a feature F6 (let's say demographic feature). In yet another example, goal G7 (let's say maximizing overall time spent for farms on sale in Texas) is assigned for users U7 of journey J7 accessing a real estate and housing platform P7 on communication devices D7 (let's say desktop) using a feature F7 (let's say geographic feature).

In an embodiment of the present disclosure, the journey management system 304 creates the one or more goals for the plurality of journeys of the travel platform 102H. In addition, the one or more goals include maximizing hotel searched, maximizing hotels added to watch-list, minimizing hotels removed from watch-list, maximizing hotel bookings, maximizing account created, and the like. Further, the one or more goals include maximizing holiday plans searched, maximizing holiday plans booked, maximizing transaction initiated, maximizing transaction completed, and the like. Furthermore, the one or more goals include minimizing inactivity, minimizing transaction failures, minimizing hotel booking cancellations, and the like.

In an example, goal G1 (let's say maximizing hotel search in Dallas) is assigned for users U1 of journey J1 accessing a travel platform P1 on communication devices D1 (let's say laptop) using a feature F1 (let's say activities feature). In another example, goal G2 (let's say minimizing hotel removal from a watch-list) is assigned for users U2 of journey J2 accessing a travel platform P2 on communication devices D2 (let's say smartphone) using a feature F2 (let's say frequency feature). In yet another example, goal G3 (let's say maximizing holiday plan booked for Cairo) is assigned for users U3 of journey J3 accessing a travel platform P3 on communication devices D3 (let's say desktop) using a feature F3 (let's say recency feature). In yet another example, goal G4 (let's say minimizing transaction failed for hotel booking in Ohio) is assigned for users U4 of journey J4 accessing a travel platform P4 on communication devices D4 (let's say tablet) using a feature F4 (let's say monetary feature). In yet another example, goal G5 (let's say minimizing inactivity after opening webpage of hotels in Hawaii) is assigned for users U5 of journey J5 accessing a travel platform P5 on communication devices D5 (let's say laptop) using a feature F5 (let's say inactivity feature). In yet another example, goal G6 (let's say minimizing hotel booking cancellation in Florida) is assigned for users U6 of journey J6 accessing a travel platform P6 on communication devices D6 (let's say smartphone) using a feature F6 (let's say demographic feature). In yet another example, goal G7 (let's say maximizing overall time spent for Italian restaurants in Georgia) is assigned for users U7 of Journey J7 accessing a travel platform P7 on communication devices D7 (let's say desktop) using a feature F7 (let's say time feature).

The journey management system 304 identifies the entry criterion for automated admittance of each of the plurality of users 202 accessing the plurality of platforms 102 in corresponding journey from the plurality of journeys in real-time. In addition, the journey management system 304 automatically admits each of the plurality of users 202 accessing the plurality of platforms 102 in corresponding journey of the plurality of journeys.

In an embodiment of the present disclosure, the journey management system 304 identifies the entry criterion for the automated admittance of each of the plurality of users 202 accessing the over-the-top media platform 102A. In another embodiment of the present disclosure, the journey management system 304 identifies the entry criterion for the automated admittance of each of the plurality of users 202 accessing the e-commerce platform 102B. In yet another embodiment of the present disclosure, the journey management system 304 identifies the entry criterion for the automated admittance of each of the plurality of users 202 accessing the fintech platform 102C. In yet another embodiment of the present disclosure, the journey management system 304 identifies the entry criterion for the automated admittance of each of the plurality of users 202 accessing the social media platform 102D. In yet another embodiment of the present disclosure, the journey management system 304 identifies the entry criterion for the automated admittance of each of the plurality of users 202 accessing the health platform 102E. In yet another embodiment of the present disclosure, the journey management system 304 identifies the entry criterion for the automated admittance of each of the plurality of users 202 accessing the education platform 102F. In yet another embodiment of the present disclosure, the journey management system 304 identifies the entry criterion for the automated admittance of each of the plurality of users 202 accessing the real-estate and housing platform 102G. In yet another embodiment of the present disclosure, the journey management system 304 identifies the entry criterion for the automated admittance of each of the plurality of users 202 accessing the travel platform 102H.

In an embodiment of the present disclosure, the journey management system 304 automatically admits each of the plurality of users 202 accessing the over-the-top media platform 102A in corresponding journey of the plurality of journeys. In another embodiment of the present disclosure, the journey management system 304 automatically admits each of the plurality of users 202 accessing the e-commerce platform 102B in corresponding journey of the plurality of journeys. In yet another embodiment of the present disclosure, the journey management system 304 automatically admits each of the plurality of users 202 accessing the fintech platform 102C in corresponding journey of the plurality of journeys. In yet another embodiment of the present disclosure, the journey management system 304 automatically admits each of the plurality of users 202 accessing the social media platform 102D in corresponding journey of the plurality of journeys. In yet another embodiment of the present disclosure, the journey management system 304 automatically admits each of the plurality of users 202 accessing the health platform 102E in corresponding journey of the plurality of journeys. In yet another embodiment of the present disclosure, the journey management system 304 automatically admits each of the plurality of users 202 accessing the education platform 102F in corresponding journey of the plurality of journeys. In yet another embodiment of the present disclosure, the journey management system 304 automatically admits each of the plurality of users 202 accessing the real-estate and housing platform 102G in corresponding journey of the plurality of journeys. In yet another embodiment of the present disclosure, the journey management system 304 automatically admits each of the plurality of users 202 accessing the travel platform 102H in corresponding journey of the plurality of journeys.

In an example, an entry criterion E1 (Let's say installing an application) is identified for automatically admitting a user U1 accessing an OTT platform P1 on a communication device D1 (let's say desktop) in a journey J1. In another example, an entry criterion E2 (Let's say launching an application) is identified for automatically admitting a user U2 accessing an OTT platform P2 on a communication device D2 (let's say smartphone) in a journey J2. In yet another example, an entry criterion E3 (Let's say vising a webpage) is identified for automatically admitting a user U3 accessing an OTT platform P3 on a communication device D3 (let's say laptop) in a journey J3. In yet another example, an entry criterion E4 (Let's say initiating subscription) is identified for automatically admitting a user U4 accessing an OTT platform P4 on a communication device D4 (let's say tablet) in a journey J4. In yet another example, an entry criterion E5 (Let's say adding to watchlist) is identified for automatically admitting a user U5 accessing an OTT platform P5 on a communication device D5 (let's say laptop) in a journey J5. In yet another example, an entry criterion E6 (Let's say second visit for comedy genre) is identified for automatically admitting a user U6 accessing an OTT platform P6 on a communication device D6 (let's say smartphone) in a journey J6.

In an example, an entry criterion E1 (Let's say installing an application) is identified for automatically admitting a user U1 accessing an e-commerce platform P1 on a communication device D1 (let's say desktop) in a journey J1. In another example, an entry criterion E2 (Let's say launching an application) is identified for automatically admitting a user U2 accessing an e-commerce platform P2 on a communication device D2 (let's say smartphone) in a journey J2. In yet another example, an entry criterion E3 (Let's say vising a webpage) is identified for automatically admitting a user U3 accessing an e-commerce platform P3 on a communication device D3 (let's say laptop) in a journey J3. In yet another example, an entry criterion E4 (Let's say initiating subscription) is identified for automatically admitting a user U4 accessing an e-commerce platform P4 on a communication device D4 (let's say tablet) in a journey J4. In yet another example, an entry criterion E5 (Let's say adding to cart) is identified for automatically admitting a user U5 accessing an e-commerce platform P5 on a communication device D5 (let's say laptop) in a journey J5. In yet another example, an entry criterion E6 (Let's say visiting after 30 minutes for home appliances) is identified for automatically admitting a user U6 accessing an e-commerce platform P6 on a communication device D6 (let's say smartphone) in a journey J6.

In an example, an entry criterion E1 (Let's say installing an application) is identified for automatically admitting a user U1 accessing a fintech platform P1 on a communication device D1 (let's say desktop) in a journey J1. In another example, an entry criterion E2 (Let's say launching an application) is identified for automatically admitting a user U2 accessing a fintech platform P2 on a communication device D2 (let's say smartphone) in a journey J2. In yet another example, an entry criterion E3 (Let's say vising a webpage) is identified for automatically admitting a user U3 accessing a fintech platform P3 on a communication device D3 (let's say laptop) in a journey J3. In yet another example, an entry criterion E4 (Let's say initiating car loan) is identified for automatically admitting a user U4 accessing a fintech platform P4 on a communication device D4 (let's say tablet) in a journey J4. In yet another example, an entry criterion E5 (Let's say searching for education loan) is identified for automatically admitting a user U5 accessing a fintech platform P5 on a communication device D5 (let's say laptop) in a journey J5. In yet another example, an entry criterion E6 (Let's say visiting after 7 days for opening savings account) is identified for automatically admitting a user U6 accessing a fintech platform P6 on a communication device D6 (let's say smartphone) in a journey J6.

In an example, an entry criterion E1 (Let's say installing an application) is identified for automatically admitting a user U1 accessing a social media platform P1 on a communication device D1 (let's say desktop) in a journey J1. In another example, an entry criterion E2 (Let's say launching an application) is identified for automatically admitting a user U2 accessing a social media platform P2 on a communication device D2 (let's say smartphone) in a journey J2. In yet another example, an entry criterion E3 (Let's say vising a webpage) is identified for automatically admitting a user U3 accessing a social media platform P3 on a communication device D3 (let's say laptop) in a journey J3. In yet another example, an entry criterion E4 (Let's say initiating paid promotions of a fashion page) is identified for automatically admitting a user U4 accessing a social media platform P4 on a communication device D4 (let's say tablet) in a journey J4. In yet another example, an entry criterion E5 (Let's say searching for business pages) is identified for automatically admitting a user U5 accessing a social media platform P5 on a communication device D5 (let's say laptop) in a journey J5. In yet another example, an entry criterion E6 (Let's say fifth visit on a business page in one month) is identified for automatically admitting a user U6 accessing a social media platform P6 on a communication device D6 (let's say smartphone) in a journey J6.

In an example, an entry criterion E1 (Let's say installing an application) is identified for automatically admitting a user U1 accessing a health platform P1 on a communication device D1 (let's say desktop) in a journey J1. In another example, an entry criterion E2 (Let's say launching an application) is identified for automatically admitting a user U2 accessing a health platform P2 on a communication device D2 (let's say smartphone) in a journey J2. In yet another example, an entry criterion E3 (Let's say vising a webpage) is identified for automatically admitting a user U3 accessing a health platform P3 on a communication device D3 (let's say laptop) in a journey J3. In yet another example, an entry criterion E4 (Let's say initiating appointment with a dermatologist) is identified for automatically admitting a user U4 accessing a health platform P4 on a communication device D4 (let's say tablet) in a journey J4. In yet another example, an entry criterion E5 (Let's say searching for hair healthcare kit) is identified for automatically admitting a user U5 accessing a health platform P5 on a communication device D5 (let's say laptop) in a journey J5. In yet another example, an entry criterion E6 (Let's say twentieth order of inhalers in two weeks) is identified for automatically admitting a user U6 accessing a health platform P6 on a communication device D6 (let's say smartphone) in a journey J6.

In an example, an entry criterion E1 (Let's say installing an application) is identified for automatically admitting a user U1 accessing an education platform P1 on a communication device D1 (let's say desktop) in a journey J1. In another example, an entry criterion E2 (Let's say launching an application) is identified for automatically admitting a user U2 accessing an education platform P2 on a communication device D2 (let's say smartphone) in a journey J2. In yet another example, an entry criterion E3 (Let's say vising a webpage) is identified for automatically admitting a user U3 accessing an education platform P3 on a communication device D3 (let's say laptop) in a journey J3. In yet another example, an entry criterion E4 (Let's say bookmarking lecture on material science) is identified for automatically admitting a user U4 accessing an education platform P4 on a communication device D4 (let's say tablet) in a journey J4. In yet another example, an entry criterion E5 (Let's say buying an artificial intelligence course) is identified for automatically admitting a user U5 accessing an education platform P5 on a communication device D5 (let's say laptop) in a journey J5. In yet another example, an entry criterion E6 (Let's say tenth visit on a trigonometry lecture) is identified for automatically admitting a user U6 accessing an education platform P6 on a communication device D6 (let's say smartphone) in a journey J6.

In an example, an entry criterion E1 (Let's say installing an application) is identified for automatically admitting a user U1 accessing a real estate and housing platform P1 on a communication device D1 (let's say desktop) in a journey J1. In another example, an entry criterion E2 (Let's say launching an application) is identified for automatically admitting a user U2 accessing a real estate and housing platform P2 on a communication device D2 (let's say smartphone) in a journey J2. In yet another example, an entry criterion E3 (Let's say vising a webpage) is identified for automatically admitting a user U3 accessing a real estate and housing platform P3 on a communication device D3 (let's say laptop) in a journey J3. In yet another example, an entry criterion E4 (Let's say clicking on a notification for apartments in Philadelphia) is identified for automatically admitting a user U4 accessing a real estate and housing platform P4 on a communication device D4 (let's say tablet) in a journey J4. In yet another example, an entry criterion E5 (Let's say searching for rental apartments in Phoenix) is identified for automatically admitting a user U5 accessing a real estate and housing platform P5 on a communication device D5 (let's say laptop) in a journey J5. In yet another example, an entry criterion E6 (Let's say fifth visit on a webpage in one month) is identified for automatically admitting a user U6 accessing a real estate and housing platform P6 on a communication device D6 (let's say smartphone) in a journey J6.

In an example, an entry criterion E1 (Let's say installing an application) is identified for automatically admitting a user U1 accessing a travel platform P1 on a communication device D1 (let's say desktop) in a journey J1. In another example, an entry criterion E2 (Let's say launching an application) is identified for automatically admitting a user U2 accessing a travel platform P2 on a communication device D2 (let's say smartphone) in a journey J2. In yet another example, an entry criterion E3 (Let's say vising a webpage) is identified for automatically admitting a user U3 accessing a travel platform P3 on a communication device D3 (let's say laptop) in a journey J3. In yet another example, an entry criterion E4 (Let's say clicking on a notification of 10 percent less on flight tickets) is identified for automatically admitting a user U4 accessing a travel platform P4 on a communication device D4 (let's say tablet) in a journey J4. In yet another example, an entry criterion E5 (Let's say searching for hotels in Miami) is identified for automatically admitting a user U5 accessing a travel platform P5 on a communication device D5 (let's say laptop) in a journey J5. In yet another example, an entry criterion E6 (Let's say first visit on couch surfing section since application installation) is identified for automatically admitting a user U6 accessing a travel platform P6 on a communication device D6 (let's say smartphone) in a journey J6.

The journey management system 304 detects an optimal time of the engagement with the plurality of users 202 in the plurality of journeys using the one or more machine learning algorithms in real-time. In an embodiment of the present disclosure, the journey management system 304 detects the optimal time of the engagement with the plurality of users 202 accessing the over-the-top media platform 102A in the plurality of journeys. In another embodiment of the present disclosure, the journey management system 304 detects the optimal time of the engagement with the plurality of users 202 accessing the e-commerce platform 102B in the plurality of journeys. In yet another embodiment of the present disclosure, the journey management system 304 detects the optimal time of the engagement with the plurality of users 202 accessing the fintech platform 102C in the plurality of journeys. In yet another embodiment of the present disclosure, the journey management system 304 detects the optimal time of the engagement with the plurality of users 202 accessing the social media platform 102D in the plurality of journeys. In yet another embodiment of the present disclosure, the journey management system 304 detects the optimal time of the engagement with the plurality of users 202 accessing the health platform 102E in the plurality of journeys. In yet another embodiment of the present disclosure, the journey management system 304 detects the optimal time of the engagement with the plurality of users 202 accessing the education platform 102F in the plurality of journeys. In yet another embodiment of the present disclosure, the journey management system 304 detects the optimal time of the engagement with the plurality of users 202 accessing the real-estate and housing platform 102G in the plurality of journeys. In yet another embodiment of the present disclosure, the journey management system 304 detects the optimal time of the engagement with the plurality of users 202 accessing the travel platform 102H in the plurality of journeys.

The journey management system 304 identifies an optimal channel from the plurality of channels for the plurality of journeys for the engagement with the plurality of users 202 using the one or more machine learning algorithms in real-time. In an embodiment of the present disclosure, the journey management system 304 identifies the optimal channel for the engagement with the plurality of users 202 accessing the over-the-top media platform 102A in the plurality of journeys. In another embodiment of the present disclosure, the journey management system 304 identifies the optimal channel for the engagement with the plurality of users 202 accessing the e-commerce platform 102B in the plurality of journeys. In yet another embodiment of the present disclosure, the journey management system 304 identifies the optimal channel for the engagement with the plurality of users 202 accessing the fintech platform 102C in the plurality of journeys. In yet another embodiment of the present disclosure, the journey management system 304 identifies the optimal channel for the engagement with the plurality of users 202 accessing the social media platform 102D in the plurality of journeys. In yet another embodiment of the present disclosure, the journey management system 304 identifies the optimal channel for the engagement with the plurality of users 202 accessing the health platform 102E in the plurality of journeys. In yet another embodiment of the present disclosure, the journey management system 304 identifies the optimal channel for the engagement with the plurality of users 202 accessing the education platform 102F in the plurality of journeys. In yet another embodiment of the present disclosure, the journey management system 304 identifies the optimal channel for the engagement with the plurality of users 202 accessing the real-estate and housing platform 102G in the plurality of journeys. In yet another embodiment of the present disclosure, the journey management system 304 identifies the optimal channel for the engagement with the plurality of users 202 accessing the travel platform 102H in the plurality of journeys.

In an example, a channel C1 (Let's say mobile channel) is identified as the optimal channel for the engagement with a user U1 accessing an OTT platform P1 on a communication device D1 (let's say desktop) in a journey J1. In another example, a channel C2 (Let's say email channel) is identified as the optimal channel for the engagement with a user U2 accessing an OTT platform P2 on a communication device D2 (let's say smartphone) in a journey J2. In yet another example, a channel C3 (Let's say desktop channel) is identified as the optimal channel for the engagement with a user U3 accessing an OTT platform P3 on a communication device D3 (let's say laptop) in a journey J3. In yet another example, a channel C4 (Let's say social channel) is identified as the optimal channel for the engagement with a user U4 accessing an OTT platform P4 on a communication device D4 (let's say tablet) in a journey J4. In yet another example, a channel C5 (Let's say remarketing channel) is identified as the optimal channel for the engagement with a user U5 accessing an OTT platform P5 on a communication device D5 (let's say workstation) in a journey J5. In yet another example, a channel C6 (Let's say server channel) is identified as the optimal channel for the engagement with a user U6 accessing an OTT platform P6 on a communication device D6 (let's say smartphone) in a journey J6.

In an example, a channel C1 (Let's say mobile channel) is identified as the optimal channel for the engagement with a user U1 accessing an e-commerce platform P1 on a communication device D1 (let's say desktop) in a journey J1. In another example, a channel C2 (Let's say email channel) is identified as the optimal channel for the engagement with a user U2 accessing an e-commerce platform P2 on a communication device D2 (let's say smartphone) in a journey J2. In yet another example, a channel C3 (Let's say desktop channel) is identified as the optimal channel for the engagement with a user U3 accessing an e-commerce platform P3 on a communication device D3 (let's say laptop) in a journey J3. In yet another example, a channel C4 (Let's say social channel) is identified as the optimal channel for the engagement with a user U4 accessing an e-commerce platform P4 on a communication device D4 (let's say tablet) in a journey J4. In yet another example, a channel C5 (Let's say remarketing channel) is identified as the optimal channel for the engagement with a user U5 accessing an e-commerce platform P5 on a communication device D5 (let's say workstation) in a journey J5. In yet another example, a channel C6 (Let's say server channel) is identified as the optimal channel for the engagement with a user U6 accessing an e-commerce platform P6 on a communication device D6 (let's say smartphone) in a journey J6.

In an example, a channel C1 (Let's say mobile channel) is identified as the optimal channel for the engagement with a user U1 accessing a fintech platform P1 on a communication device D1 (let's say desktop) in a journey J1. In another example, a channel C2 (Let's say email channel) is identified as the optimal channel for the engagement with a user U2 accessing a fintech platform P2 on a communication device D2 (let's say smartphone) in a journey J2. In yet another example, a channel C3 (Let's say desktop channel) is identified as the optimal channel for the engagement with a user U3 accessing a fintech platform P3 on a communication device D3 (let's say laptop) in a journey J3. In yet another example, a channel C4 (Let's say social channel) is identified as the optimal channel for the engagement with a user U4 accessing a fintech platform P4 on a communication device D4 (let's say tablet) in a journey J4. In yet another example, a channel C5 (Let's say remarketing channel) is identified as the optimal channel for the engagement with a user U5 accessing a fintech platform P5 on a communication device D5 (let's say workstation) in a journey J5. In yet another example, a channel C6 (Let's say server channel) is identified as the optimal channel for the engagement with a user U6 accessing a fintech platform P6 on a communication device D6 (let's say smartphone) in a journey J6.

In an example, a channel C1 (Let's say mobile channel) is identified as the optimal channel for the engagement with a user U1 accessing a social media platform P1 on a communication device D1 (let's say desktop) in a journey J1. In another example, a channel C2 (Let's say email channel) is identified as the optimal channel for the engagement with a user U2 accessing a social media platform P2 on a communication device D2 (let's say smartphone) in a journey J2. In yet another example, a channel C3 (Let's say desktop channel) is identified as the optimal channel for the engagement with a user U3 accessing a social media platform P3 on a communication device D3 (let's say laptop) in a journey J3. In yet another example, a channel C4 (Let's say social channel) is identified as the optimal channel for the engagement with a user U4 accessing a social media platform P4 on a communication device D4 (let's say tablet) in a journey J4. In yet another example, a channel C5 (Let's say remarketing channel) is identified as the optimal channel for the engagement with a user U5 accessing a social media platform P5 on a communication device D5 (let's say workstation) in a journey J5. In yet another example, a channel C6 (Let's say server channel) is identified as the optimal channel for the engagement with a user U6 accessing a social media platform P6 on a communication device D6 (let's say smartphone) in a journey J6.

In an example, a channel C1 (Let's say mobile channel) is identified as the optimal channel for the engagement with a user U1 accessing a health platform P1 on a communication device D1 (let's say desktop) in a journey J1. In another example, a channel C2 (Let's say email channel) is identified as the optimal channel for the engagement with a user U2 accessing a health platform P2 on a communication device D2 (let's say smartphone) in a journey J2. In yet another example, a channel C3 (Let's say desktop channel) is identified as the optimal channel for the engagement with a user U3 accessing a health platform P3 on a communication device D3 (let's say laptop) in a journey J3. In yet another example, a channel C4 (Let's say social channel) is identified as the optimal channel for the engagement with a user U4 accessing a health platform P4 on a communication device D4 (let's say tablet) in a journey J4. In yet another example, a channel C5 (Let's say remarketing channel) is identified as the optimal channel for the engagement with a user U5 accessing a health platform P5 on a communication device D5 (let's say workstation) in a journey J5. In yet another example, a channel C6 (Let's say server channel) is identified as the optimal channel for the engagement with a user U6 accessing a health platform P6 on a communication device D6 (let's say smartphone) in a journey J6.

In an example, a channel C1 (Let's say mobile channel) is identified as the optimal channel for the engagement with a user U1 accessing an education platform P1 on a communication device D1 (let's say desktop) in a journey J1. In another example, a channel C2 (Let's say email channel) is identified as the optimal channel for the engagement with a user U2 accessing an education platform P2 on a communication device D2 (let's say smartphone) in a journey J2. In yet another example, a channel C3 (Let's say desktop channel) is identified as the optimal channel for the engagement with a user U3 accessing an education platform P3 on a communication device D3 (let's say laptop) in a journey J3. In yet another example, a channel C4 (Let's say social channel) is identified as the optimal channel for the engagement with a user U4 accessing an education platform P4 on a communication device D4 (let's say tablet) in a journey J4. In yet another example, a channel C5 (Let's say remarketing channel) is identified as the optimal channel for the engagement with a user U5 accessing an education platform P5 on a communication device D5 (let's say workstation) in a journey J5. In yet another example, a channel C6 (Let's say server channel) is identified as the optimal channel for the engagement with a user U6 accessing an education platform P6 on a communication device D6 (let's say smartphone) in a journey J6.

In an example, a channel C1 (Let's say mobile channel) is identified as the optimal channel for the engagement with a user U1 accessing a real estate and housing platform P1 on a communication device D1 (let's say desktop) in a journey J1. In another example, a channel C2 (Let's say email channel) is identified as the optimal channel for the engagement with a user U2 accessing a real estate and housing platform P2 on a communication device D2 (let's say smartphone) in a journey J2. In yet another example, a channel C3 (Let's say desktop channel) is identified as the optimal channel for the engagement with a user U3 accessing a real estate and housing platform P3 on a communication device D3 (let's say laptop) in a journey J3. In yet another example, a channel C4 (Let's say social channel) is identified as the optimal channel for the engagement with a user U4 accessing a real estate and housing platform P4 on a communication device D4 (let's say tablet) in a journey J4. In yet another example, a channel C5 (Let's say remarketing channel) is identified as the optimal channel for the engagement with a user U5 accessing a real estate and housing platform P5 on a communication device D5 (let's say workstation) in a journey J5. In yet another example, a channel C6 (Let's say server channel) is identified as the optimal channel for the engagement with a user U6 accessing a real estate and housing platform P6 on a communication device D6 (let's say smartphone) in a journey J6.

In an example, a channel C1 (Let's say mobile channel) is identified as the optimal channel for the engagement with a user U1 accessing a travel platform P1 on a communication device D1 (let's say desktop) in a journey J1. In another example, a channel C2 (Let's say email channel) is identified as the optimal channel for the engagement with a user U2 accessing a travel platform P2 on a communication device D2 (let's say smartphone) in a journey J2. In yet another example, a channel C3 (Let's say desktop channel) is identified as the optimal channel for the engagement with a user U3 accessing a travel platform P3 on a communication device D3 (let's say laptop) in a journey J3. In yet another example, a channel C4 (Let's say social channel) is identified as the optimal channel for the engagement with a user U4 accessing a travel platform P4 on a communication device D4 (let's say tablet) in a journey J4. In yet another example, a channel C5 (Let's say remarketing channel) is identified as the optimal channel for the engagement with a user U5 accessing a travel platform P5 on a communication device D5 (let's say workstation) in a journey J5. In yet another example, a channel C6 (Let's say server channel) is identified as the optimal channel for the engagement with a user U6 accessing a travel platform P6 on a communication device D6 (let's say smartphone) in a journey J6.

The journey management system 304 recommends an optimal content for the engagement with the plurality of users 202 throughout the plurality of journeys using the one or more machine learning algorithms in real-time. In an embodiment of the present disclosure, the journey management system 304 recommends the optimal content for the engagement with the plurality of users 202 accessing the over-the-top media platform 102A in the plurality of journeys. In another embodiment of the present disclosure, the journey management system 304 recommends the optimal content for the engagement with the plurality of users 202 accessing the e-commerce platform 102B in the plurality of journeys. In yet another embodiment of the present disclosure, the journey management system 304 recommends the optimal content for the engagement with the plurality of users 202 accessing the fintech platform 102C in the plurality of journeys. In yet another embodiment of the present disclosure, the journey management system 304 recommends the optimal content for the engagement with the plurality of users 202 accessing the social media platform 102D in the plurality of journeys. In yet another embodiment of the present disclosure, the journey management system 304 recommends the optimal content for the engagement with the plurality of users 202 accessing the health platform 102E in the plurality of journeys. In yet another embodiment of the present disclosure, the journey management system 304 recommends the optimal content for the engagement with the plurality of users 202 accessing the education platform 102F in the plurality of journeys. In yet another embodiment of the present disclosure, the journey management system 304 recommends the optimal content for the engagement with the plurality of users 202 accessing the real-estate and housing platform 102G in the plurality of journeys. In yet another embodiment of the present disclosure, the journey management system 304 recommends the optimal content for the engagement with the plurality of users 202 accessing the travel platform 102H in the plurality of journeys.

In an embodiment of the present disclosure, the optimal content is displayed on the one or more communication devices 204 in a form of flash messages. In another embodiment of the present disclosure, the optimal content is displayed on the one or more communication devices 204 in the form of text messages. In yet another embodiment of the present disclosure, the optimal content is displayed on the one or more communication devices 204 in the form of multimedia messages. In yet another embodiment of the present disclosure, the optimal content is displayed on the one or more online platforms 102 in the form of push notification. In yet another embodiment of the present disclosure, the optimal content is displayed on the one or more communication devices 204 as Google Ads. The optimal content is displayed on the one or more communication devices 204 through the plurality of channels in real-time. In an embodiment of the present disclosure, the optimal content displayed is associated with the interests of the plurality of users 202. In addition, the optimal content includes text content, video content, audio content, audio-video content, pictorial content, and the like.

In an embodiment of the present disclosure, the journey management system 304 displays the optimal content for the engagement with the plurality of users 202 through the plurality of channels on the over-the-top media platform 102A. In another embodiment of the present disclosure, the journey management system 304 displays the optimal content for the engagement with the plurality of users 202 through the plurality of channels on the e-commerce platform 102B. In yet another embodiment of the present disclosure, the journey management system 304 displays the optimal content for the engagement with the plurality of users 202 through the plurality of channels on the fintech platform 102C. In yet another embodiment of the present disclosure, the journey management system 304 displays the optimal content for the engagement with the plurality of users 202 through the plurality of channels on the social media platform 102D. In yet another embodiment of the present disclosure, the journey management system 304 displays the optimal content for the engagement with the plurality of users 202 through the plurality of channels on the health platform 102E. In yet another embodiment of the present disclosure, the journey management system 304 displays the optimal content for the engagement with the plurality of users 202 through the plurality of channels on the education platform 102F. In yet another embodiment of the present disclosure, the journey management system 304 displays the optimal content for the engagement with the plurality of users 202 through the plurality of channels on the real-estate and housing platform 102G. In yet another embodiment of the present disclosure, the journey management system 304 displays the optimal content for the engagement with the plurality of users 202 through the plurality of channels on the travel platform 102H.

In an example, an optimal content O1 (Let's say text content) is displayed on a communication device D1 (let's say desktop) through a channel C1 (Let's say mobile channel) for the engagement with a user U1 accessing an OTT platform P1 in a journey J1. In another example, an optimal content O2 (Let's say video content) is displayed on a communication device D2 (let's say smartphone) through a channel C2 (Let's say email channel) for the engagement with a user U2 accessing an OTT platform P2 in a journey J2. In yet another example, an optimal content O3 (Let's say audio content) is displayed on a communication device D3 (let's say laptop) through a channel C3 (Let's say desktop channel) for the engagement with a user U3 accessing an OTT platform P3 in a journey J3. In yet another example, an optimal content O4 (Let's say audio-video content) is displayed on a communication device D4 (let's say tablet) through a channel C4 (Let's say social channel) for the engagement with a user U4 accessing an OTT platform P4 in a journey J4. In yet another example, an optimal content O5 (Let's say pictorial content) is displayed on a communication device D5 (let's say workstation) through a channel C5 (Let's say remarketing channel) for the engagement with a user U5 accessing an OTT platform P5 in a journey J5.

In an example, an optimal content O1 (Let's say text content) is displayed on a communication device D1 (let's say desktop) through a channel C1 (Let's say mobile channel) for the engagement with a user U1 accessing an e-commerce platform P1 in a journey J1. In another example, an optimal content O2 (Let's say video content) is displayed on a communication device D2 (let's say smartphone) through a channel C2 (Let's say email channel) for the engagement with a user U2 accessing an e-commerce platform P2 in a journey J2. In yet another example, an optimal content O3 (Let's say audio content) is displayed on a communication device D3 (let's say laptop) through a channel C3 (Let's say desktop channel) for the engagement with a user U3 accessing an e-commerce platform P3 in a journey J3. In yet another example, an optimal content O4 (Let's say audio-video content) is displayed on a communication device D4 (let's say tablet) through a channel C4 (Let's say social channel) for the engagement with a user U4 accessing an e-commerce platform P4 in a journey J4. In yet another example, an optimal content O5 (Let's say pictorial content) is displayed on a communication device D5 (let's say workstation) through a channel C5 (Let's say remarketing channel) for the engagement with a user U5 accessing an e-commerce platform P5 in a journey J5.

In an example, an optimal content O1 (Let's say text content) is displayed on a communication device D1 (let's say desktop) through a channel C1 (Let's say mobile channel) for the engagement with a user U1 accessing a fintech platform P1 in a journey J1. In another example, an optimal content O2 (Let's say video content) is displayed on a communication device D2 (let's say smartphone) through a channel C2 (Let's say email channel) for the engagement with a user U2 accessing a fintech platform P2 in a journey J2. In yet another example, an optimal content O3 (Let's say audio content) is displayed on a communication device D3 (let's say laptop) through a channel C3 (Let's say desktop channel) for the engagement with a user U3 accessing a fintech platform P3 in a journey J3. In yet another example, an optimal content O4 (Let's say audio-video content) is displayed on a communication device D4 (let's say tablet) through a channel C4 (Let's say social channel) for the engagement with a user U4 accessing a fintech platform P4 in a journey J4. In yet another example, an optimal content O5 (Let's say pictorial content) is displayed on a communication device D5 (let's say workstation) through a channel C5 (Let's say remarketing channel) for the engagement with a user U5 accessing a fintech platform P5 in a journey J5.

In an example, an optimal content O1 (Let's say text content) is displayed on a communication device D1 (let's say desktop) through a channel C1 (Let's say mobile channel) for the engagement with a user U1 accessing a social media platform P1 in a journey J1. In another example, an optimal content O2 (Let's say video content) is displayed on a communication device D2 (let's say smartphone) through a channel C2 (Let's say email channel) for the engagement with a user U2 accessing a social media platform P2 in a journey J2. In yet another example, an optimal content O3 (Let's say audio content) is displayed on a communication device D3 (let's say laptop) through a channel C3 (Let's say desktop channel) for the engagement with a user U3 accessing a social media platform P3 in a journey J3. In yet another example, an optimal content O4 (Let's say audio-video content) is displayed on a communication device D4 (let's say tablet) through a channel C4 (Let's say social channel) for the engagement with a user U4 accessing a social media platform P4 in a journey J4. In yet another example, an optimal content O5 (Let's say pictorial content) is displayed on a communication device D5 (let's say workstation) through a channel C5 (Let's say remarketing channel) for the engagement with a user U5 accessing a social media platform P5 in a journey J5.

In an example, an optimal content O1 (Let's say text content) is displayed on a communication device D1 (let's say desktop) through a channel C1 (Let's say mobile channel) for the engagement with a user U1 accessing a health platform P1 in a journey J1. In another example, an optimal content O2 (Let's say video content) is displayed on a communication device D2 (let's say smartphone) through a channel C2 (Let's say email channel) for the engagement with a user U2 accessing a health platform P2 in a journey J2. In yet another example, an optimal content O3 (Let's say audio content) is displayed on a communication device D3 (let's say laptop) through a channel C3 (Let's say desktop channel) for the engagement with a user U3 accessing a health platform P3 in a journey J3. In yet another example, an optimal content O4 (Let's say audio-video content) is displayed on a communication device D4 (let's say tablet) through a channel C4 (Let's say social channel) for the engagement with a user U4 accessing a health platform P4 in a journey J4. In yet another example, an optimal content O5 (Let's say pictorial content) is displayed on a communication device D5 (let's say workstation) through a channel C5 (Let's say remarketing channel) for the engagement with a user U5 accessing a health platform P5 in a journey J5.

In an example, an optimal content O1 (Let's say text content) is displayed on a communication device D1 (let's say desktop) through a channel C1 (Let's say mobile channel) for the engagement with a user U1 accessing an education platform P1 in a journey J1. In another example, an optimal content O2 (Let's say video content) is displayed on a communication device D2 (let's say smartphone) through a channel C2 (Let's say email channel) for the engagement with a user U2 accessing an education platform P2 in a journey J2. In yet another example, an optimal content O3 (Let's say audio content) is displayed on a communication device D3 (let's say laptop) through a channel C3 (Let's say desktop channel) for the engagement with a user U3 accessing an education platform P3 in a journey J3. In yet another example, an optimal content O4 (Let's say audio-video content) is displayed on a communication device D4 (let's say tablet) through a channel C4 (Let's say social channel) for the engagement with a user U4 accessing an education platform P4 in a journey J4. In yet another example, an optimal content O5 (Let's say pictorial content) is displayed on a communication device D5 (let's say workstation) through a channel C5 (Let's say remarketing channel) for the engagement with a user U5 accessing an education platform P5 in a journey J5.

In an example, an optimal content O1 (Let's say text content) is displayed on a communication device D1 (let's say desktop) through a channel C1 (Let's say mobile channel) for the engagement with a user U1 accessing a real estate and housing platform P1 in a journey J1. In another example, an optimal content O2 (Let's say video content) is displayed on a communication device D2 (let's say smartphone) through a channel C2 (Let's say email channel) for the engagement with a user U2 accessing a real estate and housing platform P2 in a journey J2. In yet another example, an optimal content O3 (Let's say audio content) is displayed on a communication device D3 (let's say laptop) through a channel C3 (Let's say desktop channel) for the engagement with a user U3 accessing a real estate and housing platform P3 in a journey J3. In yet another example, an optimal content O4 (Let's say audio-video content) is displayed on a communication device D4 (let's say tablet) through a channel C4 (Let's say social channel) for the engagement with a user U4 accessing a real estate and housing platform P4 in a journey J4. In yet another example, an optimal content O5 (Let's say pictorial content) is displayed on a communication device D5 (let's say workstation) through a channel C5 (Let's say remarketing channel) for the engagement with a user U5 accessing a real estate and housing platform P5 in a journey J5.

In an example, an optimal content O1 (Let's say text content) is displayed on a communication device D1 (let's say desktop) through a channel C1 (Let's say mobile channel) for the engagement with a user U1 accessing a travel platform P1 in a journey J1. In another example, an optimal content O2 (Let's say video content) is displayed on a communication device D2 (let's say smartphone) through a channel C2 (Let's say email channel) for the engagement with a user U2 accessing a travel platform P2 in a journey J2. In yet another example, an optimal content O3 (Let's say audio content) is displayed on a communication device D3 (let's say laptop) through a channel C3 (Let's say desktop channel) for the engagement with a user U3 accessing a travel platform P3 in a journey J3. In yet another example, an optimal content O4 (Let's say audio-video content) is displayed on a communication device D4 (let's say tablet) through a channel C4 (Let's say social channel) for the engagement with a user U4 accessing a travel platform P4 in a journey J4. In yet another example, an optimal content O5 (Let's say pictorial content) is displayed on a communication device D5 (let's say workstation) through a channel C5 (Let's say remarketing channel) for the engagement with a user U5 accessing a travel platform P5 in a journey J5.

In an embodiment of the present disclosure, the plurality of journeys has an acquisition objective designed to send offers to new users of the plurality of users 202 that have not sufficiently patronized the plurality of platforms 102. In another embodiment of the present disclosure, the plurality of journeys has a loyalty campaign designed to send offers to former users of the plurality of users 202 that have sufficiently patronized the plurality of platforms 102. In yet another embodiment of the present disclosure, the plurality of journeys has an all-inclusive campaign designed to send offers to both new and former users.

The journey management system 304 predicts performance of each of the plurality of journeys for corresponding goal of the one or more goals in real-time. The performance of each of the plurality of journeys is predicted based on analysis of each of the plurality of users 202 in corresponding segment of the one or more segments using the one or more machine learning algorithms. In addition, the performance predicted based on analysis of each of the plurality of users 202 before the engagement with the plurality of journeys corresponds to a predicted performance. Further, the performance of each of the plurality of journeys after the engagement with each of the plurality of users 202 corresponds to an actual performance. Furthermore, the journey management system 304 analyzes and compares the predicted performance of each of the one or more segments and the actual performance of each of the one or more segments. Moreover, the journey management system 304 generates a performance chart. The performance chart depicts an accuracy and a precision of the predicted performance along with the actual performance with the time.

The interactive computing environment 300 includes the server 306 and the database 306a. The journey management system 304 is associated with the server 306. In general, server is a computer program or device that provides functionality for other programs or devices. The server 306 provides various functionalities, such as sharing data or resources among multiple clients, or performing computation for a client. However, those skilled in the art would appreciate that the journey management system 304 is connected to more number of servers. Furthermore, it may be noted that the server 306 includes the database 306a. However, those skilled in the art would appreciate that more number of the servers include more numbers of database.

In an embodiment of the present disclosure, the journey management system 304 is located in the server 306. In another embodiment of the present disclosure, the journey management system 304 is connected with the server 306. In yet another embodiment of the present disclosure, the journey management system 304 is a part of the server 306. The server 306 handles each operation and task performed by the journey management system 304. The server 306 stores one or more instructions for performing the various operations of the journey management system 304. The server 306 is associated with the administrator 308. In addition, the administrator 308 manages the different components of the journey management system 304. The administrator 308 coordinates the activities of the components involved in the journey management system 304. The administrator 308 is any person or individual who monitors the working of the journey management system 304 and the server 306 in real-time. The administrator 308 monitors the working of the journey management system 304 and the server 306 through a communication device. The communication device includes the laptop, the desktop computer, the tablet, a personal digital assistant and the like.

The database 306a stores different sets of information associated with various components of the journey management system 304. In addition, the database 306a is used to hold general information and specialized data, such as characteristics data of the plurality of users 202, data of the one or more communication devices 204, data of the plurality of platforms 102 and the like. The database 306a stores the information of the plurality of platforms 102, the one or more communication devices 204, profiles of the plurality of users 202, the first set of data associated with the plurality of users 202 and the like. The database 306a organizes the data using model such as relational models or hierarchical models. Further, the database 306a store data provided by the administrator 308.

The journey management system 304 as referred aforesaid at least exhibits following advantages
1. Dynamic Adaptation, as the journey management system 304 continuously optimizes content delivery based on real-time feedback.
2. Personalized Engagement, as the journey management system 304 tailors content to individual user segments and contexts.
3. Scalable, as the journey management system 304 efficiently handles large user bases and diverse campaign requirements.
4. Improved Performance, as the journey management system 304, maximizes the likelihood of achieving campaign goals.

The journey management system 304 as referred aforesaid provides a comprehensive system for personalized engagement using user intent prediction, optimal engagement timing, and dynamic content selection. The integration of machine learning and Multi-Armed Bandit algorithms ensures continuous improvement and adaptation to user behavior, significantly enhancing the effectiveness of marketing campaigns.

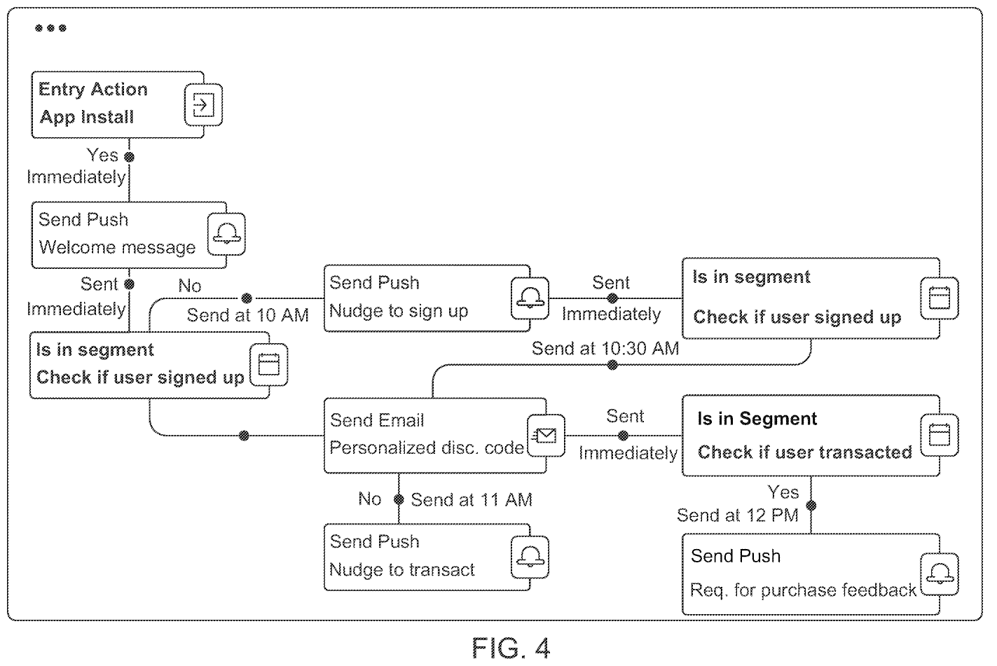

FIG. 4 illustrates an exemplary user onboarding journey 400 for engaging the plurality of users 202 in real-time, in accordance with various embodiments of the present disclosure. The exemplary user onboarding journey 400 enables the engagement with the new users of the plurality of users 202 to boost regular usage of the plurality of platforms 102. In addition, the exemplary user onboarding journey 400 enhances the frequency of the new users of the plurality of users 202 on the plurality of platforms 102. Further, the new users from the plurality of users 202 automatically enter the exemplary user onboarding journey 400 as the application of any of the plurality of platforms 102 is installed. Furthermore, the journey management system 304 sends “welcome message” as the push notification to the new users in the exemplary user onboarding journey 400. Moreover, the journey management system 304 sends “personalized discount code” on the email channel if the new users sign up in the exemplary user onboarding journey 400. Also, the journey management system 304 sends “nudge to sign up” as the push notification if the new users do not sign up in the exemplary user onboarding journey 400. Also, the journey management system 304 sends “request for purchase feedback” as the push notification if the new users transact using the “personalized discount code” in the exemplary user onboarding journey 400. Also, the journey management system 304 sends “nudge to transact” as the push notification if the new users do not transact in the exemplary user onboarding journey 400.

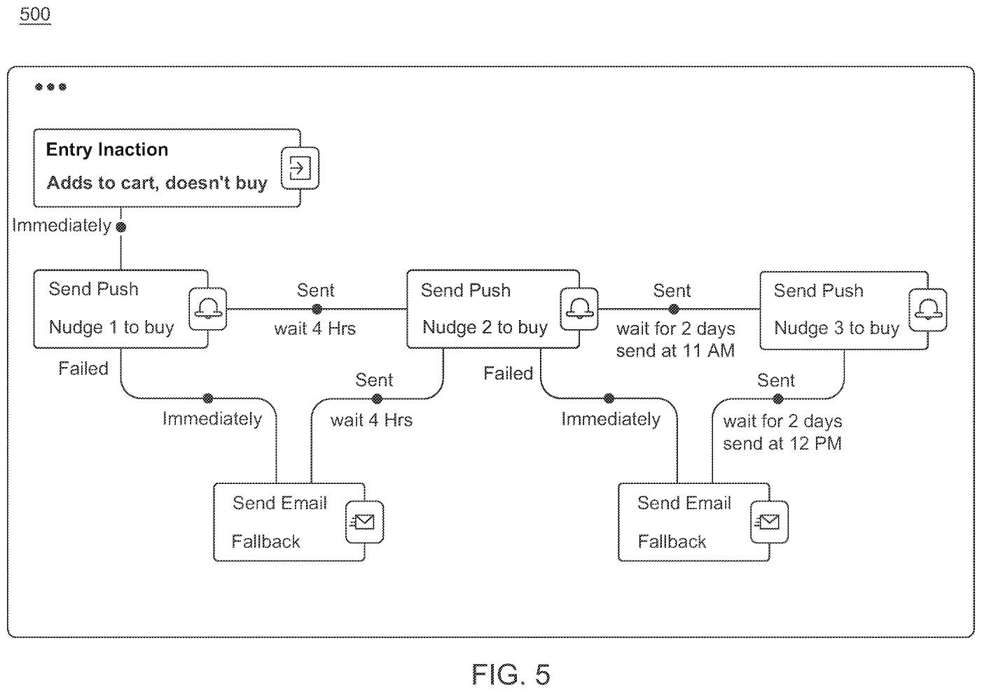

FIG. 5 illustrates a first exemplary journey 500 on detection of an inaction for engaging the plurality of users 202, in accordance with various embodiments of the present disclosure. The journey management system 304 detects “adding to cart, does not buy” as the inaction to add the plurality of users 202 in the first exemplary journey 500. In addition, the journey management system 304 sends alerts to the plurality of users 202 to decrease the inaction. Further, the journey management system 304 sends “first nudge to buy” as the push notification if the plurality of users 202 does not buy after adding to cart in the first exemplary journey 500. Furthermore, the journey management system 304 sends “second nudge to buy” as the push notification if the plurality of users 202 does not buy after 4 hours from the “first nudge to buy” in the first exemplary journey 500. Moreover, the journey management system 304 sends “third nudge to buy” as the push notification if the plurality of users 202 does not buy after 2 days from the “second nudge to buy” in the first exemplary journey 500.

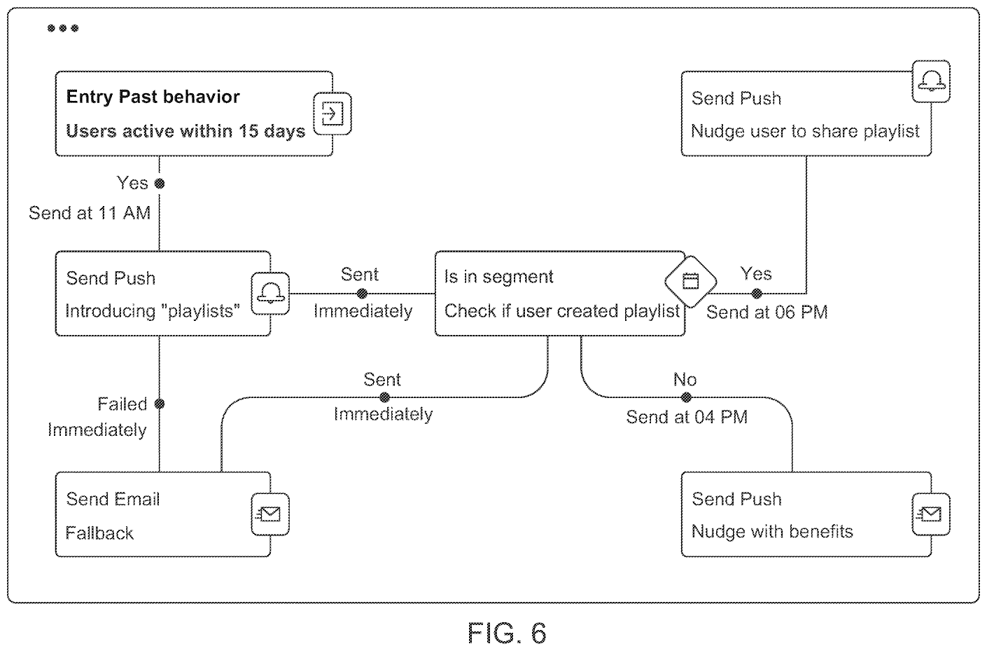

FIG. 6 illustrates an exemplary drive conversion journey 600 for engaging the plurality of users 202, in accordance with various embodiments of the present disclosure. The journey management system 304 detects “user activity within 15 days” from the past behavior to add the plurality of users 202 in the exemplary drive conversion journey 600. The journey management system 304 sends automated reminders in the exemplary drive conversion journey 600 to the plurality of users 202 to complete any order on any of the plurality of platforms 102. In addition, the journey management system 304 sends “introducing playlists” as the push notification on detection of the “user activity within 15 days” in the exemplary drive conversion journey 600. Further, the journey management system 304 segments the plurality of users 202 on creation of the playlists in the exemplary drive conversion journey 600. Furthermore, the journey management system 304 sends “nudge to share playlists” if the plurality of users 202 has created the playlists in the exemplary drive conversion journey 600.

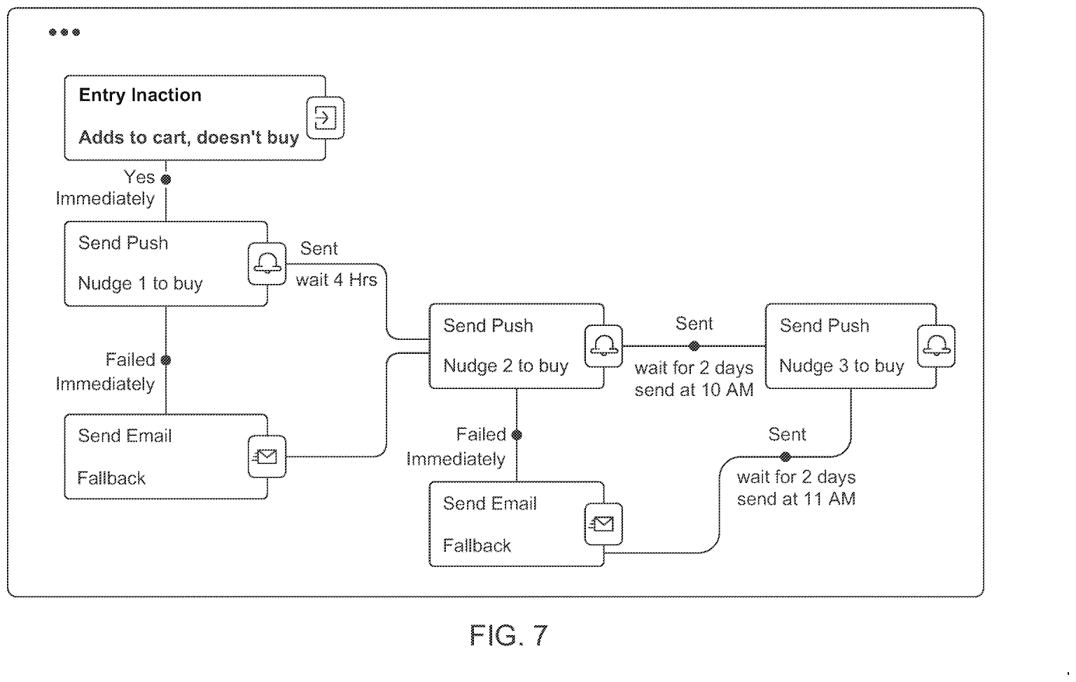

FIG. 7 illustrates an exemplary long running re-engagement journey 700 for engaging the plurality of users 202, in accordance with various embodiments of the present disclosure. The journey management system 304 resurrects inactive users from the plurality of users 202 through sending various engagement messages in the exemplary long running re-engagement journey 700. The journey management system 304 detects “adding to cart, does not buy” as the inaction to add the plurality of users 202 in the exemplary long running re-engagement journey 700. In addition, the journey management system 304 sends “first nudge to buy” as the push notification if the plurality of users 202 does not buy after adding to cart in the exemplary long running re-engagement journey 700. Further, the journey management system 304 sends “second nudge to buy” as the push notification if the plurality of users 202 does not buy after 4 hours from the “first nudge to buy” in the exemplary long running re-engagement journey 700. Furthermore, the journey management system 304 sends “third nudge to buy” as the push notification if the plurality of users 202 does not buy after 2 days from the “second nudge to buy” in the exemplary long running re-engagement journey 700.

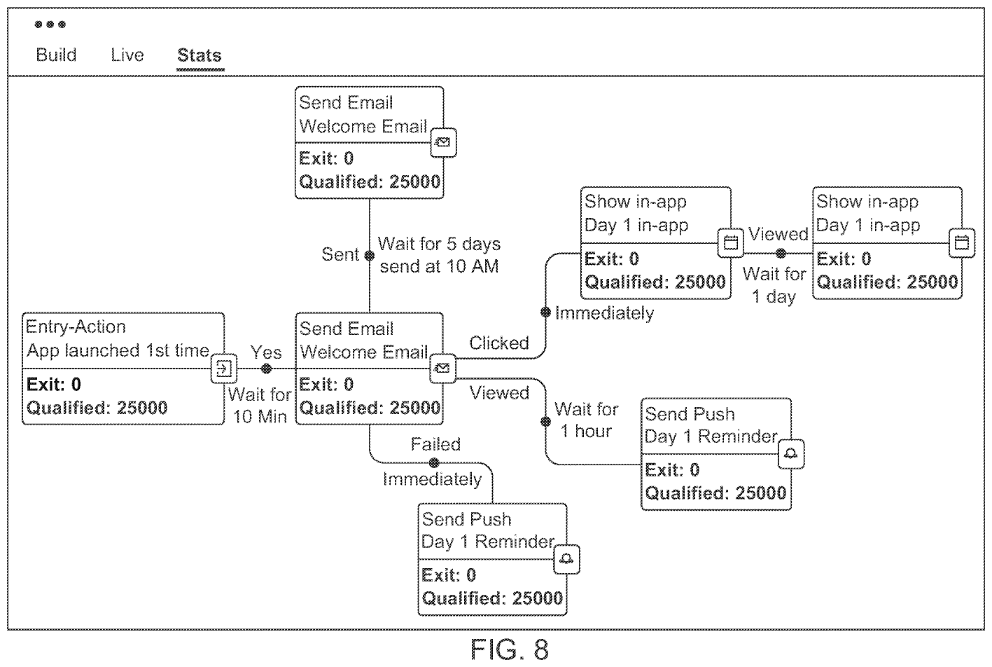

FIG. 8 illustrates an exemplary statistic monitor 800 for the plurality of journeys, in accordance with various embodiments of the present disclosure. The journey management system 304 displays a live-view of the performance of the plurality of journeys in the exemplary statistic monitor 800. The journey management system 304 detects “first application launch” as the entry criterion to add the plurality of users 202 in the exemplary statistic monitor 800. In addition, the exemplary statistic monitor 800 displays various paths in a journey for the plurality of users 202 based on the entry criterion and the activity.

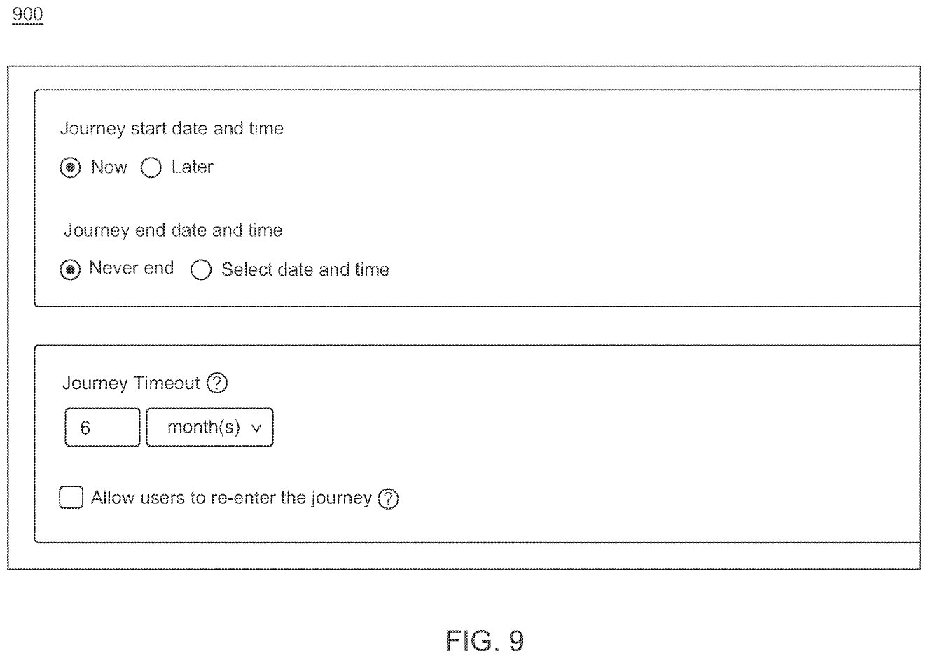

FIG. 9 illustrates a first exemplary onboarding and offboarding criteria 900 for the plurality of journeys, in accordance with various embodiments of the present disclosure. The first exemplary onboarding and offboarding criteria 900 include “journey start date and time”, “journey end date and time”, and “journey timeout”. In addition, the “journey start date and time” is defined as “Now” in the first exemplary onboarding and offboarding criteria 900. Further, the “journey end date and time” is defined as “Never End” in the first exemplary onboarding and offboarding criteria 900. Furthermore, the “journey timeout” is defined as “6 months” in the first exemplary onboarding and offboarding criteria 900.

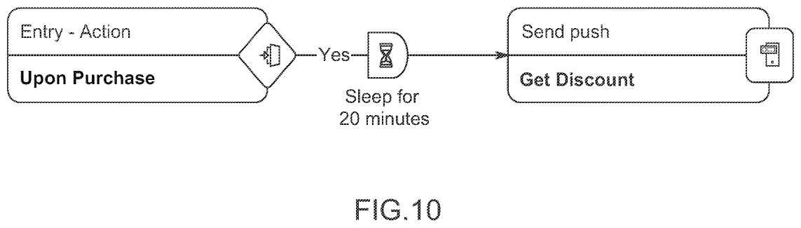

FIG. 10 illustrates a second exemplary journey 1000 on detection of an action for engaging the plurality of users 202, in accordance with various embodiments of the present disclosure. The journey management system 304 detects “purchase” as the action to add the plurality of users 202 in the second exemplary journey 1000. In addition, the journey management system 304 sends “get discount” as the push notification after 20 minutes of sleep time upon the “purchase” in the second exemplary journey 1000.

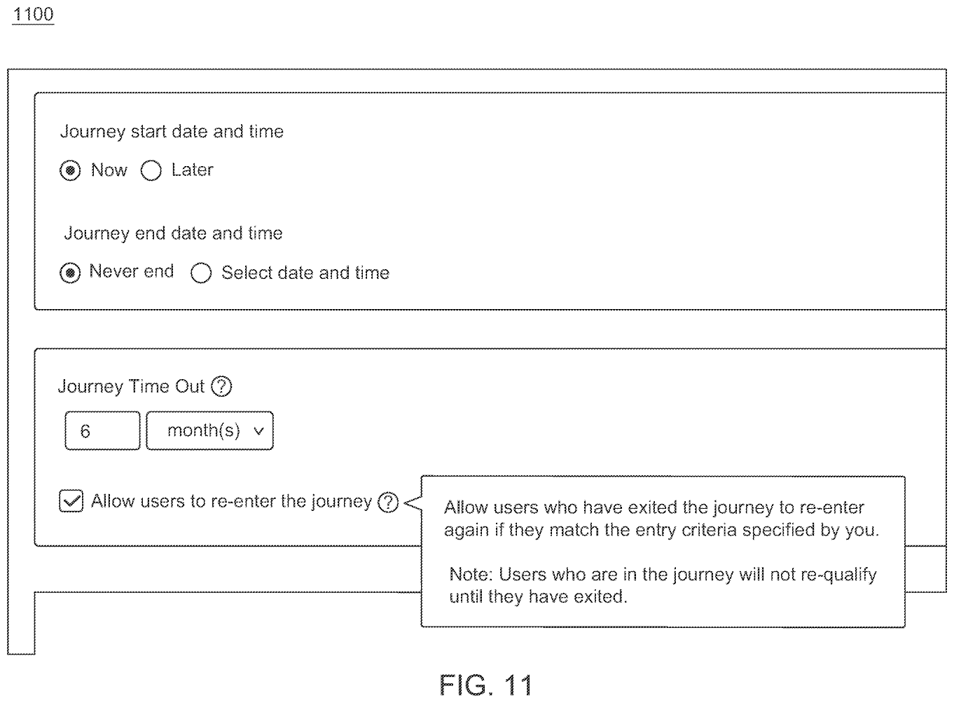

FIG. 11 illustrates a second exemplary onboarding and offboarding criteria 1100 with re-entry of the plurality of users 202 for the plurality of journeys, in accordance with various embodiments of the present disclosure. In addition, the “journey start date and time” is defined as “Now” in the second exemplary onboarding and offboarding criteria 1100. Further, the “journey end date and time” is defined as “Never End” in the second exemplary onboarding and offboarding criteria 1100. Furthermore, the “journey timeout” is defined as “6 months” in the second exemplary onboarding and offboarding criteria 1100. Moreover, the second exemplary onboarding and offboarding criteria 1100 allow the plurality of users 202 to re-enter the plurality of journeys.

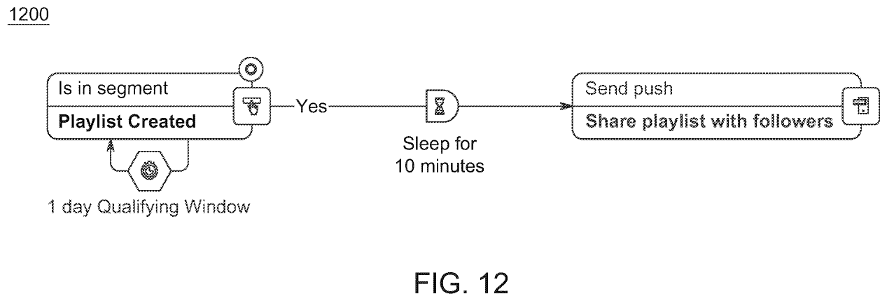

FIG. 12 illustrates a first exemplary journey 1200 with the plurality of segment nodes and the plurality of engagement nodes, in accordance with various embodiments of the present disclosure. The journey management system 304 automatically defines each of the plurality of journeys. In addition, the journey management system 304 automatically connects an optimal segment node from the plurality of segment nodes with an optimal engagement node from the plurality of engagement nodes for the first exemplary journey 1200. Further, the journey management system 304 detects “playlist created” as the action in the optimal segment node for the first exemplary journey 1200. Furthermore, the journey management system 304 detects “share playlist with followers” as the push notification after 10 minutes of sleep time upon the “playlist created” in the optimal engagement node for the first exemplary journey 1200. Moreover, the journey management system 304 connects the “playlist created” with the “share playlist with followers” in the first exemplary journey 1200. Also, the first exemplary journey 1200 initiates with the optimal segment node.

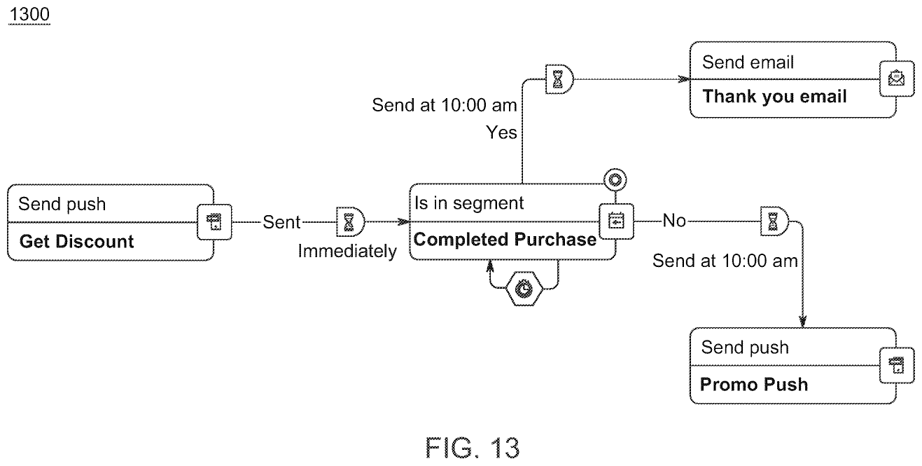

FIG. 13 illustrates a second exemplary journey 1300 with the plurality of segment nodes and the plurality of engagement nodes, in accordance with various embodiments of the present disclosure. The journey management system 304 automatically defines each of the plurality of journeys. In addition, the journey management system 304 automatically connects an optimal segment node from the plurality of segment nodes with an optimal engagement node from the plurality of engagement nodes for the second exemplary journey 1300. Further, the journey management system 304 detects “get discount” as the push notification in the optimal engagement node for the second exemplary journey 1300. Furthermore, the journey management system 304 detects “completed purchase” as the action in the optimal segment node for the second exemplary journey 1300. Moreover, the journey management system 304 connects the “get discount” with the “completed purchase” in the second exemplary journey 1300. Also, the second exemplary journey 1300 initiates with the optimal engagement node.

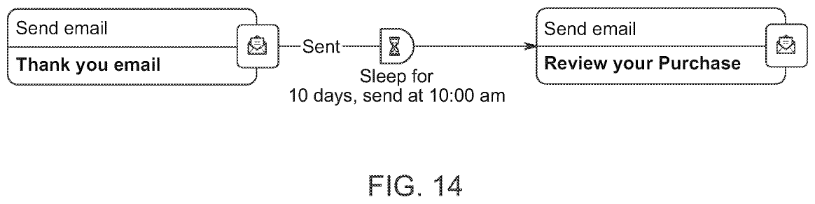

FIG. 14 illustrates a third exemplary journey 1400 with the plurality of segment nodes and the plurality of engagement nodes, in accordance with various embodiments of the present disclosure. The journey management system 304 automatically defines each of the plurality of journeys. In addition, the journey management system 304 automatically connects a first optimal engagement node from the plurality of engagement nodes with a second optimal engagement node from the plurality of engagement nodes for the third exemplary journey 1400. Further, the journey management system 304 detects “thank you mail” as the email channel in the first optimal engagement node for the third exemplary journey 1400. Furthermore, the journey management system 304 detects “review your purchase” as the email channel in the second optimal engagement node for the third exemplary journey 1400. Moreover, the journey management system 304 connects the “thank you mail” with the “review your purchase” in the third exemplary journey 1400.

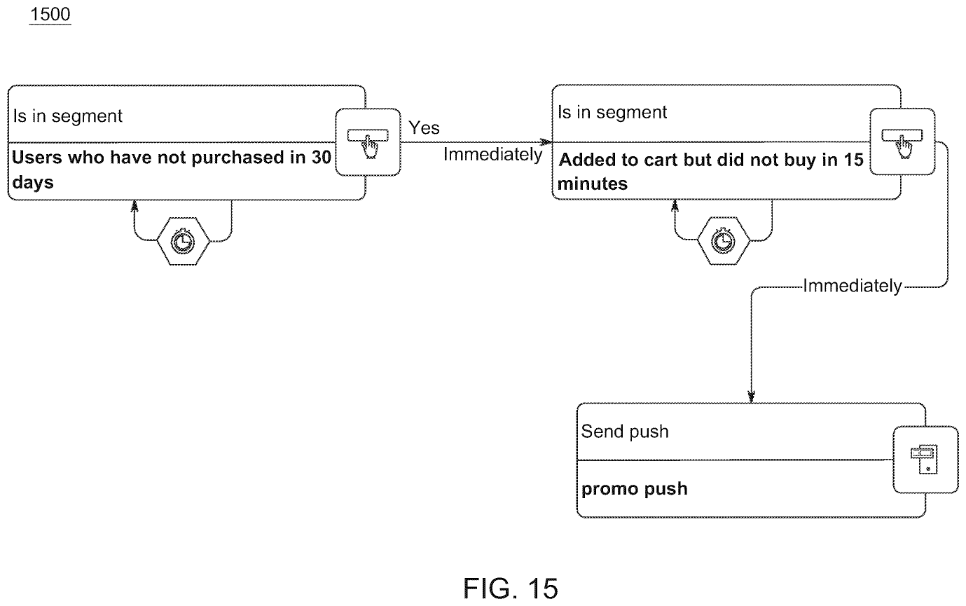

FIG. 15 illustrates a fourth exemplary journey 1500 with the plurality of segment nodes and the plurality of engagement nodes, in accordance with various embodiments of the present disclosure. The journey management system 304 automatically defines each of the plurality of journeys. In addition, the journey management system 304 automatically connects a first optimal segment node from the plurality of segment nodes with a second optimal segment node from the plurality of segment nodes for the fourth exemplary journey 1500. Further, the journey management system 304 detects “users who have not purchased in 30 days” in the first optimal segment node for the fourth exemplary journey 1500. Furthermore, the journey management system 304 detects “added to cark but did not buy in 15 minutes” in the second optimal segment node for the fourth exemplary journey 1500. Moreover, the journey management system 304 connects the “users who have not purchased in 30 days” with the “added to cark but did not buy in 15 minutes” in the fourth exemplary journey 1500.

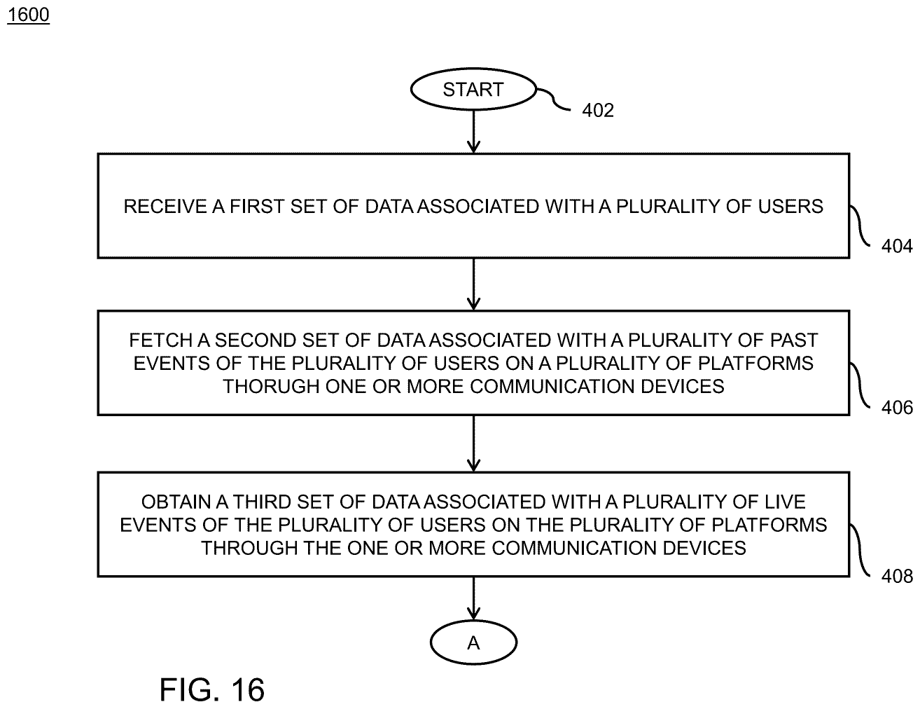

FIG. 16 illustrates a flow chart 1600 of the method for generating the plurality of journeys for engaging the plurality of users 202 in real-time, in accordance with various embodiments of the present disclosure. It may be noted that in order to explain the method steps of the flowchart 1600, references will be made to the elements explained in FIG. 3. The flow chart 1600 starts at step 402. At step 404, the journey management system 304 receives the first set of data associated with the plurality of users 202. At step 406, the journey management system 304 fetches the second set of data associated with the plurality of past events of the plurality of users 202 on the plurality of platforms 102 through the one or more communication devices 204. At step 408, the journey management system 304 obtains the third set of data associated with the plurality of live events of the plurality of users 202 on the plurality of platforms 102 through the one or more communication devices 204. At step 400, the journey management system 304 computes an optimal time (H*u, H*global) of sending marketing engagement (C) by capturing an hour of the day where the user were most active or when the majority of users were most active. At step 410, the journey management system 304 analyzes the first set of data, the second set of data, and the third set of data using the one or more machine learning algorithms. At step 412, the journey management system 304 generates the plurality of journeys to engage the plurality of users 202 through the plurality of channels based on the analysis of the first set of data, the second set of data, and the third set of data. At step 414, the journey management system 304 creates the one or more goals for each of the plurality of journeys of the plurality of platforms 102.

The flow chart 1600 terminates at step 416. It may be noted that the flowchart 1600 is explained to have above stated process steps; however, those skilled in the art would appreciate that the flowchart 1600 may have more/less number of process steps which may enable all the above stated embodiments of the present disclosure.

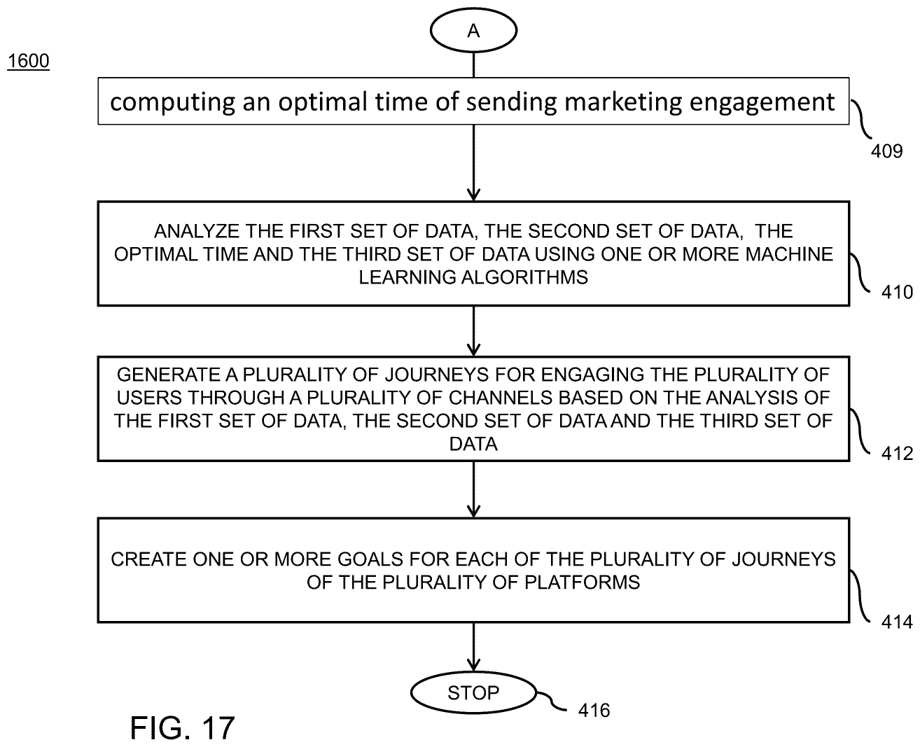

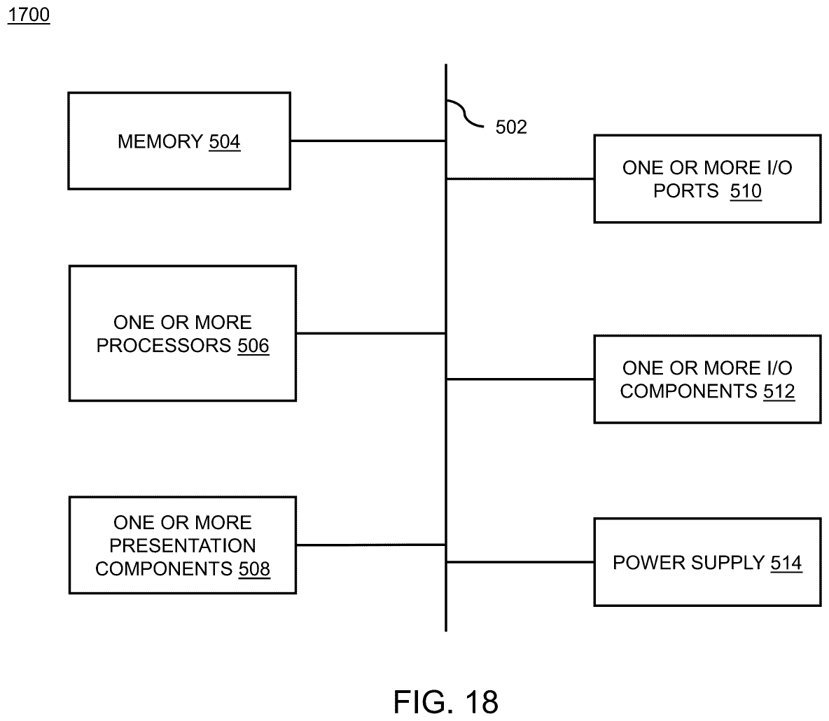

FIG. 17 illustrates a block diagram of a computing device 1700, in accordance with various embodiments of the present disclosure. The computing device 1700 includes a bus 502 that directly or indirectly couples the following devices: a memory 504, one or more processors 506, one or more presentation components 508, one or more input/output (I/O) ports 510, one or more input/output components 512, and an illustrative power supply 514. The bus 502 represents what may be one or more busses (such as an address bus, data bus, or combination thereof). Although the various blocks of FIG. 17 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 17 is merely illustrative of an exemplary computing device 1700 that can be used in connection with one or more embodiments of the present invention. Distinction is not made between such categories as “workstation,” “server,” “laptop,” “hand-held device,” etc., as all are contemplated within the scope of FIG. 17 and reference to “computing device.”

The computing device 1700 typically includes a variety of computer-readable media. The computer-readable media can be any available media that can be accessed by the computing device 1700 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data.

The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 1700. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 504 includes computer-storage media in the form of volatile and/or nonvolatile memory. The memory 504 may be removable, non-removable, or a combination thereof. Exemplary hardware devices include solid-state memory, hard drives, optical-disc drives, etc. The computing device 1700 includes one or more processors that read data from various entities such as memory 504 or I/O components 512. The one or more presentation components 508 present data indications to a user or other device. Exemplary presentation components include a display device, speaker, printing component, vibrating component, etc. The one or more I/O ports 510 allow the computing device 1700 to be logically coupled to other devices including the one or more I/O components 512, some of which may be built in. Illustrative components include a microphone, joystick, game pad, satellite dish, scanner, printer, wireless device, etc.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

1. A computer-implemented method for generating a plurality of journeys for personalized engagement of a plurality of users in real-time, the computer-implemented method comprising:
receiving, at a journey management system with a processor, a first set of data associated with the plurality of users, wherein the plurality of users is associated with one or more communication devices, and the first type of data comprises a marketing engagement (C) sent to the users, and an intended user action (G) to be executed against the sent marketing engagement;
fetching, at the journey management system with the processor, a second set of data associated with a plurality of past events of the plurality of users on a plurality of platforms,
obtaining, at the journey management system with the processor, a third set of data associated with tracking a plurality of live events from the plurality of users on the plurality of platforms in response to the marketing engagement, where the third set of data corresponds to an actual user action (E);
computing an optimal time (H*ᵤ H*_{gobal}) of sending marketing engagement (C) by capturing an hour of the day where the user were most active or when the majority of users were most active;
analyzing, at the journey management system with the processor, the first set of data, the second set of data, the third set of data an the optimal time using an XGBoost machine learning model in real-time, wherein the analysis is performed based on training of the machine learning model, wherein the analysis is performed for predicting one or more patterns as a probability of user intent defined by at least one of:
whether (Ŷᵤ) the user will perform a predetermined goal; and
a likelihood (Ĥᵤ) of success of the sent engagement of the user at each hour;
generating, at the journey management system with the processor, the plurality of journeys for engaging the plurality of users through a plurality of channels based on the one or more patterns of user intent by the steps of:
a) personalization of the marketing engagement to be sent to the user based on the patterns of user intent; and
b) selecting an optimal content to be delivered via the personalized marketing engagement at the predicted optimal time, said selection performed via a multi-bandit algorithm based on the user intent and a campaign context; and
creating, at the journey management system with the processor, one or more goals for each of the plurality of journeys of the plurality of platforms, wherein the one or more goals are ambitious aim of the plurality of platforms for the plurality of journeys, wherein each of the one or more goals is tracked in real-time.

2. The computer-implemented method as recited in claim 1, wherein the first set of data corresponds to personal information of the plurality of users, wherein the first set of data comprising name data, age data, e-mail identity data, contact number data, gender data, geographic location data, angiographic data, demographic data, payment cards data, banking partners data, salary data, loan data, lifetime data on each of the plurality of platforms, and relationship status data, wherein the marketing engagement (C) comprises notification, email, in-app message, wireless communication messages, and wherein the intended user action comprises clicking on a link, viewing a product, purchasing an item.

3. The computer-implemented method as recited in claim 1, further comprising identifying, at the journey management system with the processor, an entry criterion for automated admittance of each of the plurality of users accessing the plurality of platforms in corresponding journey from the plurality of journeys in real-time.

4. The computer-implemented method as recited in claim 1, further comprising identifying, at the journey management system with the processor, the one or more patterns based on the training of the machine learning model on the plurality of past events, the plurality of live events, and a plurality of features in real-time.

5. The computer-implemented method as recited in claim 1, further comprising training, at the journey management system with the processor, the machine learning model for performing the analysis of the first set of data, the second set of data, and the third set of data, wherein the machine learning model is trained using a combined loss function associated with prediction of the probabilities of the user intent, and wherein the third set of data comprises clicking on a link, viewing a product, purchasing an item, device feature, operating system feature, user interaction with device.

6. The computer-implemented method as recited in claim 1, further comprising enabling, at the journey management system with the processor, segmentation of the plurality of users in one or more segments based on the predicted patterns of the user intent.

7. The computer-implemented method as recited in claim 1, further comprising creating, at the journey management system with the processor, a plurality of intent based micro-segments associated with each of the one or more segments based on the predicted patterns of the user intent, wherein the plurality of intent based micro-segments is created in real-time, and are classified into High, Medium, and Low intent categories using the XGBoost machine learning model by classifying the probability of user intent (Ŷᵤ) as High. Low or Medium based on a computed “F score”.

8. The computer-implemented method as recited in claim 1, further comprising computing, at the journey management system with the processor, the optimal time of the engagement with the plurality of users in the plurality of journeys using user-specific historical data subject to availability or multiple user data.

9. The computer-implemented method as recited in claim 1, further comprising identifying, at the journey management system with the processor, an optimal channel from the plurality of channels for the plurality of journeys for the engagement with the plurality of users using the one or more machine learning algorithms in real-time, wherein the plurality of channels comprising mobile channels, email channels, desktop channels, social channels, remarketing channels, and server channels.

10. The computer-implemented method as recited in claim 1, further comprising updating the multi-arm bandit algorithm for an updated selection of the optimal content based on a reward signal derived from user action in response to previously delivered optimal content through the personalized engagement.

11. The computer-implemented method as recited in claim 1, wherein the selected content comprises reminders, recommendations, discounts based on the user intent and the content of campaign, and wherein the multi bandit algorithm for selected context is at least one of upper confidence bound and Thomson sampling.
